(19) United States
(12) Patent Application Publication
(10) Pub. No.: US 2023/0113155 A1
(43) Pub. Date: Apr. 13, 2023

(54) ELECTRONIC DEVICE

(71) Applicant: SEMICONDUCTOR ENERGY LABORATORY CO., LTD., Atsugi-shi (JP)

(72) Inventors: Shunpei YAMAZAKI, Tokyo (JP); Yosuke TSUKAMOTO, Atsugi (JP); Kiyoshi KATO, Atsugi (JP); Tatsuya ONUKI, Atsugi (JP); Yoshiaki OIKAWA, Atsugi (JP); Kensuke YOSHIZUMI, Atsugi (JP)

(21) Appl. No.: 17/937,823

(22) Filed: Oct. 4, 2022

(30) Foreign Application Priority Data
Oct. 7, 2021 (JP) 2021-165494

(51) Int. Cl. G02B 27/00; G02B 27/01

(52) U.S. Cl. CPC G02B 27/0093; G02B 27/0101; G02B 27/0172; G02B 27/0176; G02B 2027/0138; G02B 2027/014; G02B 2027/0178

(57) ABSTRACT

Provided is a multifunctional display device or a multifunctional electronic device. Provided is a display device or electronic device with high visibility. Provided is a display device or electronic device with low power consumption. The electronic device includes a housing, a display device, a system unit, a camera, a secondary battery, a reflective surface, and a wearing tool. The system unit and the secondary battery are each positioned inside the housing. The system unit includes a charging circuit unit. The charging circuit unit is configured to control charging of the secondary battery. The system unit is configured to perform first processing based on imaging data of the camera. The first processing includes at least one of gesture operation, head tracking, and eye tracking. The system unit is configured to generate image data based on the first processing. The display device is configured to display the image data.

### BACKGROUND OF THE INVENTION

### 1. Field of the Invention

One embodiment of the present invention relates to a display device. One embodiment of the present invention relates to an electronic device including a display device.

Note that one embodiment of the present invention is not limited to the above technical field. Examples of the technical field of one embodiment of the present invention disclosed in this specification and the like include a semiconductor device, a display device, a light-emitting apparatus, a power storage device, a memory device, an electronic device, a lighting device, an input device, an input/output device, a driving method thereof, and a manufacturing method thereof. A semiconductor device generally means a device that can function by utilizing semiconductor characteristics.

### 2. Description of the Related Art

Wearable electronic devices, stationary electronic devices, and the like are becoming widespread as electronic devices equipped with display devices for augmented reality (AR) or virtual reality (VR). Examples of wearable electronic devices include a head mounted display (HMD) and an eyeglass-type electronic device. Examples of stationary electronic devices include a head-up display (HUD).

With an electronic device whose display portion is close to the user, such as an HMD, the user is likely to perceive pixels and strongly feels granularity, whereby the sense of immersion or realistic feeling in AR or VR might be diminished. Thus, an HMD is preferably provided with a display device that has minute pixels so that pixels are not perceived by the user. Patent Document 1 discloses a method in which an HMD including minute pixels is achieved by using transistors capable of high-speed operation.

### REFERENCE

### Patent Document

[Patent Document 1] Japanese Published Patent Application No. 2000-002856

### SUMMARY OF THE INVENTION

An object of one embodiment of the present invention is to provide a multifunctional display device or a multifunctional electronic device. Another object is to provide a wearable electronic device with a novel structure. Another object is to provide a display device or an electronic device with high visibility. Another object is to provide a display device or an electronic device with low power consumption. Another object is to provide a display device or an electronic device that can be operated intuitively. Another object is to provide an electronic device that can be easily reduced in size. Another object is to provide an electronic device that can be easily reduced in weight.

An object of one embodiment of the present invention is to provide a display device with a novel structure or an electronic device with a novel structure. Another object of one embodiment of the present invention is to provide a driving method of the display device with a novel structure or a driving method of the electronic device with a novel structure. Another object of one embodiment of the present invention is to at least alleviate at least one of problems of the conventional technique.

Note that the description of these objects does not preclude the existence of other objects. In one embodiment of the present invention, there is no need to achieve all the objects. Objects other than these can be derived from the description of the specification, the drawings, the claims, and the like.

One embodiment of the present invention is an electronic device including a housing, a display device, a system unit, a camera, a secondary battery, a reflective surface, and a wearing tool. The system unit and the secondary battery are each positioned inside the housing. The system unit includes a charging circuit unit. The charging circuit unit is configured to control charging of the secondary battery. The system unit is configured to perform first processing based on imaging data of the camera. The first processing includes at least one of gesture operation, head tracking, and eye tracking. The system unit is configured to generate image data based on the first processing. The display device is configured to display the image data.

In the above structure, the wearing tool is preferably configured to hold a user's head around the user's ear.

In the above structure, the wearing tool is preferably worn over a user's ear.

In the above structure, the housing preferably has a curved shape along a user's head.

In the above structure, the housing preferably has a cylindrical shape whose axis is along a part of a substantially elliptical shape.

In the above structure, the secondary battery is preferably flexible.

According to one embodiment of the present invention, a multifunctional display device or a multifunctional electronic device can be provided. Alternatively, a wearable electronic device with a novel structure can be provided. Alternatively, a display device or an electronic device with high visibility can be provided. Alternatively, a display device or an electronic device with low power consumption can be provided. Alternatively, a display device or an electronic device that can be operated intuitively can be provided. Alternatively, an electronic device that can be easily reduced in size can be provided. Alternatively, an electronic device that can be easily reduced in weight can be provided.

According to one embodiment of the present invention, a display device with a novel structure or an electronic device with a novel structure can be provided. According to one embodiment of the present invention, a driving method of the display device with a novel structure or a driving method of the electronic device with a novel structure can be provided. According to one embodiment of the present invention, at least one of problems of the conventional technique can be at least alleviated.

Note that the description of these effects does not preclude the existence of other effects. One embodiment of the present invention does not necessarily have all the effects. Effects other than these can be derived from the description of the specification, the drawings, the claims, and the like.

### BRIEF DESCRIPTION OF THE DRAWINGS

FIGS. 1A to 1C illustrate a structure example of an electronic device.

FIGS. 2A to 2C illustrate a structure example of an electronic device.

FIG. 3 illustrates a structure example of an electronic device.

FIG. 4 is a block diagram illustrating a structure example of an electronic device.

FIG. 5 illustrates a structure example of an electronic device.

FIGS. 6A to 6C illustrate a structure example of an electronic device.

FIG. 7A illustrates an example of operation of an electronic device, and FIGS. 7B and 7C illustrate examples of images displayed on the electronic device.

FIGS. 8A and 8B illustrate a structure example of a display device.

FIG. 9 illustrates a structure example of a display device.

FIGS. 10A to 10C are each a perspective view of a display module.

FIGS. 11A and 11B illustrate a configuration example of a display device.

FIGS. 12A to 12D each illustrate a configuration example of a display device.

FIGS. 13A to 13D each illustrate a configuration example of a display device.

FIG. 14 is a timing chart showing a driving method of a display device.

FIGS. 15A and 15B illustrate a configuration example of a display device.

FIGS. 16A and 16B illustrate an operation example of a display device.

FIGS. 17A and 17B illustrate a structure example of a display device.

FIGS. 18A to 18D illustrate structure examples of a display device.

FIGS. 19A to 19C illustrate structure examples of a display device.

FIG. 20 is a block diagram illustrating a configuration example of a display device.

FIG. 21 is a block diagram illustrating a configuration example of a display device.

FIGS. 22A and 22B illustrate a structure example of a display device.

FIG. 23 illustrates a configuration example of a display device.

FIG. 24 illustrates a configuration example of a display device.

FIGS. 25A to 25C illustrate a structure example of a display device.

FIGS. 26A to 26F each illustrate a structure example of a pixel.

FIGS. 27A and 27B illustrate a structure example of a display device.

FIG. 28 illustrates a structure example of a display device.

FIG. 29 illustrates a structure example of a display device.

FIG. 30 illustrates a structure example of a display device.

FIG. 31 illustrates a structure example of a display device.

FIG. 32 illustrates a structure example of a display device.

FIG. 33 illustrates a structure example of a display device.

FIG. 34 illustrates a structure example of a display device.

FIGS. 35A to 35F each illustrate a structure example of a light-emitting device.

FIGS. 36A to 36C each illustrate a structure example of a light-emitting device.

FIGS. 37A to 37E illustrate a bendable secondary battery.

FIGS. 38A and 38B illustrate a bendable secondary battery.

FIGS. 39A and 39B each illustrate a structure example of an electronic device.

### DETAILED DESCRIPTION OF THE INVENTION

Embodiments will be described below with reference to the drawings. Note that the embodiments can be implemented with many different modes, and it will be readily understood by those skilled in the art that modes and details thereof can be changed in various ways without departing from the spirit and scope thereof. Therefore, the present invention should not be construed as being limited to the description of embodiments below.

Note that in structures of the invention described below, the same portions or portions having similar functions are denoted by the same reference numerals in different drawings, and the description thereof is not repeated. The same hatching pattern is used for portions having similar functions, and the portions are not denoted by specific reference numerals in some cases.

Note that in each drawing described in this specification, the size, the layer thickness, or the region of each component is exaggerated for clarity in some cases. Therefore, the size, the layer thickness, or the region is not limited to the illustrated scale.

Note that in this specification and the like, ordinal numbers such as “first” and “second” are used in order to avoid confusion among components and do not limit the number of components.

Note that in this specification, an EL layer means a layer containing at least a light-emitting substance (also referred to as a light-emitting layer) or a stack including the light-emitting layer provided between a pair of electrodes of a light-emitting element.

In this specification and the like, a display panel that is one embodiment of a display device has a function of displaying (outputting) an image or the like on (to) a display surface. Thus, the display panel is one embodiment of an output device.

In this specification and the like, a structure in which a connector such as a flexible printed circuit (FPC) or a tape carrier package (TCP) is attached to a substrate of a display panel, or a structure in which an integrated circuit (IC) is mounted on a substrate by a chip on glass (COG) method or the like is referred to as a display panel module or a display module, or simply referred to as a display panel or the like in some cases.

### Embodiment 1

In this embodiment, a display device of one embodiment of the present invention and an electronic device including the display device will be described.

One embodiment of the present invention is a head-mounted electronic device. The electronic device has a function of displaying images in a variety of display modes. Examples of the display modes include an AR display mode and a VR display mode. In the AR display mode, an image can be displayed on a screen so as to be superimposed on a real-world scenery viewed through the screen. In the VR mode, an image is displayed while the user's view is blocked such that a real-world scenery cannot be viewed.

The electronic device of one embodiment of the present invention preferably has a function of displaying a three-dimensional image by displaying images on a plurality of display portions with a parallax taken into account. The electronic device can include, when being mounted with a pair of display devices, for example, a plurality of display portions.

The electronic device has a function of displaying a three-dimensional image by displaying a first image and a second image on a screen.

The electronic device of one embodiment of the present invention includes a wearing tool to be worn on a head. The housing is preferably provided with a plurality of image sensors (cameras). When an image of hands is captured by a camera pointed at the outside of the housing, hand movement (gesture) can be acquired as information, which enables gesture operation and thus enables intuitive operation. When a surrounding scenery is captured by a camera pointed at the outside of the housing, processing such as head tracking (tracking of the orientation of the head or a part of the body of the user wearing the electronic device) can be performed. When an image of the user's eye is captured by a camera pointed at the inner side of the housing, eye information, sight-line movement information, or the like used for authentication processing, health management, or eye tracking can be acquired.

The display device of one embodiment of the present invention preferably has an extremely high resolution. For example, a display device with a resolution higher than or equal to 1000 ppi, preferably higher than or equal to 2000 ppi, further preferably higher than or equal to 3000 ppi, still further preferably higher than or equal to 4000 ppi, yet further preferably higher than or equal to 5000 ppi, yet still further preferably higher than or equal to 6000 ppi, and lower than or equal to 10000 ppi, lower than or equal to 9000 ppi, or lower than or equal to 8000 ppi can be used.

The number of pixels (definition) in the display device of one embodiment of the present invention is preferably as large as possible. For example, the definition can be HD (1280×720 pixels), FHD (1920×1080 pixels), or WQHD (2560×1440 pixels). The display device of one embodiment of the present invention preferably has an extremely high definition such as WQXGA (2560×1600 pixels), 4K2K (3840×2160 pixels), or 8K4K (7680×4320 pixels). The definition is particularly preferably 4K2K, 8K4K, or higher.

There is no particular limitation on the screen ratio (aspect ratio) of the display device of one embodiment of the present invention. For example, the display device of one embodiment of the present invention is compatible with a variety of screen ratios such as 1:1 (a square), 3:4, 16:9, and 16:10.

In the case of using the display device as a direct-view display device, the display diagonal is preferably 0.5 inches or more, further preferably 0.7 inches or more, still further preferably 1 inch or more, yet further preferably 1.3 inches or more, and 2 inches or less or 1.7 inches or less. Specifically, the size of the display device is preferably 1.5 inches or a similar size. In the display device with the above size, a lens or the like included in a direct-view optical system can be thin and image distortion due to the lens can be small.

In the case of using the display device of one embodiment of the present invention as a projection display device, an enlarged image can be projected on a screen. Thus, a small display device can be used, leading to reduction in weight of the electronic device.

More specific examples will be described below with reference to drawings.

### [Structure Example of Electronic Device]

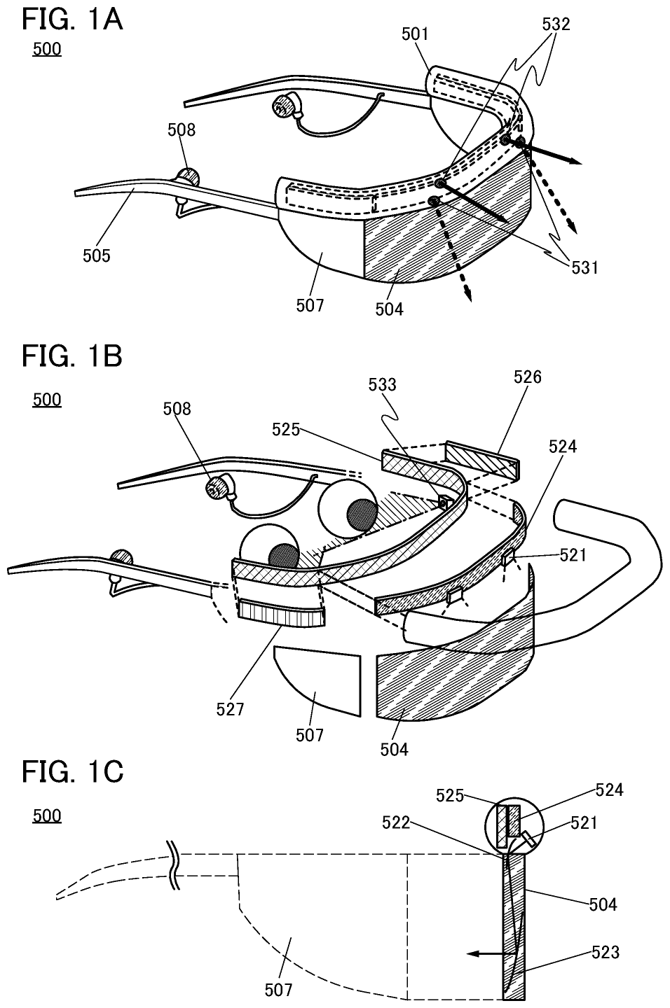

FIG. 1A is a perspective view of an electronic device 500.

The electronic device 500 functions as what is called a portable information terminal, and can execute a variety of programs and reproduce a variety of contents by connecting to the Internet, for example. The electronic device 500 has a function of displaying augmented reality contents in an AR mode, for example. The electronic device 500 may have a function of displaying virtual reality contents in a VR mode. Note that the electronic device 500 may have a function of displaying substitutional reality (SR) contents or mixed reality (MR) contents as well as AR contents or VR contents.

The electronic device 500 includes a housing 501, an optical component 504, a wearing tool 505, a light-blocking portion 507, and the like. The housing 501 preferably has a cylindrical shape. The electronic device 500 is preferably wearable on the user's head. Furthermore, it is preferred that the electronic device 500 be worn such that the housing 501 be positioned above the circumference of the user's head passing through eyebrows and ears. When the housing 501 has a cylindrical shape that is curved along the user's head, the electronic device 500 can fit more snugly. The housing 501 is fixed to the optical component 504. The optical component 504 is fixed to the wearing tool 505 with the light-blocking portion 507 or the housing 501 therebetween.

The electronic device 500 includes a display device 521, a reflective plate 522, a secondary battery 524, and a system unit. Each of the display device 521, the reflective plate 522, the secondary battery 524, and the system unit is preferably provided in the housing 501. The system unit can be provided with a control unit, a memory unit, and a communication unit included in the electronic device 500, a sensor, and the like. The system unit is preferably provided with a charging circuit, a power supply circuit, and the like.

FIG. 1B illustrates the components of the electronic device 500 illustrated in FIG. 1A. FIG. 1B is a schematic diagram for describing the details of the component of the electronic device 500 illustrated in FIG. 1A.

In the electronic device 500 illustrated in FIG. 1B, the secondary battery 524, a system unit 526, and a system unit 527 are provided in and along the cylindrical housing 501. Furthermore, a system unit 525 is provided along the secondary battery 524 and the like.

The housing 501 preferably has a curved cylindrical shape. When the secondary battery 524 is provided along the curved cylinder, the secondary battery 524 can be positioned efficiently in the housing 501 and the space in the housing 501 can be used efficiently; as a result, the volume of the secondary battery 524 can be increased in some cases.

The housing 501 has a cylindrical shape and the axis of the cylinder is along a part of a substantially elliptical shape, for example. A cross section of the cylinder is preferably substantially elliptical, for example. Alternatively, a part of a cross section of the cylinder preferably has a part of an elliptical shape, for example. In particular, in the case where the electronic device 500 is worn on a head, the part of the cross section having a part of an elliptical shape is preferably positioned on a side facing the head. However, one embodiment of the present invention is not limited thereto. For example, a part of a cross section of the cylinder may have a polygonal (e.g., triangular, quadrangular, or pentagonal) part.

The housing 501 is curved along the user's forehead, for example. Alternatively, the housing 501 is positioned along the user's forehead, for example.

The housing 501 may be formed using two or more cases in combination. For example, the housing 501 may be formed using an upper case and a lower case in combination. Alternatively, the housing 501 may be formed using a case on an inner side (a side in contact with the user) and a case on an outer side in combination, for example. The housing 501 may be formed using three or more cases in combination.

An electrode can be provided in a portion of the housing 501 in contact with the user's forehead to measure brain waves using the electrode. Alternatively, an electrode may be provided in a portion in contact with the user's forehead to acquire information such as user's sweat using the electrode.

A plurality of secondary batteries having cylindrical shapes, elliptic cylindrical shapes, or prism shapes, for example, may be provided as the secondary batteries 524 in the housing 501.

A flexible secondary battery is preferably used as the secondary battery 524 because such a battery can have a shape along the curved cylinder. The use of the flexible secondary battery can increase the degree of freedom in placing the battery in the housing. The secondary battery 524, the system units, and the like are placed in the cylindrical housing. The system units are provided over a plurality of circuit boards, for example. The plurality of circuit boards and the secondary battery are connected using a connecter, a wiring, and the like. The flexible secondary battery can be provided in a position where the connecter, the wiring, and the like are not provided.

Note that the secondary battery 524 may be provided in the wearing tool 505 as well as in the housing 501, for example.

The secondary battery 524 includes an exterior body, an electrode stack, a positive electrode lead electrode, and a negative electrode lead electrode.

The secondary battery 524 includes an electrolyte solution. Alternatively, the secondary battery 524 includes a solid electrolyte. Alternatively, the secondary battery 524 includes an electrolyte solution and a solid electrolyte.

The electrode stack included in the secondary battery 524 includes a positive electrode and a negative electrode. In the case where the secondary battery 524 includes an electrolyte solution, the electrode stack preferably includes a separator between the positive electrode and the negative electrode. In the case where the secondary battery 524 includes a solid electrolyte, the electrode stack preferably includes the solid electrolyte between the positive electrode and the negative electrode.

The electrode stack included in the secondary battery 524 can be, for example, a wound body in which a positive electrode and a negative electrode are stacked and wound. Alternatively, the electrode stack can be, for example, an electrode stack in which a plurality of positive electrodes and a plurality of negative electrodes are stacked such that a positive electrode and a negative electrode are alternately provided.

The electrode stack included in the secondary battery 524 is preferably placed to be surrounded by the exterior body. The positive electrode lead electrode is electrically connected to the positive electrode included in the electrode stack. The negative electrode lead electrode is electrically connected to the negative electrode included in the electrode stack.

A region of the positive electrode lead electrode is placed in the exterior body and the other region is led out to the outside of the exterior body. The positive electrode lead electrode is, in the exterior body, bonded and electrically connected to part of the positive electrode (e.g., a positive electrode current collector). A region of the negative electrode lead electrode is placed in the exterior body and the other region is led out to the outside of the exterior body. The negative electrode lead electrode is, in the exterior body, bonded and electrically connected to part of the negative electrode (e.g., a negative electrode current collector).

The exterior body is preferably flexible. For the exterior body, one or more selected from metal materials such as aluminum and resin materials can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

When a film-like exterior body is used as the exterior body of the secondary battery, a bendable secondary battery can be obtained. Accordingly, the secondary battery can be used while being bent.

In the case where the secondary battery is provided in the electronic device or the like, the exterior body of the secondary battery provided along the housing included in the electronic device changes its shape in accordance with expansion and contraction of the housing due to temperature change, whereby a reduction in airtightness of the exterior body of the secondary battery can be inhibited, in some cases.

Since the secondary battery is deformable, the secondary battery can be provided even in a limited space in the electronic device.

The thickness of the film-like exterior body is preferably less than or equal to 2 mm, further preferably less than or equal to 1 mm, still further preferably less than or equal to 500 μm, yet further preferably less than or equal to 300 μm, yet still further preferably less than or equal to 200 μm, yet still further preferably less than or equal to 100 μm, yet still further preferably less than or equal to 70 μm. The thickness of the metal thin film in the film-like exterior body is preferably less than or equal to 1 mm, further preferably less than or equal to 500 μm, still further preferably less than or equal to 300 μm, yet further preferably less than or equal to 200 μm, yet still further preferably less than or equal to 100 μm, yet still further preferably less than or equal to 70 μm, yet still further preferably less than or equal to 50 μm, yet still further preferably less than or equal to 30 μm, yet still further preferably less than or equal to 20 μm.

Since the film-like exterior body is thin, the volume of the secondary battery can be small. Accordingly, the area occupied by the secondary battery in the electronic device or the like can be small.

The exterior body may have projections and depressions. For example, a film may be provided with projections. Examples of the film provided with projections include an embossed film and an accordion-folded film.

A metal film is easily embossed. Projections formed by embossing increase the surface area of the exterior body exposed to the outside air, for example, increase the ratio of the surface area to the area seen from above, so that heat can be dissipated effectively. In the projections formed on the front (or the back) of the film by embossing, an enclosed space whose inner volume is variable is formed with the film serving as part of a wall of a seal structure. This enclosed space can be said to be formed because the projections of the film have an accordion structure. Note that embossing, which is a kind of pressing, is not necessarily employed and any method that allows formation of a relief on part of the film may be employed.

### <Bendable Secondary Battery>

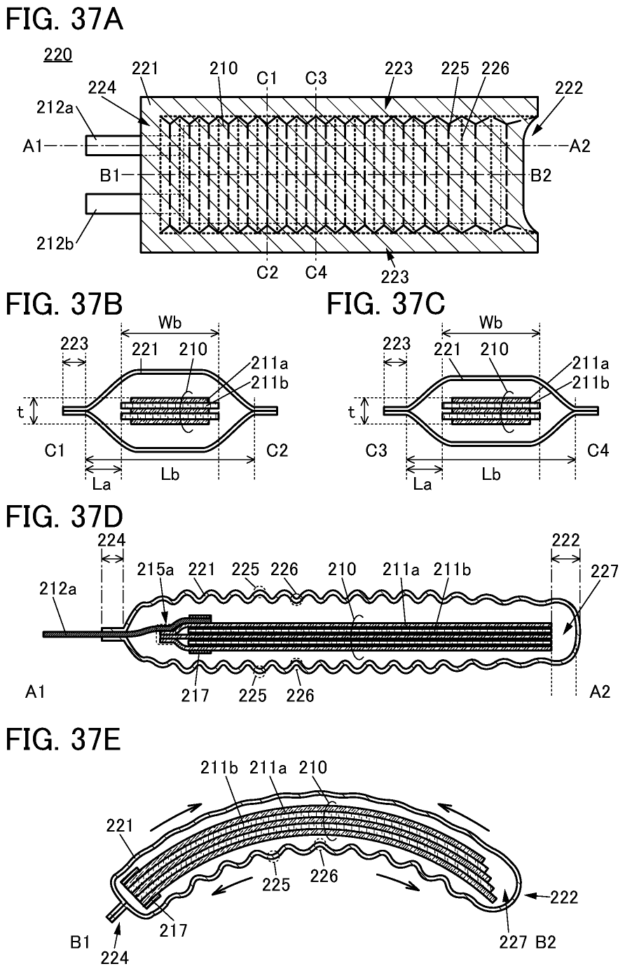

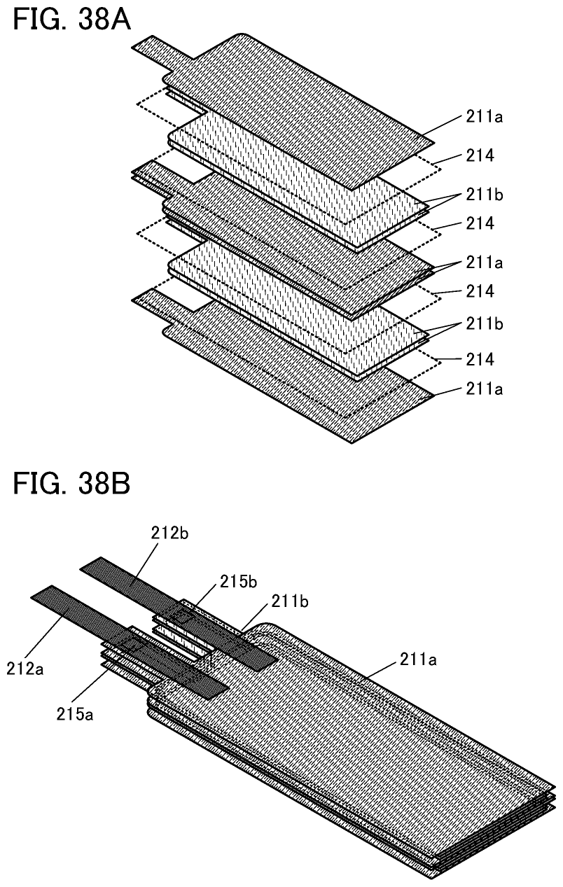

Next, an example of a bendable secondary battery will be described with reference to FIGS. 37A to 37E and FIGS. 38A and 38B.

FIG. 37A is a schematic top view of a bendable secondary battery 220. FIGS. 37B, 37C and 37D are schematic cross-sectional views taken along the cutting line C1-C2, cutting line C3-C4, and cutting line A1-A2, respectively, in FIG. 37A. The secondary battery 220 includes an exterior body 221 and an electrode stack 210 held in an inner region of the exterior body 221. The electrode stack 210 includes at least a positive electrode 211a and a negative electrode 211b. The positive electrode 211a and the negative electrode 211b are collectively referred to as the electrode stack 210. A lead 212a electrically connected to the positive electrode 211a and a lead 212b electrically connected to the negative electrode 211b are extended to the outside of the exterior body 221. In the electrode stack 210, a separator is preferably provided between the positive electrode 211a and the negative electrode 211b. Alternatively, a solid electrolyte layer may be provided between the positive electrode 211a and the negative electrode 211b. The solid electrolyte layer preferably has flexibility. The solid electrolyte layer is preferably flexible. In addition to the positive electrode 211a and the negative electrode 211b, an electrolyte (not illustrated) is enclosed in a region surrounded by the exterior body 221. A gel electrolyte can be used as the electrolyte.

The positive electrode 211a and the negative electrode 211b included in the secondary battery 220 are described with reference to FIGS. 38A and 38B. FIG. 38A is a perspective view illustrating the stacking order of the positive electrode 211a, the negative electrode 211b, and a separator 214. FIG. 38B is a perspective view illustrating the lead 212a and the lead 212b in addition to the positive electrode 211a and the negative electrode 211b.

As illustrated in FIG. 38A, the secondary battery 220 includes a plurality of the positive electrodes 211a having strip shapes, a plurality of the negative electrodes 211b having strip shapes, and a plurality of the separators 214. The positive electrodes 211a and the negative electrodes 211b each include a projected tab portion and a portion other than the tab portion. A positive electrode active material layer is formed on one surface of each of the positive electrodes 211a other than the tab portion, and a negative electrode active material layer is formed on one surface of each of the negative electrodes 211b other than the tab portion.

The positive electrodes 211a and the negative electrodes 211b are stacked so that surfaces of the positive electrodes 211a on each of which the positive electrode active material layer is not formed are in contact with each other and that surfaces of the negative electrodes 211b on each of which the negative electrode active material layer is not formed are in contact with each other.

Furthermore, each of the separators 214 is provided between the surface of one of the positive electrodes 211a on which the positive electrode active material layer is formed and the surface of one of the negative electrodes 211b on which the negative electrode active material layer is formed. In FIGS. 38A and 38B, the separators 214 are shown by dotted lines for easy viewing.

As illustrated in FIG. 38B, the plurality of positive electrodes 211a are electrically connected to the lead 212a in a bonding portion 215a. The plurality of negative electrodes 211b are electrically connected to the lead 212b in a bonding portion 215b.

Next, the exterior body 221 will be described with reference to FIGS. 37B to 37E.

The exterior body 221 has a film-like shape and is folded in half with the positive electrodes 211a and the negative electrodes 211b between facing portions of the exterior body 221. The exterior body 221 includes a folded portion 222, a pair of seal portions 223, and a seal portion 224. The pair of seal portions 223 are provided with the positive electrodes 211a and the negative electrodes 211b positioned therebetween and thus can also be referred to as side seals. The seal portion 224 includes portions overlapping with the lead 212a and the lead 212b and can also be referred to as a top seal.

Part of the exterior body 221 that overlaps with the positive electrodes 211a and the negative electrodes 211b preferably has a wave shape in which crest lines 225 and trough lines 226 are alternately arranged. The seal portions 223 and the seal portion 224 of the exterior body 221 are preferably flat.

FIG. 37B illustrates a cross section cut along the part overlapping with one of the crest lines 225. FIG. 37C illustrates a cross section cut along the part overlapping with one of the trough lines 226. FIGS. 37B and 37C correspond to cross sections of the secondary battery 220, the positive electrodes 211a, and the negative electrodes 211b in the width direction.

Here, the distance between end portions of the positive and negative electrodes 211a and 211b in the width direction and one of the seal portions 223, that is, the distance between the end portions of the positive and negative electrodes 211a and 211b and one of the seal portions 223 is referred to as a distance La. When the secondary battery 220 changes in shape, for example, when the secondary battery 220 is bent, the positive electrodes 211a and the negative electrodes 211b change in shape such that their positions are shifted from one another in the length direction as described later. At this time, if the distance La is too short, the exterior body 221 is rubbed hard against the positive electrodes 211a and the negative electrodes 211b, so that the exterior body 221 is damaged in some cases. In particular, when a metal film of the exterior body 221 is exposed, the metal film might be corroded by the electrolyte solution. Therefore, the distance La is preferably set as long as possible. However, if the distance La is too long, the volume of the secondary battery 220 increases.

The distance La between the positive and negative electrodes 211a and 211b and one of the seal portions 223 is preferably increased as the total thickness of the stacked positive electrodes 211a and negative electrodes 211b is larger.

Specifically, when the total thickness of the stacked positive electrodes 211a, negative electrodes 211b, and separators 214 (not illustrated) is referred to as a thickness t, the distance La is preferably 0.8 times or more and 3.0 times or less, further preferably 0.9 times or more and 2.5 times or less, still further preferably 1.0 times or more and 2.0 times or less as large as the thickness t. Alternatively, the distance La is preferably 0.8 times or more and 2.5 times or less, 0.8 times or more and 2.0 times or less, 0.9 times or more and 3.0 times or less, 0.9 times or more and 2.0 times or less, 1.0 times or more and 3.0 times or less, or 1.0 times or more and 2.5 times or less as large as the thickness t. With the distance La in the above range, a compact battery that is highly reliable for bending can be obtained.

When the distance between the pair of seal portions 223 is referred to as a distance Lb, it is preferred that the distance Lb be sufficiently larger than the widths of the positive electrodes 211a and the negative electrodes 211b (here, a width Wb of the negative electrodes 211b). In that case, even when the positive electrodes 211a and the negative electrodes 211b come into contact with the exterior body 221 by change in the shape of the secondary battery 220, such as repeated bending, the positions of parts of the positive and negative electrodes 211a and 211b can be shifted in the width direction; thus, the positive and negative electrodes 211a and 211b and the exterior body 221 can be effectively prevented from being rubbed against each other.

For example, the difference between the distance Lb (i.e., the distance between the pair of seal portions 223) and the width Wb of the negative electrodes 211b is preferably 1.6 times or more and 6.0 times or less, further preferably 1.8 times or more and 5.0 times or less, still further preferably 2.0 times or more and 4.0 times or less as large as the thickness t of the positive and negative electrodes 211a and 211b. Alternatively, the difference is preferably 1.6 times or more and 5.0 times or less, 1.6 times or more and 4.0 times or less, 1.8 times or more and 6.0 times or less, 1.8 times or more and 4.0 times or less, 2.0 times or more and 6.0 times or less, or 2.0 times or more and 5.0 times or less as large as the thickness t.

Here, when the value obtained by dividing the difference between the distance Lb and the width Wb (Lb−Wb) by twice the thickness t (2t) is represented by a, a is 0.8 or more and 3.0 or less, preferably 0.9 or more and 2.5 or less, further preferably 1.0 or more and 2.0 or less. Alternatively, a is 0.8 or more and 2.5 or less, 0.8 or more and 2.0 or less, 0.9 or more and 3.0 or less, 0.9 or more and 2.0 or less, 1.0 or more and 3.0 or less, or 1.0 or more and 2.5 or less.

FIG. 37D illustrates a cross section including the lead 212a and corresponds to a cross section of the secondary battery 220, the positive electrodes 211a, and the negative electrodes 211b in the length direction. As illustrated in FIG. 37D, a space 227 is preferably provided in the folded portion 222 between the exterior body 221 and the end portions of the positive and negative electrodes 211a and 211b in the length direction.

FIG. 37E is a schematic cross-sectional view of the secondary battery 220 in a state of being bent. FIG. 37E corresponds to a cross section along the cutting line B1-B2 in FIG. 37A.

When the secondary battery 220 is bent, the exterior body 221 is deformed such that a part positioned on the outer side of bending expands and another part positioned on the inner side of bending contracts. Specifically, the part of the exterior body 221 positioned on the outer side of bending is deformed such that the wave amplitude becomes smaller and the length of the wave period becomes larger. By contrast, the part of the exterior body 221 positioned on the inner side of bending is deformed such that the wave amplitude becomes larger and the length of the wave period becomes smaller. When the exterior body 221 changes its shape in this manner, stress applied to the exterior body 221 due to bending is relieved, so that a material itself of the exterior body 221 does not need to expand and contract. Thus, the secondary battery 220 can be bent with weak force without damage to the exterior body 221.

Furthermore, as illustrated in FIG. 37E, when the secondary battery 220 is bent, the positions of the positive and negative electrodes 211a and 211b are shifted relatively. At this time, one end of the stacked positive and negative electrodes 211a and 211b on the seal portion 224 side is fixed by a fixing member 217. Thus, the plurality of positive electrodes 211a and the plurality of negative electrodes 211b are more shifted at a position closer to the folded portion 222. Accordingly, stress applied to the positive electrodes 211a and the negative electrodes 211b is relieved, and the positive electrodes 211a and the negative electrodes 211b themselves do not need to expand and contract. Consequently, the secondary battery 220 can be bent without damage to the positive electrodes 211a and the negative electrodes 211b.

The space 227 is provided between the positive and negative electrodes 211a and 211b and the exterior body 221, whereby the relative positions of the positive electrodes 211a and the negative electrodes 211b can be shifted while the positive electrodes 211a and the negative electrodes 211b located on the inner side when the secondary battery 220 is bent do not come in contact with the exterior body 221.

Note that the exterior body 221 may have a region where one of the trough lines 226 is in contact with the electrode stack 210.

In the secondary battery 220 illustrated in FIGS. 37A to 37E and FIGS. 38A and 38B as an example, the exterior body, the positive electrodes 211a, and the negative electrodes 211b are less likely to be damaged and the battery performance is less likely to deteriorate even when the secondary battery 220 is repeatedly bent and unbent.

In an all-solid-state battery, the contact state of the inside interfaces can be kept favorable by applying a predetermined pressure in the direction of stacking positive electrodes and negative electrodes. By applying a predetermined pressure in the direction of stacking the positive electrodes and the negative electrodes, the amount of expansion of the all-solid-state battery in the stacking direction due to charge and discharge can be suppressed, and the reliability of the all-solid-state battery can be improved.

The control unit, the memory unit, and the communication unit included in the electronic device 500, the sensor, and the like can each be provided in at least one of the system unit 525, the system unit 526, and the system unit 527.

A reflective surface 523 serving as a screen is formed in the optical component 504. The reflective surface 523 functions as a half mirror and transmits light. FIG. 1C is a cross-sectional view of the electronic device 500 illustrated in FIG. 1A. As shown by an arrow in FIG. 1C, light emitted from the display device 521 is reflected by the reflective plate 522 and then enters the optical component 504. The light is totally reflected in the optical component 504 and reaches the reflective surface 523, whereby an image is projected on the reflective surface 523. The user can see the image projected on the reflective surface 523 so as to be superimposed on an image transmitted through the reflective surface 523.

Although a pair of display devices 521 are provided above the reflective surface 523 and image projection is performed from the above in an example illustrated in FIG. 1C, the pair of display devices 521 may be provided below the reflective surface 523. Alternatively, the pair of display devices 521 may be provided on the left and right of the reflective surface 523.

The light-blocking portion 507 preferably has a low visible light transmittance, for example. In the light-blocking portion 507, a black film or a black layer can be used as a light-blocking film, for example. The light-blocking portion 507 has a function of blocking external light and the like in the lateral direction to increase visibility of an image displayed on the optical component 504.

It is preferred that an image be favorably displayed in the electronic device 500 when the absolute value of a viewing angle is less than or equal to 50° or less than or equal to 60°. The light-blocking portion 507 may be provided in a region where the absolute value of a viewing angle is greater than 50° or greater than 60° in a display portion.

Since the light-blocking portion 507 can block information other than that displayed on the display portion, realistic feeling and sense of immersion can be enhanced. Moreover, fear can be fostered in a fear experience depending on the usage conditions.

The wearing tool 505 can employ various modes as long as it can be fixed to the user's head. FIG. 1A and the like illustrate examples where the wearing tool 505 has a shape like a temple of glasses; however, one embodiment of the present invention is not limited thereto. The wearing tool 505 can have any shape with which the user can wear the electronic device, for example, a shape of a helmet or a band.

When the housing 501 has a cylindrical shape curved along the user's head, the electronic device 500 that fits snugly can be obtained. Unlike conventional smartphones and tablet terminals, the electronic device 500 that fits snugly does not need to be held by hand; thus, the user can operate the electronic device or the like by both hands while viewing an image displayed on the electronic device 500.

Since the electronic device 500 fits snugly, the electronic device 500 may be operated by gesture operation using one or both hands while being worn on the user's head. Conventional smartphones, tablet terminals, and the like have been inconvenient because, for example, the main body needs to be grasped by one hand and the screen needs to be operated by finger(s) of the hand grasping the main body or the other hand, so that at least one hand is occupied by the device even when the screen is small. The gesture operation of the electronic device 500 of one embodiment of the present invention enables hands-free operation.

When the electronic device 500 is provided with a microphone, the electronic device 500 can be operated by voice input.

The electronic device 500 preferably has a function of wirelessly feeding power to the secondary battery 524. The wireless power feeding can be performed using an antenna, for example. The antenna can be provided on any of the system unit 525, the system unit 526, the system unit 527, the optical component 504, and the wearing tool 505, for example.

The electronic device 500 may include an earphone 508. The earphone 508 can be directly connected to or connected by wire to the wearing tool 505. The earphone 508 may include a magnet. This is preferred because the earphone 508 can be fixed to the wearing tool 505 with magnetic force and thus can be easily housed. The earphone 508 may include a communication unit and have a wireless communication function. The earphone 508 can output audio data with the wireless communication function. Note that the earphone 508 may include a vibration mechanism to function as a bone conduction earphone. The earphone 508 may include a sensor unit. With the use of the sensor unit, the state of the user of the electronic device can be estimated.

Alternatively, a speaker or the like can be used to output audio data. For example, an amplifier and a speaker can be provided in the wearing tool 505.

The electronic device 500 may have a function of outputting audio data that matches the orientation of the user's head using head tracking.

The electronic device 500 includes two types of imaging devices (cameras 531 and 532) for capturing images of the outside of the electronic device. The camera 531 has a function of capturing an image of the front side of the housing 501, and includes a wide-angle lens for capturing an image within a range of about one meter from the electronic device 500, for example. The camera 531 is an imaging device mainly used for capturing an image of user's hands movement for gesture operation. The camera 532 is an imaging device mainly used for capturing the scenery. The camera 532 has a lens that is more telephoto than that of the camera 531, that is, the camera 532 has a longer focal length and a narrower angle of view than the camera 531. The camera 531 and the camera 532 may each include a zooming mechanism for changing the focal length. In that case, the camera 532 whose maximum focal length is greater than the maximum focal length of the camera 531 is selected.

FIG. 1A and the like illustrate the electronic device 500 including a pair of cameras 531 and a pair of cameras 532. Such an electronic device can perform stereo imaging, so that 3D images can be captured and a distance to an object can be estimated. Note that the electronic device 500 may include one camera 531 and one camera 532, or include either one of the camera 531 and the camera 532.

The electronic device 500 includes a pair of imaging devices (cameras 533) for capturing an image of the inner side of the electronic device. One of the pair of cameras 533 captures an image of the right eye and the other captures an image of the left eye. The cameras 533 preferably have sensitivity to infrared light. Since the cameras 533 can capture images of the use's right and left eyes independently, the images can be used for iris authentication, health care, or eye tracking, for example. Although not illustrated, a light source that emits infrared light used for lighting is preferably included. Note that the electronic device 500 may include one camera 533 that captures an image of both eyes, or include one camera 533 that captures an image of one eye.

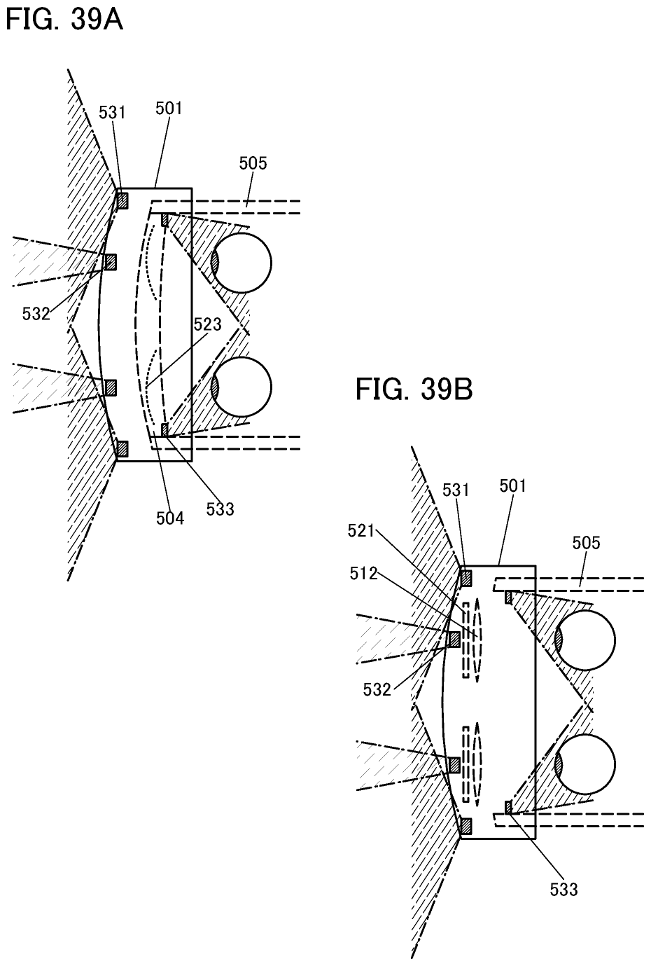

FIG. 39A illustrates examples of image-capturing ranges of the cameras 531, 532, and 533 using dashed-dotted lines. Note that some components such as the display device 521 are not illustrated in FIG. 39A.

Although an example where the cameras 531 are provided is described here, a range sensor (hereinafter also referred to as a sensing unit) capable of measuring the distance between the user and an object may be provided as the camera 531. In other words, the camera 531 is one embodiment of the sensing unit. As the sensing unit, an image sensor or a range image sensor such as a light detection and ranging (LiDAR) sensor can be used, for example. By using images obtained by the camera and images obtained by the range image sensor, more information can be obtained and a gesture operation with higher accuracy is possible.

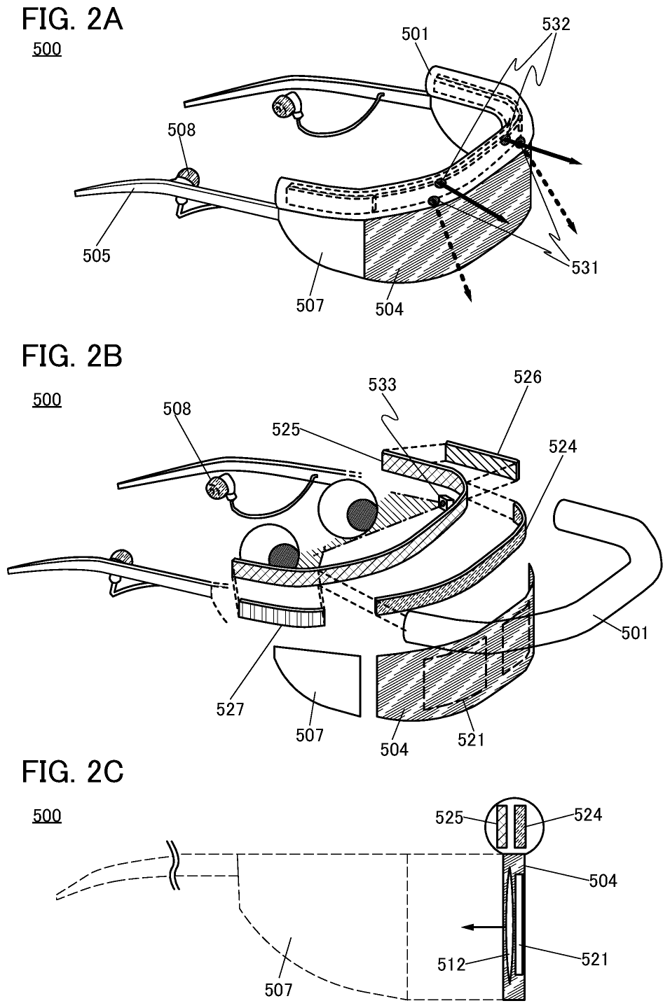

FIG. 2A illustrates an example of a perspective view of the electronic device 500. FIG. 2A is different from FIG. 1A in that, for example, the display device 521 is provided on the optical component 504. As illustrated in FIG. 2A, the electronic device 500 includes the optical component 504, a pair of wearing tools 505, a pair of display devices 521, and a pair of lenses 512. Note that one display device may be provided instead of the pair of display devices 521. As the lenses 512, spherical lenses, aspheric lenses, Fresnel lenses, or the like can be used. The use of aspheric lenses can result in a reduction in the thickness of the lenses 512 in some cases.

Each of the optical components 504 includes the display device 521 and the lens 512. The user can see an image displayed on the display device 521 through the optical component 504 and the lens 512.

The optical component 504 preferably includes a mechanism for adjusting the distance or angle between the display device 521 and the lens 512. This enables focus adjustment and zooming in/out of images. One or both of the display device 521 and the lens 512 are configured to be movable in the optical-axis direction, for example.

FIG. 2B illustrates the components of the electronic device 500 illustrated in FIG. 2A. FIG. 2C is a cross-sectional view of the electronic device 500 illustrated in FIG. 2A.

FIG. 39B illustrates examples of image-capturing ranges of the cameras 531, 532, and 533 using dashed-dotted lines.

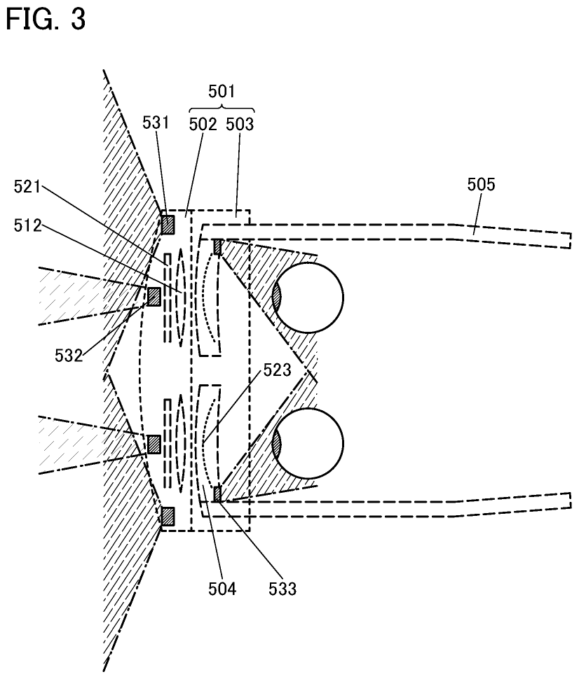

FIG. 3 illustrates an example in which the housing 501 of the electronic device 500 includes a region 502 and a region 503, the cameras 533 are provided in the region 503, and the cameras 531 and 532 are provided in the region 502. The electronic device 500 illustrated in FIG. 3 includes, in addition to a pair of display devices 521 and a pair of lenses 512, the reflective surface 523 provided in each of a pair of optical components 504.

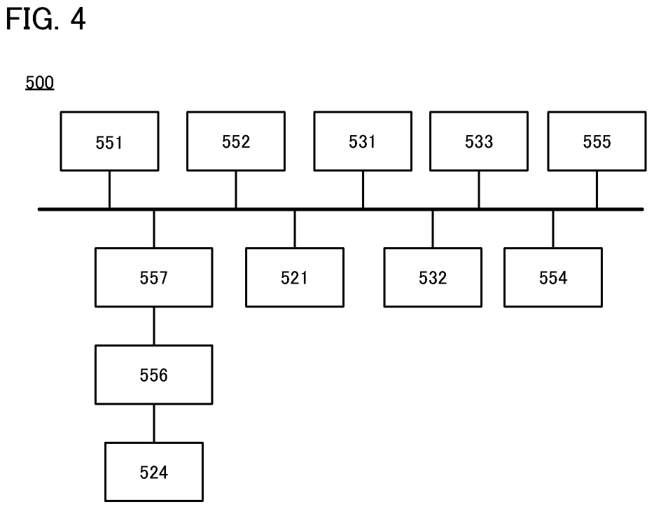

FIG. 4 is a block diagram illustrating an example of a hardware configuration of part of the electronic device 500. The electronic device 500 includes a control unit 551, the display device 521, a memory unit 552, the camera 531, the camera 532, the camera 533, a communication unit 554, a brain wave sensor 555, the secondary battery 524, a charging circuit unit 556, a power supply circuit unit 557, and the like. The components are electrically connected to one another via a bus line, for example. The components are electrically connected to one another without via the bus line, in some cases.

In FIG. 4, the control unit 551, the memory unit 552, the display device 521, the camera 531, the camera 532, the camera 533, the communication unit 554, and the brain wave sensor 555 are electrically connected to one another via the bus line.

In FIG. 4, the secondary battery 524 is electrically connected to the charging circuit unit 556, the charging circuit unit 556 is electrically connected to the power supply circuit unit 557, and the power supply circuit unit 557 is electrically connected to components such as the control unit 551, the memory unit 552, and the display device 521 via the bus line.

Hereinafter, for simple description, in the case where constituent elements other than the control unit 551 included in the electronic device 500 are not distinguished from one another, each constituent element is sometimes referred to as a component, for example.

The control unit 551 can function as, for example, a central processing unit (CPU). The control unit 551 has a function of controlling components.

The control unit 551 may be provided in any one or more of the system unit 525, the system unit 526, and the system unit 527 included in the electronic device 500, for example.

The memory unit 552 can store various kinds of data such as program data, system data, and user data. The control unit 551 can read data from the memory unit 552 and can store data in the memory unit 552.

The control unit 551 has a function of executing authentication processing using imaging data. For example, the control unit 551 can execute iris authentication processing using imaging data. Specifically, the control unit 551 compares the features of a captured image of an iris with the features of the user's iris stored in advance in the memory unit 552 to determine whether the irises belong to the same person.

The brain wave sensor 555 has a function of acquiring the user's brain waves and output the data to the control unit 551. The brain wave sensor 555 includes at least one electrode that is in contact with the user's forehead, for example. The brain wave sensor 555 can acquire data on frequency and amplitude of brain waves such as α-waves, β-waves, θ-waves, and δ-waves. The control unit 551 can estimate the user's wakefulness state or the like from the brain wave data and execute processing in accordance with the wakefulness state.

The charging circuit unit 556 is electrically connected to the secondary battery. The charging circuit unit 556 has a function of charging the secondary battery. Furthermore, the charging circuit unit 556 has a function of receiving power supplied from the outside. The charging circuit unit 556 may include a power supply circuit. The charging circuit unit 556 preferably has a function of performing wireless power feeding.

The charging circuit unit 556 has a function of measuring at least one of voltage and current of the secondary battery, for example. The charging circuit unit 556 preferably has a function of measuring or estimate the remaining capacity of the secondary battery. The remaining capacity of the secondary battery can be estimated using a coulomb counter, for example. The charging circuit unit 556 has a function of monitoring the parameters of the secondary battery such as voltage, current, and remaining capacity. The charging circuit unit 556 has a function of controlling charging conditions of the secondary battery in accordance with the values of the monitored parameters. The charging conditions may be controlled such that charging is stopped, for example.

The charging circuit unit 556 preferably functions as a protection circuit. Alternatively, the electronic device 500 may be provided with a protection circuit for the secondary battery in addition to the charging circuit unit 556.

The protection circuit for the secondary battery has a function of setting the upper voltage limit of the secondary battery to inhibit overcharge, for example. The protection circuit for the secondary battery has a function of setting the lower voltage limit of the secondary battery to inhibit overdischarge, for example. The protection circuit for the secondary battery has a function of setting the upper current limit of the secondary battery to inhibit charge overcurrent or discharge overcurrent, for example.

The protection circuit for the secondary battery is set to have the upper limit voltage and the lower limit voltage of the secondary battery used, and imposes the upper limit of current from the outside or the upper limit of current output to the outside, for example. The protection circuit for the secondary battery includes a switch unit, for example. The range from the lower limit voltage to the upper limit voltage set in the protection circuit for the secondary battery falls within the recommended voltage range. When a voltage falls outside the range, the switch unit operates in the protection circuit for the secondary battery and the protection circuit functions as a circuit for protecting the secondary battery. For example, when a voltage that is likely to cause overcharge is detected, current is interrupted by turning off the switch in the switch unit. Furthermore, a function of interrupting current in accordance with a temperature rise may be set by providing a PTC element in the charge and discharge path.

The switch unit can be formed by a combination of n-channel transistors and/or p-channel transistors. The switch unit is not limited to including a switch having a Si transistor using single crystal silicon; the switch unit may be formed using a power transistor containing germanium (Ge), silicon germanium (SiGe), gallium arsenide (GaAs), gallium aluminum arsenide (GaAlAs), indium phosphide (InP), silicon carbide (SiC), zinc selenide (ZnSe), gallium nitride (GaN), gallium oxide (GaOₓ), where x is a real number greater than 0), or the like. A memory element using a transistor containing a metal oxide (also referred to as an oxide semiconductor) in its channel formation region (hereinafter, such a transistor is also referred to as an OS transistor) can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the protection circuit using OS transistors can be stacked over the switch unit so that they can be integrated into one chip. Since the area occupied by the protection circuit can be reduced, a reduction in size is possible.

Signals are transmitted between the control unit 551 and the components via the bus line. The control unit 551 has a function of processing signals input from the components which are connected through the bus line, a function of generating signals to be output to the components, and the like, so that the components connected to the bus line can be controlled comprehensively.

Note that a transistor that contains an oxide semiconductor in its channel formation region and that has an extremely low off-state current can be used in an IC or the like included in the control unit 551 or another component. With the use of the transistor having an extremely low off-state current as a switch for holding electric charge (data) which flows into a capacitor serving as a memory element, a long data retention period can be ensured. By utilizing this characteristic for a register, a cache memory, or the like of the control unit 551, normally-off computing is achieved where the control unit 551 operates only when needed and power supply to the control unit 551 is stopped after data on the previous processing is stored in the memory element when the control unit 551 is not used; thus, power consumption of the electronic device 500 can be reduced.

The control unit 551 interprets and executes instructions from various programs with the use of a processor to process various kinds of data and control programs. The programs executed by the processor may be stored in a memory region of the processor or in the memory unit 552.

A CPU and another microprocessor such as a digital signal processor (DSP) or a graphics processing unit (GPU) can be used alone or in combination as the control unit 551. Furthermore, such a microprocessor may be obtained with a programmable logic device (PLD) such as a field programmable gate array (FPGA) or a field programmable analog array (FPAA).

The control unit 551 may include a main memory. The main memory can include a volatile memory, such as a random access memory (RAM), or a nonvolatile memory, such as a read only memory (ROM).

For example, a dynamic random access memory (DRAM) is used for the RAM included in the main memory, in which case a memory space as a workspace for the control unit 551 is virtually allocated and used. An operating system, an application program, a program module, program data, and the like which are stored in the memory unit 552 are loaded into the RAM and executed. The data, program, program module, and the like which are loaded into the RAM are directly accessed and operated by the control unit 551.

In the ROM, a basic input/output system (BIOS), firmware, and the like for which rewriting is not needed can be stored. As the ROM, a mask ROM, a one-time programmable read only memory (OTPROM), or an erasable programmable read only memory (EPROM) can be used. As an EPROM, an ultra-violet erasable programmable read only memory (UV-EPROM) which can erase stored data by irradiation with ultraviolet rays, an electrically erasable programmable read only memory (EEPROM), a flash memory, and the like can be given.

The control unit 551 preferably includes a processor specialized for parallel arithmetic operation as compared with a CPU. For example, a processor including a large number of (e.g., several tens to several hundreds of) processor cores capable of parallel processing, such as a GPU, a tensor processing unit (TPU), or a neural processing unit (NPU), is preferably included. Accordingly, the control unit 551 can especially perform arithmetic operation by a neural network at high speed.

Examples of the memory unit 552 are a memory device including a nonvolatile memory element, such as a flash memory, a magnetoresistive random access memory (MRAM), a phase change RAM (PRAM), a resistive RAM (ReRAM), or a ferroelectric RAM (FeRAM); a memory device including a volatile memory element, such as a dynamic RAM (DRAM) or a static RAM (SRAM); and the like. A memory media drive such as a hard disk drive (HDD) or a solid state drive (SSD) may be used, for example.

The communication unit 554 can transmit and receive data to and from an external communication apparatus wirelessly. The communication unit 554 can communicate via an antenna, for example. In a communication means (communication method) of the communication unit 554, for example, the communication can be performed in such a manner that a device such as an external communication apparatus is connected to a computer network such as the Internet (infrastructure of the World Wide Web, WWW), an intranet, an extranet, a personal area network (PAN), a local area network (LAN), a campus area network (CAN), a metropolitan area network (MAN), a wide area network (WAN), or a global area network (GAN). A communication protocol or a communication technology used for wireless communication is a communications standard such as Long-Term Evolution (LTE), Global System for Mobile Communication (GSM: registered trademark), Enhanced Data Rates for GSM Evolution (EDGE), Code Division Multiple Access 2000 (CDMA2000), or W-CDMA (registered trademark), or a communications standard developed by IEEE such as Wi-Fi (registered trademark), Bluetooth (registered trademark), or ZigBee (registered trademark).

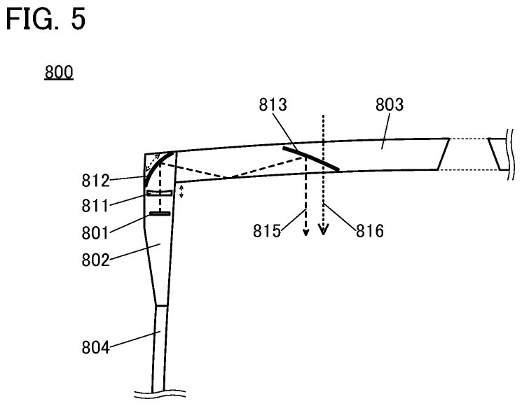

FIG. 5 illustrates an example of an image projection method for the electronic device of one embodiment of the present invention.

An electronic device 800 illustrated in FIG. 5 includes a pair of display panels 801, a pair of housings 802, a pair of optical components 803, a pair of components 804, and the like. The display panel 801, a lens 811, and a reflective plate 812 are provided in each of the housings 802. A reflective surface 813 functioning as a half mirror is provided in a portion corresponding to a display region of each of the optical components 803.

Light 815 emitted from the display panel 801 passes through the lens 811 and is reflected by the reflective plate 812 to the optical component 803 side. In the optical component 803, the light 815 is fully reflected repeatedly by end surfaces of the optical component 803 and reaches the reflective surface 813, whereby an image is projected on the reflective surface 813. Accordingly, the user can see both the light 815 reflected by the reflective surface 813 and transmitted light 816 transmitted through the optical component 803 (including the reflective surface 813).

FIG. 5 illustrates an example in which the reflective plate 812 and the reflective surface 813 each have a curved surface. This can increase optical design flexibility and reduce the thickness of the optical component 803, compared to the case where they have flat surfaces. Note that the reflective plate 812 and the reflective surface 813 may be flat.

The reflective plate 812 can use a component having a mirror surface, and preferably has high reflectivity. As the reflective surface 813, a half mirror utilizing reflection of a metal film may be used, but the use of prism utilizing total reflection or the like can increase the transmittance of the transmitted light 816.

Here, the housing 802 preferably includes a mechanism for adjusting the distance or angle between the lens 811 and the display panel 801. This enables focus adjustment and zooming in/out of image. One or both of the lens 811 and the display panel 801 are preferably configured to be movable in the optical-axis direction, for example.

The housing 802 preferably includes a mechanism capable of adjusting the angle of the reflective plate 812. The position of the display region where images are displayed can be changed by changing the angle of the reflective plate 812. Thus, the display region can be placed at the most appropriate position in accordance with the position of the user's eye.

A display module or the display device of one embodiment of the present invention can be used for the display panel 801. Thus, the electronic device 800 is capable of performing ultrahigh-resolution display.

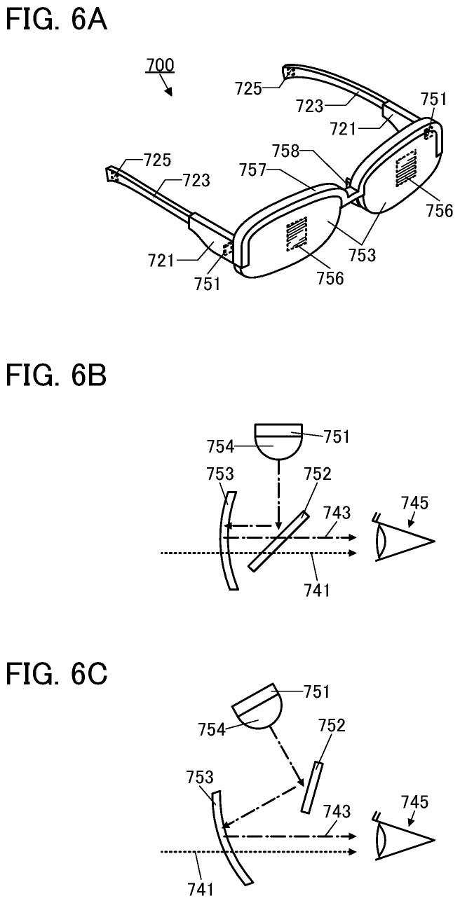

Next, an example where an image is projected from above an optical component in the electronic device of one embodiment of the present invention will be described with reference to FIGS. 6A to 6C.

An electronic device 700 illustrated in FIG. 6A includes a pair of display panels 751, a pair of housings 721, a communication unit (not illustrated), a pair of wearing portions 723, a control unit (not illustrated), an image capturing unit (not illustrated), a pair of optical components 753, a frame 757, and a pair of nose pads 758.

The display device of one embodiment of the present invention can be used for each of the display panels 751. Thus, the electronic device is capable of performing ultrahigh-resolution display.

The electronic device 700 can project images displayed on the display panels 751 onto display regions 756 of the optical components 753. Since the optical components 753 have a light-transmitting property, the user can see images displayed on the display regions, which are superimposed on transmission images viewed through the optical components 753. Accordingly, the electronic device 700 is capable of AR display.

In the electronic device 700, a camera capable of capturing images of the front side may be provided as the image capturing unit. Furthermore, when the electronic device 700 is provided with an acceleration sensor such as a gyroscope sensor, the orientation of the user's head can be sensed and an image corresponding to the orientation can be displayed on the display regions 756.

The pair of wearing portions 723 each include a vibration module 725 serving as a sound output means. The vibration modules 725 enable part of the wearing portions 723 to function as bone conduction speakers. Bone conduction allows the user to listen to sounds without concern for sound leakage to the surroundings. Note that an earphone may be used as the sound output means.

The communication unit includes a wireless communication device, and a video signal and the like can be supplied by the wireless communication device. Instead of or in addition to the wireless communication device, a connector that can be connected to a cable for supplying a video signal and a power supply potential may be provided.

The electronic device 700 is provided with a battery so that charging can be performed wirelessly and/or by wire.

A touch sensor module may be provided in the housing 721. The touch sensor module has a function of detecting a touch on the outer surface of the housing 721. Detecting a tap operation, a slide operation, or the like by the user with the touch sensor module enables various types of processing. For example, a video can be paused or restarted by a tap operation, and can be fast-forwarded or fast-reversed by a slide operation. When the touch sensor module is provided in each of the two housings 721, the range of the operation can be increased.

Various touch sensors can be applied to the touch sensor module. For example, any of touch sensors of the following types can be used: a capacitive type, a resistive type, an infrared type, an electromagnetic induction type, a surface acoustic wave type, and an optical type. In particular, a capacitive sensor or an optical sensor is preferably used for the touch sensor module.

In the case of using an optical touch sensor, a photoelectric conversion device (also referred to as a photoelectric conversion element) can be used as a light-receiving device (also referred to as a light-receiving element). One or both of an inorganic semiconductor and an organic semiconductor can be used for an active layer of the photoelectric conversion device.

FIG. 6A illustrates a structure in which the display panels 751 are provided on the housings 721 and images are projected from the sides of the optical components 753. Without limitation to this structure, the display panels 751 may each have a structure in which an image is projected from above or below the corresponding optical component 753.

FIG. 6B illustrates an example where an image is projected from above the optical component 753. Each of the display panels 751 is positioned on the frame 757 such that an image is output therebelow, for example. Part of light emitted from the display panel 751 is reflected by an optical component 752 to the optical component 753 side and projected on the optical component 753. Part of the light reflected by the optical component 753 (light 743) passes through the optical component 752 and then reaches an eye 745 of the user. Meanwhile, external light 741 passes through the optical component 753 and the optical component 752 and reaches the eye 745 of the user. In this manner, an image from the display panel 751 can be superimposed on a real-world scenery.

A lens 754 may be provided on the display panel 751 on its display surface side. Furthermore, a microlens array may be provided between the display panel 751 and the lens 754.

The optical component 752 and the optical component 753 can each include a polarizing plate, a circularly polarizing plate, a lens, a half mirror, or the like. The optical component 752 functions as a beam splitter and has a function of transmitting light with predetermined polarization and reflecting light with other polarization, for example. The optical component 753 condenses and reflects light from the optical component 752 and polarizes the light such that the light can pass through the optical component 752.

As illustrated in FIG. 6C, the optical component 752 may be provided above the optical axes of the external light 741 and the light 743. In the structure illustrated in FIG. 6C, the external light 741 or the light 743 reflected by or passing through the optical component 753 reaches the eye 745 of the user without passing through the optical component 752. Accordingly, distortion of a viewed image can be further inhibited, for example. Meanwhile, the housing 721 and the electronic device 700 in the structure illustrated in FIG. 6B can be smaller than those in the structure illustrated in FIG. 6C, in some cases.

### [Example of Image]

Hereinafter, operation examples of a display system of one embodiment of the present invention that a user can experience and examples of images that can be shown to the user will be described.

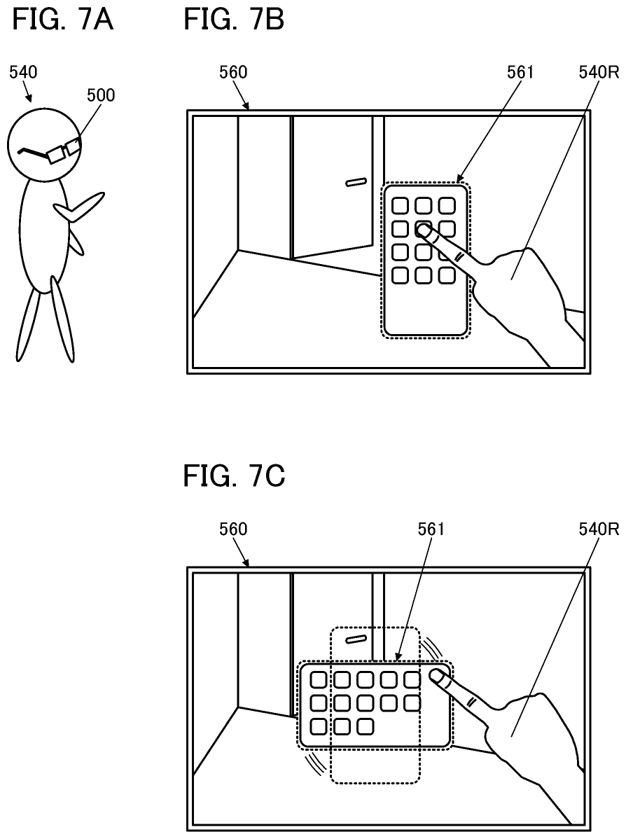

FIG. 7A illustrates a user 540 performing gesture operation while wearing the electronic device 500. Here, an image can be displayed on the screen so as to be superimposed on a real-world scenery viewed through the screen in the electronic device 500; thus, the user 540 can see an image displayed in an AR mode.

FIG. 7B illustrates an example of a field of view 560 of the user 540 in FIG. 7A. The field of view 560 includes image data 561 superimposed on a real-world indoor scenery including a floor, a wall, a door, and the like. Here, an image imitating a screen of a smartphone or a tablet terminal is illustrated as the image data 561.

Since the user can operate the image data 561 that appears to float in the air as in the case of operating a smartphone, the user can use the electronic device 500 without feeling uncomfortable. When the user 540 operates the image data 561 by its edge using a finger of a right hand 540R as illustrated in FIG. 7C, the image data 561 can be rotated from portrait orientation to landscape orientation.

At least part of any of the structure examples, the drawings corresponding thereto, and the like described in this embodiment can be implemented in combination with any of the other structure examples, the other drawings corresponding thereto, and the like as appropriate.

### Embodiment 2

Hereinafter, structure examples of a display device applicable to the display device of the electronic device described as an example in Embodiment 1 will be described with reference to drawings.

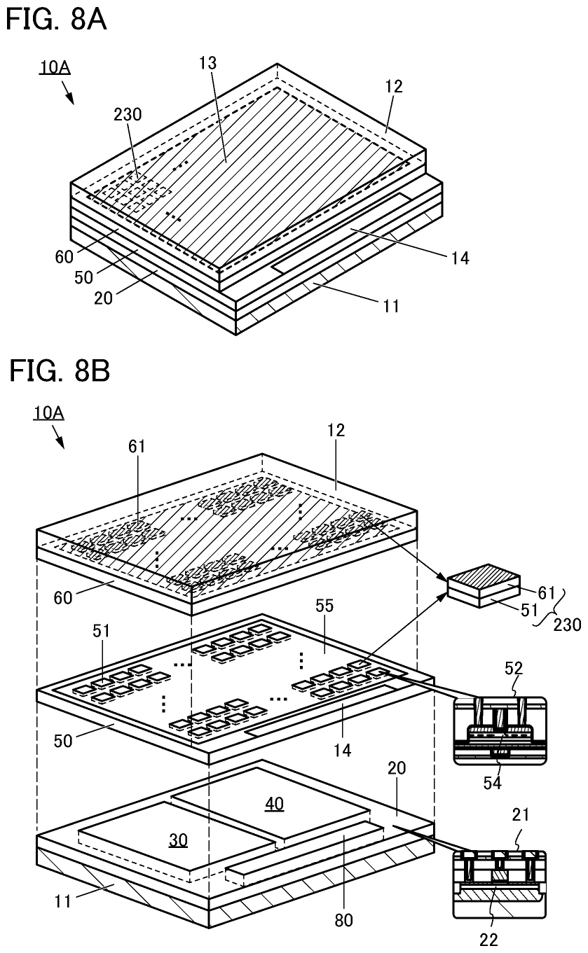

FIG. 8A is a perspective view of a display device 10A applicable to the display device of the electronic device described as an example in Embodiment 1. The display device 10A can be used as the display device 521.

The display device 10A includes a substrate 11 and a substrate 12. The display device 10A includes a display portion 13 composed of elements provided between the substrate 11 and the substrate 12. The display portion 13 is a region where an image is displayed in the display device 10A. The display portion 13 includes a plurality of pixels 230. The pixels 230 each include a pixel circuit 51 and a light-emitting element 61.

Using the pixels 230 arranged in a matrix of 1920×1080, the display portion 13 can achieve display with full high definition (also referred to as 2K resolution, 2K1K, 2K, and the like). Using the pixels 230 arranged in a matrix of 3840×2160, for example, the display portion 13 can achieve display with ultra-high definition (also referred to as 4K resolution, 4K2K, 4K, and the like). Using the pixels 230 arranged in a matrix of 7680×4320, for example, the display portion 13 can achieve display with super high definition (also referred to as 8K resolution, 8K4K, 8K, and the like). Using a larger number of pixels 230, the display portion 13 can achieve display with 16K or 32K resolution.

The pixel density (resolution) of the display portion 13 is preferably higher than or equal to 1000 ppi and lower than or equal to 10000 ppi. For example, the pixel density may be higher than or equal to 2000 ppi and lower than or equal to 6000 ppi, or higher than or equal to 3000 ppi and lower than or equal to 5000 ppi.

There is no particular limitation on the screen ratio (aspect ratio) of the display portion 13. For example, the display portion 13 is compatible with a variety of screen ratios such as 1:1 (a square), 4:3, 16:9, and 16:10.

Note that in this specification and the like, the term “element” can be replaced with the term “device” in some cases. For example, a display element, a light-emitting element, and a liquid crystal element can be rephrased as a display device, a light-emitting device, and a liquid crystal device, respectively.

In the display device 10A, various kinds of signals and power supply potentials are input from the outside via a terminal portion 14, whereby an image can be displayed using a display element provided in the display portion 13. Any of a variety of elements can be used as the display element. A light-emitting element having a function of emitting light, such as an organic EL element or an LED element, a liquid crystal element, a micro electro mechanical systems (MEMS) element, or the like can be typically used.

A plurality of layers are provided between the substrate 11 and the substrate 12, and each of the layers is provided with a transistor for circuit operation, or a display element which emits light. A pixel circuit having a function of controlling operation of the display element, a driver circuit having a function of controlling the pixel circuit, a functional circuit having a function of controlling the driver circuit, and the like are provided in the plurality of layers.

FIG. 8B is a perspective view schematically illustrating structures of layers provided between the substrate 11 and the substrate 12.

A layer 20 is provided over the substrate 11. The layer 20 includes a driver circuit 30, a functional circuit 40, and an input/output circuit 80. The layer 20 includes a transistor 21 containing silicon in a channel formation region 22 (also referred to as a Si transistor). The substrate 11 is, for example, a silicon substrate. A silicon substrate is preferably used because of having higher thermal conductivity than a glass substrate. Since the driver circuit 30, the functional circuit 40, and the input/output circuit 80 are provided in the same layer, wirings electrically connecting the driver circuit 30, the functional circuit 40, and the input/output circuit 80 can be short. As a result, charge and discharge time of a control signal used when the functional circuit 40 controls the driver circuit 30 becomes short, leading to a reduction in power consumption. In addition, charge and discharge time during which a signal is supplied from the input/output circuit 80 to the functional circuit 40 and the driver circuit 30 becomes short, leading to a reduction in power consumption.

The transistor 21 can be a transistor containing single crystal silicon in its channel formation region (such a transistor is also referred to as a “c-Si transistor”), for example. In particular, the use of a transistor containing single crystal silicon in its channel formation region as the transistor provided in the layer 20 can increase the on state-current of the transistor. This is preferable because the circuits included in the layer 20 can be driven at a high speed. The Si transistor can be formed by minute processing to have a channel length greater than or equal to 3 nm and less than or equal to 10 nm, for example; therefore, the display device 10A can be provided with a CPU, an accelerator such as a GPU, an application processor, or the like together with the display portion.

A transistor containing polycrystalline silicon in its channel formation region (such a transistor is also referred to as a “Poly-Si transistor”) may be provided in the layer 20. As the polycrystalline silicon, low-temperature polysilicon (LTPS) may be used. Note that a transistor containing LTPS in its channel formation region is also referred to as an “LTPS transistor”. An OS transistor may be provided in the layer 20.

Any of a variety of circuits such as a shift register, a level shifter, an inverter, a latch, an analog switch, and a logic circuit can be used as the driver circuit 30. The driver circuit 30 includes a gate driver circuit, a source driver circuit, or the like, for example. In addition, an arithmetic circuit, a memory circuit, a power supply circuit, or the like may be included. Since the gate driver circuit, the source driver circuit, and other circuits can be placed to overlap with the display portion 13, the width of a non-display region (also referred to as a bezel) provided along the outer periphery of the display portion 13 of the display device 10A can be extremely narrow compared with the case where these circuits are placed in the same plane as the display portion 13, whereby the display device 10A can be reduced in size.

The functional circuit 40 functions as an application processor for controlling the circuits in the display device 10A and generating signals used for controlling the circuits, for example. The functional circuit 40 may include a CPU and a circuit used for correcting image data, such as an accelerator (e.g., a GPU). The functional circuit 40 may include a low voltage differential signaling (LVDS) circuit serving as an interface for receiving image data or the like from the outside of the display device 10A, a mobile industry processor interface (MIPI) circuit, and/or a digital-to-analog (D/A) converter circuit, for example. The functional circuit 40 may include a circuit for compressing and decompressing image data and/or a power supply circuit, for example.

A layer 50 is provided over the layer 20. The layer 50 includes a pixel circuit group 55 including a plurality of the pixel circuits 51. An OS transistor may be provided in the layer 50. Each of the pixel circuits 51 may include an OS transistor. Note that the layer 50 can be stacked over the layer 20.

A Si transistor may be provided in the layer 50. For example, the pixel circuits 51 may each include a transistor containing single crystal silicon or polycrystalline silicon in its channel formation region. Note that LTPS may be used as the polycrystalline silicon. The layer 50 can be formed over another substrate and bonded to the layer 20, for example.

Alternatively, for example, the pixel circuits 51 may each include a plurality of kinds of transistors formed using different semiconductor materials. In the case where the pixel circuits 51 each include a plurality of kinds of transistors formed using different semiconductor materials, the transistors may be provided in different layers for each kind of transistor. For example, in the case where the pixel circuits 51 and each include a Si transistor and an OS transistor, the Si transistor and the OS transistor may be provided to overlap with each other. Providing the transistors to overlap with each other reduces the area occupied by the pixel circuits 51. Thus, the resolution of the display device 10A can be increased. Note that a structure in which the LTPS transistor and the OS transistor are combined is referred to as LTPO in some cases.

FIG. 8B illustrates a transistor 52 that is an OS transistor as an example of a transistor included in the layer 50. It is preferred that a transistor in which a channel formation region 54 includes an oxide containing at least one of indium, an element M (the element M is aluminum, gallium, yttrium, or tin), and zinc be used as the transistor 52, which is an OS transistor. Such an OS transistor has a characteristic of an extremely low off-state current. Thus, it is preferred that the OS transistor be used as the transistor provided particularly in the pixel circuit, in which case analog data written to the pixel circuit can be retained for a long time.

A layer 60 is provided over the layer 50. The substrate 12 is provided over the layer 60. The substrate 12 is preferably a light-transmitting substrate or a layer formed using a light-transmitting material. The layer 60 includes a plurality of the light-emitting elements 61. The layer 60 can be stacked over the layer 50. As the light-emitting elements 61, organic electroluminescent elements (also referred to as organic EL elements) or the like can be used, for example. Note that the light-emitting elements 61 are not limited thereto and may be inorganic EL elements formed using an inorganic material, for example. Note that an “organic EL element” and an “inorganic EL element” are collectively referred to as “EL element” in some cases. The light-emitting elements 61 may contain inorganic compounds such as quantum dots. For example, when used for a light-emitting layer, quantum dots can function as a light-emitting material.

As illustrated in FIG. 8B, the display device 10A of one embodiment of the present invention can have a structure in which the light-emitting elements 61, the pixel circuits 51, the driver circuit 30, and the functional circuit 40 are stacked; thus, the aperture ratio (effective display area ratio) of the pixels can be significantly increased. For example, the aperture ratio of the pixels can be greater than or equal to 40% and less than 100%, preferably greater than or equal to 50% and less than or equal to 95%, and further preferably greater than or equal to 60% and less than or equal to 95%. Furthermore, the pixel circuits 51 can be arranged extremely densely, resulting in a significant increase in the resolution of the pixels. For example, the pixels can be arranged in the display portion 13 of the display device 10A (a region where the pixel circuits 51 and the light-emitting elements 61 are stacked) with a resolution higher than or equal to 2000 ppi, preferably higher than or equal to 3000 ppi, further preferably higher than or equal to 5000 ppi, still further preferably higher than or equal to 6000 ppi, and lower than or equal to 20000 ppi or lower than or equal to 30000 ppi.

The display device 10A has extremely high resolution and thus can be suitably used for a glasses-type AR device, for example. For example, even in the case of a structure in which the display portion of the display device 10A is viewed through an optical component such as a lens, pixels of the extremely-high-resolution display portion included in the display device 10A are not seen when the display portion is enlarged by the lens, so that display providing a high sense of immersion can be performed.

In the case where the display device 10A is used as a display device for AR, the display portion 13 can have a screen diagonal greater than or equal to 0.1 inches and less than or equal to 5.0 inches, preferably greater than or equal to 0.5 inches and less than or equal to 2.0 inches, further preferably greater than or equal to 1 inch and less than or equal to 1.7 inches. For example, the display portion 13 may have a screen diagonal of 1.5 inches or around 1.5 inches. When the display portion 13 has a screen diagonal less than or equal to 2.0 inches, the number of times of light exposure treatment using a light exposure apparatus (typified by a scanner apparatus) can be one; thus, the productivity of a manufacturing process can be improved.

The display device 10A of one embodiment of the present invention can be used for an electronic device other than a wearable electronic device. In that case, the display portion 13 can have a screen diagonal greater than 2.0 inches. The structure of transistors used in the pixel circuits 51 may be selected as appropriate depending on the screen diagonal of the display portion 13. In the case where single crystal Si transistors are used in the pixel circuits 51, for example, the display portion 13 preferably has a screen diagonal greater than or equal to 0.1 inches and less than or equal to 3 inches. In the case where LTPS transistors are used in the pixel circuits 51, the display portion 13 preferably has a screen diagonal greater than or equal to 0.1 inches and less than or equal to 30 inches, further preferably greater than or equal to 1 inch and less than or equal to 30 inches. In the case where LTPO structures (where an LTPS transistor and an OS transistor are used in combination) are employed in the pixel circuits 51, the display portion 13 preferably has a screen diagonal greater than or equal to 0.1 inches and less than or equal to 50 inches, further preferably greater than or equal to 1 inch and less than or equal to 50 inches. In the case where OS transistors are used in the pixel circuits 51, the display portion 13 preferably has a screen diagonal greater than or equal to 0.1 inches and less than or equal to 200 inches, further preferably greater than or equal to 50 inches and less than or equal to 100 inches.

With the use of single crystal Si transistors, an increase in screen size is extremely difficult due to the size of a single crystal Si substrate. Furthermore, since a laser crystallization apparatus is used in the fabrication process, LTPS transistors are unlikely to respond to an increase in screen size (typically to a screen diagonal greater than 30 inches). By contrast, since the fabrication process does not necessarily require a laser crystallization apparatus or the like or can be performed at a relatively low temperature (typically, lower than or equal to 450° C.), OS transistors can be applied to a display panel with a relatively large area (typically, a screen diagonal greater than or equal to 50 inches and less than or equal to 100 inches). In addition, an LTPO structure can be applied to a display portion with a screen diagonal midway between the screen diagonal for the structure using LTPS transistors and that for the structure using OS transistors (typically, a screen diagonal greater than or equal to 1 inch and less than or equal to 50 inches).

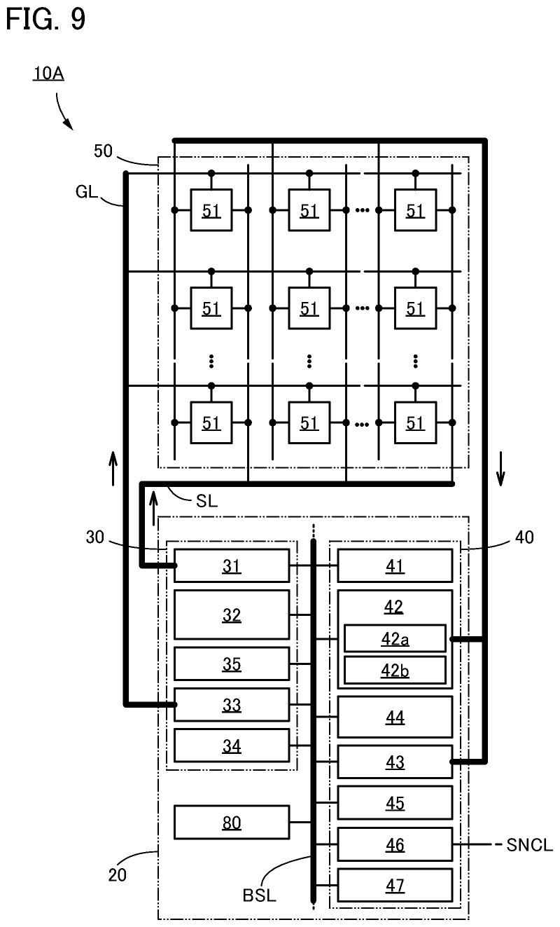

A specific configuration example of the driver circuit 30 and the functional circuit 40 will be described with reference to FIG. 9. FIG. 9 is a block diagram illustrating a plurality of wirings connecting the pixel circuit 51, the driver circuit 30, and the functional circuit 40 in the display device 10A, a bus wiring in the display device 10A, and the like.

In the display device 10A illustrated in FIG. 9, the plurality of pixel circuits 51 are arranged in a matrix in the layer 50.

Furthermore, the driver circuit 30, the functional circuit 40, and the input/output circuit 80 are provided in the layer 20 in the display device 10A illustrated in FIG. 9. The driver circuit 30 includes, for example, a source driver circuit 31, a digital-analog converter (DAC) circuit 32, an amplifier circuit 35, a gate driver circuit 33, and a level shifter 34. The functional circuit 40 includes, for example, a memory device 41, a GPU (AI accelerator) 42, an EL correction circuit 43, a timing controller 44, a CPU 45, a sensor controller 46, and a power supply circuit 47. The functional circuit 40 functions as an application processor.

The input/output circuit 80 is compatible with a transmission method such as low voltage differential signaling (LVDS), and has a function of dividing control signals, image data, and the like input via the terminal portion 14 between the driver circuit 30 and the functional circuit 40. Furthermore, the input/output circuit 80 has a function of outputting data of the display device 10A to the outside via the terminal portion 14.

FIG. 9 illustrates an example of the display device 10A in which the circuits included in the driver circuit 30 and the circuits included in the functional circuit 40 are each electrically connected to a bus wiring BSL.

The source driver circuit 31 has a function of transmitting image data to the pixel circuits 51 included in the pixels 230, for example. Thus, the source driver circuit 31 is electrically connected to the pixel circuits 51 through a wiring SL. Note that a plurality of the source driver circuits 31 may be provided.

The digital-analog converter circuit 32 has a function of converting image data that has been digitally processed by a GPU, a correction circuit, or the like described later, into analog data, for example. The image data converted into analog data is amplified by the amplifier circuit 35 such as an operational amplifier and is transmitted to the pixel circuits 51 via the source driver circuit 31. Note that the image data may be transmitted to the source driver circuit 31, the digital-analog converter circuit 32, and the pixel circuits 51 in this order. The digital-analog converter circuit 32 and the amplifier circuit 35 may be included in the source driver circuit 31.

The gate driver circuit 33 has a function of selecting a pixel circuit to which the image data is transmitted among the pixel circuits 51, for example. Thus, the gate driver circuit 33 is electrically connected to the pixel circuits 51 through a wiring GL. Note that a plurality of the gate driver circuits 33 may be provided so that the number of the gate driver circuits 33 corresponds to the number of the source driver circuits 31.

The level shifter 34 has a function of converting signals to be input to the source driver circuit 31, the digital-analog converter circuit 32, the gate driver circuit 33, and the like into signals having appropriate levels, for example.

The memory device 41 has a function of storing image data to be displayed on the pixel circuits 51, for example. Note that the memory device 41 can be configured to store the image data as digital data or analog data.

In the case where the memory device 41 stores image data, the memory device 41 is preferably a nonvolatile memory. In this case, the memory device 41 can be a NAND memory or the like.

In the case where the memory device 41 stores temporary data generated in the GPU 42, the EL correction circuit 43, the CPU 45, or the like, the memory device 41 is preferably a volatile memory. In that case, a static random access memory (SRAM), a dynamic random access memory (DRAM), or the like can be used as the memory device 41.

The GPU 42 has a function of performing processing for outputting the image data read from the memory device 41 to the pixel circuits 51, for example. Specifically, the GPU 42 is configured to perform pipeline processing in parallel and can thus perform high-speed processing of the image data to be output to the pixel circuits 51. The GPU 42 can also function as a decoder for decoding an encoded image.

The functional circuit 40 may include a plurality of circuits that can increase the display quality of the display device 10A. As such circuits, for example, correction circuits (dimming or toning circuits) that detect and correct color irregularity of an image to be displayed to optimize the image may be provided. In the case where a light-emitting device containing an organic EL material is used for the display element, for example, an EL correction circuit that corrects image data in accordance with the properties of the light-emitting device may be provided in the functional circuit 40. The functional circuit 40 includes, for example, the EL correction circuit 43.

The above-described image correction may be performed using artificial intelligence in the following manner, for example. Currents flowing in the pixel circuits (or voltages applied to the pixel circuits) are monitored and acquired, a displayed image is acquired with an image sensor or the like, the currents (or voltages) and the image are used as input data in an arithmetic operation of the artificial intelligence (e.g., an artificial neural network), and the output result is used to determine whether the image should be corrected.

Such an arithmetic operation of artificial intelligence can be applied to not only image correction but also upconversion for increasing the resolution of image data. As an example, FIG. 9 illustrates the GPU 42 that includes blocks for performing arithmetic operations for various kinds of correction (e.g., color irregularity correction 42a and upconversion 42b).

An algorithm for upconversion processing of image data is selected from a nearest neighbor method, a bilinear method, a bicubic method, a rapid and accurate image super-resolution (RAISR) method, an anchored neighborhood regression (ANR) method, an A+ method, a super-resolution convolutional neural network (SRCNN) method, and the like.

The upconversion processing may be performed using different algorithms for each region determined in accordance with a gaze point. For example, upconversion processing for a region including the gaze point and the vicinity of the gaze point is performed using an algorithm with a low processing speed but high accuracy, and upconversion processing for a region other than the above region is performed using an algorithm with low accuracy but a high processing speed. In that case, the time required for upconversion processing can be shortened. In addition, power consumed by upconversion processing can be reduced.

Without limitation to upconversion processing, downconversion processing for decreasing the resolution of image data may be performed. In the case where the resolution of image data is higher than the resolution of the display portion 13, part of the image data is not displayed on the display portion 13, in some cases. In that case, downconversion processing enables the entire image data to be displayed on the display portion 13.

The timing controller 44 has a function of controlling driving frequency (e.g., frame frequency, frame rate, or refresh rate) for displaying an image, for example. In the case where a still image is displayed on the display device 10A, for example, the timing controller 44 can lower the driving frequency to reduce power consumption of the display device 10A.

The CPU 45 has a function of, for example, performing general-purpose processing such as execution of an operating system, control of data, and execution of various arithmetic operations and programs. The CPU 45 has a function of, for example, giving an instruction for an operation for writing or reading image data to/from the memory device 41, an operation for correcting image data, an operation for a later-described sensor, or the like. Furthermore, the CPU 45 may have a function of transmitting a control signal to at least one of the circuits included in the functional circuit 40, for example.

The sensor controller 46 has a function of, for example, controlling a sensor. FIG. 9 illustrates a wiring SNCL as a wiring electrically connected to the sensor.

The sensor is, for example, a touch sensor that can be on the display portion. Alternatively, the sensor may be an illuminance sensor, for example.

The power supply circuit 47 has a function of generating voltages to be supplied to the pixel circuits 51, the circuits included in the driver circuit 30 and the functional circuit 40, and the like. Note that the power supply circuit 47 may have a function of selecting a circuit to which a voltage is to be supplied. For example, the power supply circuit 47 stops supply of a voltage to the CPU 45, the GPU 42, and the like during a period in which a still image is displayed, whereby the power consumption of the whole of the display device 10A can be reduced.

As described above, the display device of one embodiment of the present invention can have a structure in which display elements, pixel circuits, a driver circuit, and a functional circuit are stacked. The driver circuit and a functional circuit, which are peripheral circuits, can be provided so as to overlap with the pixel circuits and thus the width of the bezel can be made extremely small, so that a reduction in size of the display device can be achieved. A structure of the display device of one embodiment of the present invention in which circuits are stacked enables its wirings connecting the circuits to be shortened, resulting in a reduction in weight of the display device. The display device of one embodiment of the present invention can include a display portion with a high pixel resolution; thus, the display device can have high display quality.

### <Structure Example of Display Module>

Next, a structure example of a display module including the display device 10A will be described.

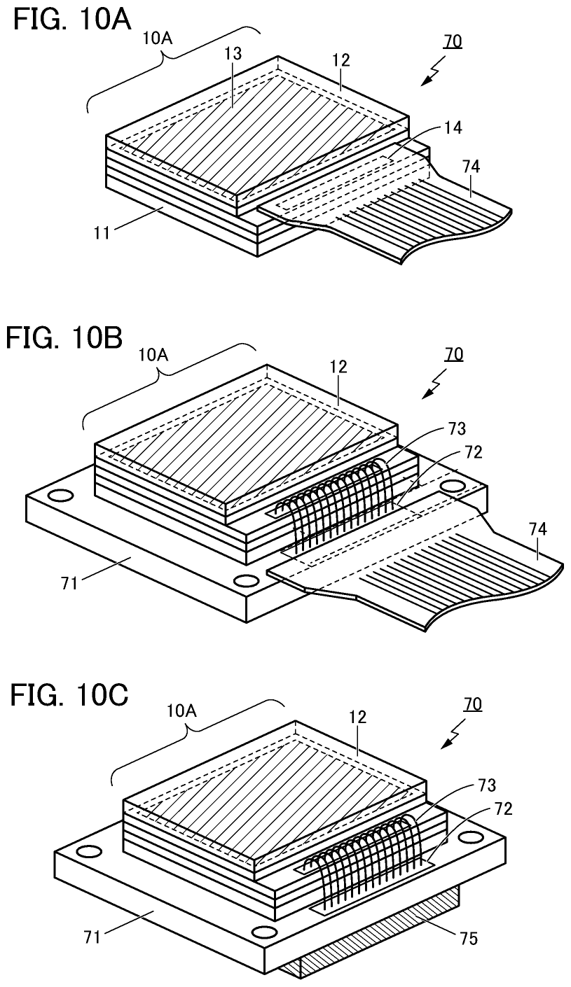

FIGS. 10A to 10C are each a perspective view of a display module 70. The display module 70 has a structure in which a flexible printed circuit (FPC) 74 is provided on the terminal portion 14 of the display device 10A. In the FPC 74, a film formed of an insulator is provided with a wiring. The FPC 74 is flexible. The FPC 74 functions as a wiring for supplying a video signal, a control signal, a power supply potential, and the like to the display device 10A from the outside. An IC may be mounted on the FPC 74.

The display module 70 illustrated in FIG. 10B includes the display device 10A over a printed wiring board 71. The printed wiring board 71 includes wirings in and/or on a substrate formed of an insulator.

In the display module 70 illustrated in FIG. 10B, the terminal portion 14 of the display device 10A is electrically connected to a terminal portion 72 of the printed wiring board 71 through a wire 73. The wire 73 can be formed in wire bonding. Ball bonding or wedge bonding can be used as the wire bonding.

After the wire 73 is formed, the wire 73 may be covered with a resin material or the like. Note that the display device 10A and the printed wiring board 71 may be electrically connected to each other by a method other than the wire bonding. For example, the display device 10A and the printed wiring board 71 may be electrically connected to each other using an anisotropic conductive adhesive or a bump.

In the display module 70 illustrated in FIG. 10B, the terminal portion 72 of the printed wiring board 71 is electrically connected to the FPC 74. In the case where the electrode pitch in the terminal portion 14 of the display device 10A is different from the electrode pitch in the FPC 74, for example, the terminal portion 14 may be electrically connected to the FPC 74 via the printed wiring board 71. Specifically, the distance between electrodes (pitch) in the terminal portion 14 can be converted into the distance between electrodes in the terminal portion 72 using wirings formed on the printed wiring board 71. Accordingly, even when the electrode pitch in the terminal portion 14 is different from the electrode pitch in the FPC 74, electrical connection between the electrodes can be obtained.

The printed wiring board 71 can be provided with a variety of elements such as a resistor, a capacitor, and a semiconductor element.

As in the display module 70 illustrated in FIG. 10C, the terminal portion 72 may be electrically connected to a connection portion 75 provided on a bottom surface (a surface where the display device 10A is not provided) of the printed wiring board 71. With the use of a socket-type connection portion as the connection portion 75, for example, the display module 70 can be easily attached to and detached from another device.

### <Configuration Example of Pixel Circuit>

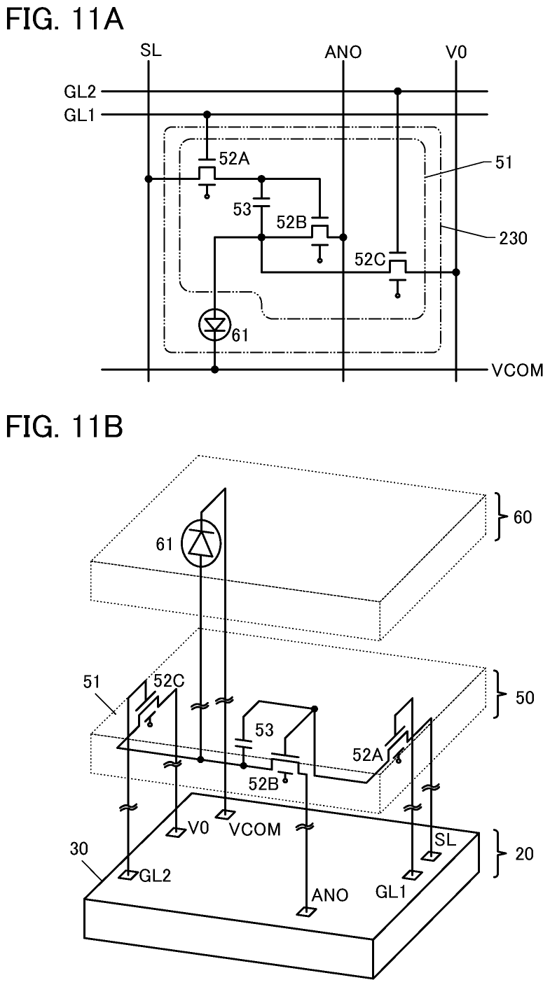

FIGS. 11A and 11B illustrate a configuration example of one of the pixel circuits 51 and one of the light-emitting elements 61 connected to the pixel circuit 51. FIG. 11A schematically illustrates the connection relation of the elements, and FIG. 11B schematically illustrates the vertical position relation of the layer 20 including the driver circuit, the layer 50 including a plurality of transistors of the pixel circuit, and the layer 60 including the light-emitting element.

The pixel circuit 51 illustrated as an example in FIGS. 11A and 11B includes a transistor 52A, a transistor 52B, a transistor 52C, and a capacitor 53. The transistor 52A, the transistor 52B, and the transistor 52C can be OS transistors. Each of the OS transistors of the transistor 52A, the transistor 52B, and the transistor 52C preferably includes a back gate electrode, in which case the back gate electrode and a gate electrode can be supplied with the same signals or different signals.

The transistor 52B includes the gate electrode electrically connected to the transistor 52A, a first electrode electrically connected to the light-emitting element 61, and a second electrode electrically connected to a wiring ANO. The wiring ANO supplies a potential for supplying a current to the light-emitting element 61.

The transistor 52A includes a first terminal electrically connected to the gate electrode of the transistor 52B, a second terminal electrically connected to the wiring SL functioning as a source line, and the gate electrode having a function of controlling the conduction state or the non-conduction state on the basis of the potential of a wiring GL1 functioning as a gate line.

The transistor 52C includes a first terminal electrically connected to a wiring V0, a second terminal electrically connected to the light-emitting element 61, and the gate electrode having a function of controlling the conduction state or the non-conduction state on the basis of the potential of a wiring GL2 functioning as a gate line. The wiring V0 supplies a reference potential and outputs a current flowing in the pixel circuit 51 to the driver circuit 30 or the functional circuit 40.

The capacitor 53 includes a conductive film electrically connected to the gate electrode of the transistor 52B and a conductive film electrically connected to the second electrode of the transistor 52C.

The light-emitting element 61 includes a first electrode electrically connected to the first electrode of the transistor 52B and a second electrode electrically connected to a wiring VCOM. The wiring VCOM supplies a potential for supplying a current to the light-emitting element 61.

Accordingly, the intensity of light emitted by the light-emitting element 61 can be controlled in accordance with an image signal supplied to the gate electrode of the transistor 52B. Furthermore, variations in the gate-source voltage of the transistor 52B can be reduced by the reference potential of the wiring V0 supplied through the transistor 52C.

A current value that can be used for setting pixel parameters can be output from the wiring V0. Specifically, the wiring V0 can function as a monitor line for outputting a current flowing through the transistor 52B or a current flowing through the light-emitting element 61 to the outside. A current output to the wiring V0 is converted into a voltage by a source follower circuit or the like and output to the outside. Alternatively, a current output to the wiring V0 can be converted into a digital signal by an A-D converter or the like and output to the functional circuit 40 or the like.

A light-emitting element described in one embodiment of the present invention refers to a self-luminous display element such as an organic EL element (also referred to as an organic light-emitting diode (OLED)). The light-emitting element electrically connected to the pixel circuit can be a self-luminous light-emitting element such as a light-emitting diode (LED), a micro LED, a quantum-dot light-emitting diode (QLED), or a semiconductor laser.

In the structure illustrated as an example in FIG. 11B, the wirings electrically connecting the pixel circuit 51 and the driver circuit 30 can be made short, so that the wiring resistance of the wirings can be reduced. Thus, data writing can be performed at high speed, leading to high-speed operation of the display device 10A. Therefore, even when the display device 10A includes a large number of pixel circuits 51, a sufficiently long frame period can be ensured and thus the pixel density of the display device 10A can be increased. In addition, the increased pixel density of the display device 10A can increase the resolution of an image displayed by the display device 10A. For example, the pixel density of the display device 10A can be 1000 ppi or higher, 5000 ppi or higher, or 7000 ppi or higher. Thus, the display device 10A can be, for example, a display device for VR or AR and can be suitably used in an electronic device with a short distance between the display portion and the user, such as an HMD.

Although FIGS. 11A and 11B illustrate, as an example, the pixel circuit 51 including three transistors in total, one embodiment of the present invention is not limited thereto. Configuration examples and a driving method example of a pixel circuit which can be used for the pixel circuit 51 will be described below.

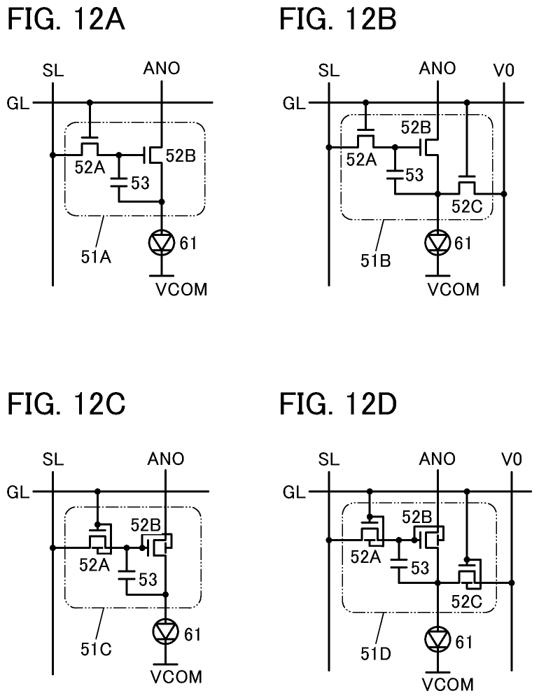

A pixel circuit 51A illustrated in FIG. 12A includes the transistor 52A, the transistor 52B, and the capacitor 53. FIG. 12A illustrates the light-emitting element 61 connected to the pixel circuit 51A. The wiring SL, the wiring GL, the wiring ANO, and the wiring VCOM are electrically connected to the pixel circuit 51A. The pixel circuit 51A has a configuration in which the transistor 52C is removed from the pixel circuit 51 illustrated in FIG. 11A and the wirings GL1 and GL2 in FIG. 11A are replaced with the wiring GL.

A gate of the transistor 52A is electrically connected to the wiring GL, one of a source and a drain of the transistor 52A is electrically connected to the wiring SL, and the other of the source and the drain of the transistor 52A is electrically connected to the gate of the transistor 52B and one electrode of the capacitor 53. One of a source and a drain of the transistor 52B is electrically connected to the wiring ANO and the other of the source and the drain of the transistor 52B is electrically connected to an anode of the light-emitting element 61. The other electrode of the capacitor 53 is electrically connected to the anode of the light-emitting element 61. A cathode of the light-emitting element 61 is electrically connected to the wiring VCOM.

A pixel circuit 51B illustrated in FIG. 12B has a structure in which the transistor 52C is added to the pixel circuit 51A. In addition, the wiring V0 is electrically connected to the pixel circuit 51B.

A pixel circuit 51C illustrated in FIG. 12C is an example in which a transistor including a pair of gates electrically connected to each other is used as each of the transistor 52A and the transistor 52B of the pixel circuit 51A. A pixel circuit 51D illustrated in FIG. 12D is an example of the case where such transistors are used in the pixel circuit 51B. With these structures, a current that can flow in the transistors can be increased. Although a transistor including a pair of gates electrically connected to each other is used as every transistor here, one embodiment of the present invention is not limited thereto. A transistor that includes a pair of gates electrically connected to different wirings may be used. When, for example, a transistor in which one of the gates is electrically connected to the source is used, the reliability can be increased.

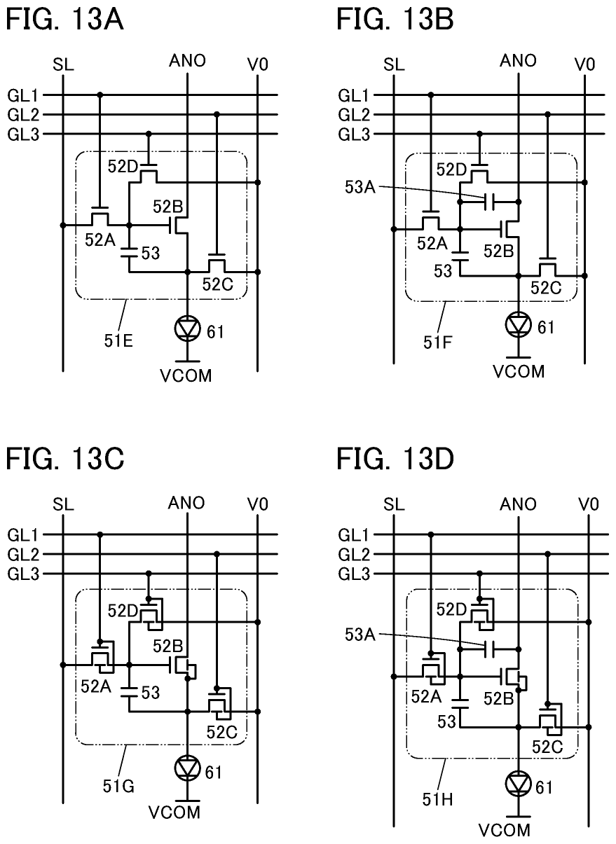

A pixel circuit 51E illustrated in FIG. 13A has a configuration in which a transistor 52D is added to the pixel circuit 51B. The wiring GL1, the wiring GL2, and a wiring GL3 serving as gate lines are electrically connected to the pixel circuit 51E. In this embodiment and the like, the wirings GL1, GL2, and GL3 are collectively referred to as the wiring GL in some cases. Thus, the wiring GL may be one wiring or a plurality of wirings.

A gate of the transistor 52D is electrically connected to the wiring GL3, one of a source and a drain of the transistor 52D is electrically connected to the gate of the transistor 52B, and the other of the source and the drain of the transistor 52D is electrically connected to the wiring V0. The gate of the transistor 52A is electrically connected to the wiring GL1, and the gate of the transistor 52C is electrically connected to the wiring GL2.

When the transistors 52C and 52D are turned on at the same time, the source and the gate of the transistor 52B have the same potential, so that the transistor 52B can be turned off Thus, a current flowing to the light-emitting element 61 can be blocked forcibly. Such a pixel circuit is suitable for the case of using a display method in which a display period and an off period are alternately provided.

A pixel circuit 51F illustrated in FIG. 13B is an example of the case where a capacitor 53A is added to the pixel circuit 51E. The capacitor 53A functions as a storage capacitor.

A pixel circuit 51G illustrated in FIG. 13C and a pixel circuit 51H illustrated in FIG. 13D are each an example of the case where a transistor including a pair of gates is used in the pixel circuit 51E or the pixel circuit 51F. A transistor in which a pair of gates are electrically connected to each other is used as each of the transistors 52A, 52C, and 52D, and a transistor in which one of gates is electrically connected to a source is used as the transistor 52B.

Next, an example of a method for driving a display device in which the pixel circuit 51E is used will be described. Note that a similar driving method can be applied to a display device in which the pixel circuit 51F, 51G, or 51H is used.

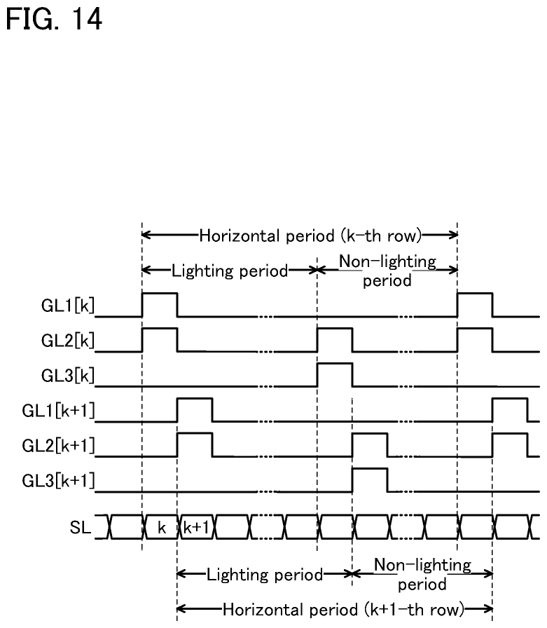

FIG. 14 shows a timing chart of a method for driving the display device in which the pixel circuit 51E is used. Changes in the potentials of wirings GL1[k], GL2[k], and GL3[k] that are gate lines of the k-th row and changes in the potentials of wirings GL1[k+1], GL2[k+1], and GL3[k+1] that are gate lines of the k+1-th row are shown here. FIG. 14 also shows the timing of supplying a signal to the wiring SL functioning as a source line.

In the example of the driving method described here, one horizontal period is divided into a lighting period and a non-lighting period. A horizontal period of the k-th row is shifted from a horizontal period of the k+1-th row by a selection period of the gate line.

In the lighting period of the k-th row, first, the wirings GL1[k] and GL2[k] are supplied with a high-level potential and the wiring SL is supplied with a source signal. Thus, the transistors 52A and 52C are turned on, so that a potential corresponding to the source signal is written from the wiring SL to the gate of the transistor 52B. After that, the wirings GL1[k] and GL2[k] are supplied with a low-level potential, so that the transistors 52A and 52C are turned off and the gate potential of the transistor 52B is retained.

Subsequently, in a lighting period of the k+1-th row, data is written by operation similar to that described above.

Next, the non-lighting period is described. In the non-lighting period of the k-th row, the wirings GL2[k] and GL3[k] are supplied with a high-level potential. Accordingly, the transistors 52C and 52D are turned on, and the source and the gate of the transistor 52B are supplied with the same potential, so that almost no current flows through the transistor 52B. Therefore, the light-emitting element 61 is turned off. As a result, all the subpixels that are positioned in the k-th row are turned off. The subpixels of the k-th row remain in the off state until the next lighting period.

Subsequently, in a non-lighting period of the k+1-th row, all the subpixels of the k+1-th row are turned off in a manner similar to that described above.

Such a driving method described above, in which the subpixels are not constantly on through one horizontal period and a non-lighting period is provided in one horizontal period, can be called duty driving. With duty driving, an afterimage phenomenon can be inhibited at the time of displaying moving images; therefore, a display device with high performance in displaying moving images can be achieved. Particularly in a VR device and the like, a reduction in an afterimage can reduce what is called VR sickness.

In the duty driving, the proportion of the lighting period in one horizontal period can be called a duty cycle. For example, a duty cycle of 50% means that the lighting period and the non-lighting period have the same lengths. Note that the duty cycle can be set freely and can be adjusted appropriately within a range higher than 0% and lower than or equal to 100%, for example.

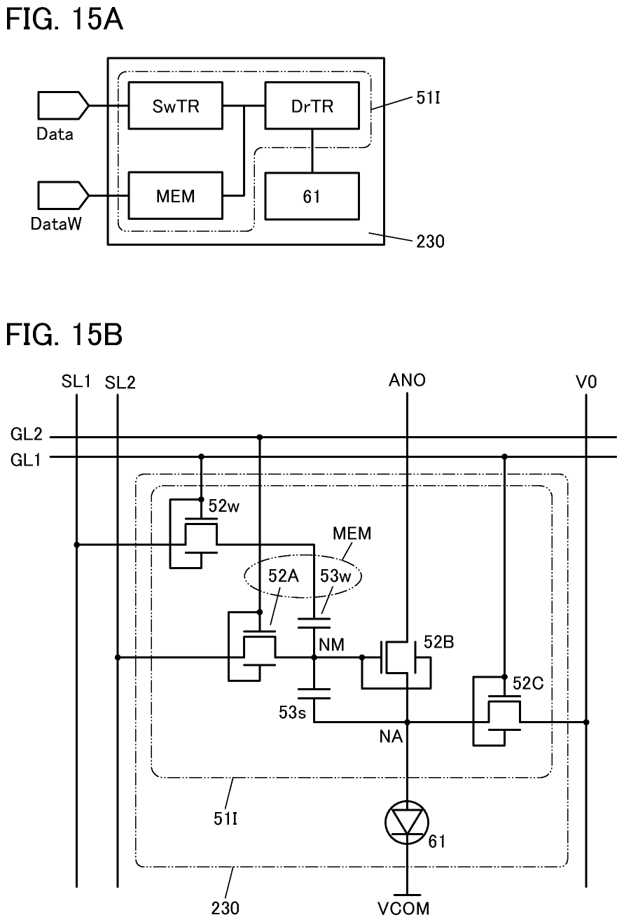

A configuration different from the configurations of the above-described pixel circuits will be described with reference to FIGS. 15A and 15B.

FIG. 15A is a block diagram of the pixel 230. The pixel illustrated in FIG. 15A includes a switching transistor SwTR, a driving transistor DrTR, the light-emitting element 61, and a memory circuit MEM.

Note that data DataW is supplied to the memory circuit MEM through a wiring SL2 and the transistor 52A. When the data DataW is supplied to the pixel in addition to image data Data, a large current flows through the light-emitting element, so that the display device can have high luminance.

FIG. 15B is a specific circuit diagram of a pixel circuit 51I.

The pixel circuit 51I illustrated in FIG. 15B includes a transistor 52w, the transistor 52A, the transistor 52B, the transistor 52C, a capacitor 53s, and a capacitor 53w. FIG. 15B illustrates the light-emitting element 61 connected to the pixel circuit 51I.

The transistor 52w functions as a switching transistor. The transistor 52B functions as a driving transistor. One of a source and a drain of the transistor 52w is electrically connected to one electrode of the capacitor 53w. The other electrode of the capacitor 53w is electrically connected to the one of the source and the drain of the transistor 52A. The one of the source and the drain of the transistor 52A is electrically connected to the gate of the transistor 52B. The gate of the transistor 52B is electrically connected to one electrode of the capacitor 53s. The other electrode of the capacitor 53s is electrically connected to the one of the source and the drain of the transistor 52B. The one of the source and the drain of the transistor 52B is electrically connected to one of a source and a drain of the transistor 52C. The one of the source and the drain of the transistor 52C is electrically connected to one electrode of the light-emitting element 61. Each of the transistors illustrated in FIG. 15B includes a back gate electrically connected to its gate; however, the connection of the back gate is not limited thereto. Each of the transistors does not necessarily include the back gate.

Here, a node to which the other electrode of the capacitor 53w, the one of the source and the drain of the transistor 52A, the gate of the transistor 52B, and the one electrode of the capacitor 53s are connected is referred to as a node NM. A node to which the other electrode of the capacitor 53s, the one of the source and the drain of the transistor 52B, the one of the source and the drain of the transistor 52C, and the one electrode of the light-emitting element 61 are connected is referred to as a node NA.

A gate of the transistor 52w is electrically connected to the wiring GL1. The gate of the transistor 52C is electrically connected to the wiring GL1. The gate of the transistor 52A is electrically connected to the wiring GL2. The other of the source and the drain of the transistor 52w is electrically connected to a wiring SL1. The other of the source and the drain of the transistor 52C is electrically connected to the wiring V0. The other of the source and the drain of the transistor 52A is electrically connected to the wiring SL2. Note that in this embodiment and the like, the wirings SL1 and SL2 are collectively referred to as the wiring SL in some cases. Thus, the wiring SL may be one wiring or a plurality of wirings.

The other of the source and the drain of the transistor 52B is electrically connected to the wiring ANO. The other electrode of the light-emitting element 61 is electrically connected to the wiring VCOM.

The wiring GL1 and the wiring GL2 can function as signal lines for controlling the operation of the respective transistors. The wiring SL1 can function as a signal line for supplying the image data Data to the pixel. The wiring SL2 can function as a signal line for writing the data DataW to the memory circuit MEM. For example, the wiring SL2 can function as a signal line for supplying a correction signal to the pixel. The wiring V0 functions as a monitor line for obtaining the electrical characteristics of the transistor 52B. Supply of a specific potential from the wiring V0 to the other electrode of the capacitor 53s through the transistor 52C enables stable writing of an image signal.

The transistor 52A and the capacitor 53w constitute the memory circuit MEM. The node NM is a storage node. When the transistor 52A is turned on, the data DataW supplied from the wiring SL2 can be written to the node NM. The use of an OS transistor with an extremely low off-state current as the transistor 52A allows the potential of the node NM to be retained for a long time.

In the pixel circuit 51I, the image data Data is supplied to the capacitor 53w from the wiring SL1 through the transistor 52w. One of the source and the drain of the transistor 52w and the node NM are capacitively coupled. Thus, the potential of the node NM to which the data DataW is written changes depending on the image data Data. Furthermore, the node NA and the node NM are capacitively coupled through the capacitor 53s. Thus, the potential of the node NA changes depending on the data DataW and the image data Data.

Note that the transistor 52w functions as a selection transistor for determining whether or not the image data Data is to be supplied. The transistor 52C functions as a reset transistor for determining whether or not to set the potential of the node NA to that of the wiring V0.

The display device of one embodiment of the present invention can detect a defective pixel using the functional circuit 40 provided to overlap with the pixel circuit group 55. Data on the defective pixel can be used to correct a display defect due to the defective pixel, leading to normal display.

Some or all of steps of a correction method described below as an example may be performed by a circuit provided outside the display device. Alternatively, some of the steps of the correction method may be performed by the functional circuit 40 and the other steps may be performed by a circuit provided outside the display device.

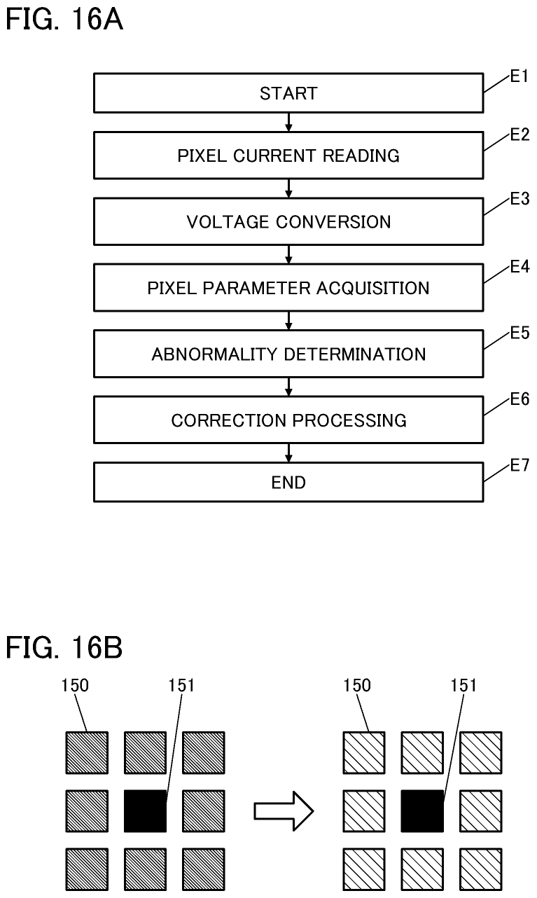

A specific example of the correction method will be described below. FIG. 16A is a flow chart of the correction method described below.

First, correction operation starts in Step E1.

Next, currents of the pixels are read in Step E2. For example, each of the pixels can be driven so as to output a current to a monitor line electrically connected to the pixel.

In the case where the pixel circuit group 55 is divided into a plurality of sections 59 as in a later-described display device 10B or the like, currents of the pixels can be read simultaneously in each of the sections 59. When the pixel circuit group 55 is divided into the plurality of sections 59, the time required to read currents of all pixels can be extremely short.

Then, the read currents are converted into voltages in Step E3. In the case of using a digital signal in a subsequent process, conversion to digital data can be performed in Step E3. For example, analog data can be converted into digital data using an analog-digital converter circuit (ADC).

Next, pixel parameters of the pixels are obtained on the basis of the acquired data in Step E4. The pixel parameter includes the threshold voltage or field-effect mobility of the driving transistor, the threshold voltage of the light-emitting element, or a current value at a certain voltage, for example.

Subsequently, each of the pixels is determined to be abnormal or not on the basis of the pixel parameter in Step E5. For example, a pixel is determined to be abnormal when its pixel parameter has a value exceeding (or lower than) a predetermined threshold value.

An abnormal pixel is recognized as a dark spot defect when luminance is significantly lower than that corresponding to an input data potential, or recognized as a bright spot defect when luminance is significantly higher than that corresponding to an input data potential, for example.

The address of the abnormal pixel and the kind of the defect can be specified and acquired in Step E5.

Then, correction processing is performed in Step E6.

An example of the correction processing is described with reference to FIG. 16B. FIG. 16B schematically illustrates pixels arranged in a matrix of 3×3 each of which includes the pixel circuit 51 and the light-emitting element 61. Here, a pixel 151 at the center is regarded as a dark spot defect. FIG. 16B schematically illustrates a state where the pixel 151 is in a non-lighting state and pixels 150 around the pixel 151 are in lighting states with predetermined luminance.

A dark spot defect is due to a pixel unlikely to have normal luminance even when correction for increasing a data potential input to the pixel is performed. Hence, correction for increasing luminance is performed on the pixels 150 around the pixel 151 recognized as a dark spot defect, as illustrated in FIG. 16B. As a result, a normal image can be displayed even when a dark spot defect exists.

In the case of a bright spot defect, the luminance of pixels around the defect is decreased, so that the bright spot defect can be less noticeable.

Such a correction method for compensating for an abnormal pixel by pixels around the abnormal pixel is effective particularly in the case of a display device with a higher resolution (e.g., 1000 ppi or higher) because adjacent pixels thereof are difficult to see as separate pixels.

It is preferred that correction be performed such that a data potential is not input to an abnormal pixel recognized as a dark spot defect, a bright spot defect, or the like.

As described above, a correction parameter can be set for each pixel. When the correction parameter is used for image data to be input, correction image data which enables the display device 10A to display an optimal image can be generated.

As well as in an abnormal pixel and pixels around the abnormal pixel, pixel parameters vary in pixels not determined to be abnormal; thus, display unevenness due to the variation might be recognized when an image is displayed, in some cases. Hence, correction parameters for the pixels not determined to be abnormal can be set so as to cancel the variation of the pixel parameters. For example, a reference value based on the mean value, average value, or the like of pixel parameters of some or all of the pixels can be set, and a correction value used for canceling a difference of a pixel parameter of a certain pixel from the reference value can be set as a correction parameter of the pixel.

For each of pixels around an abnormal pixel, it is preferred to set correction data that takes into consideration both a correction amount for compensating for the abnormal pixel and a correction amount for canceling pixel parameter variation.

Next, the correction operation terminates in Step E7.

After that, an image can be displayed on the basis of part of the correction parameters obtained in the correction operation and image data to be input.

Note that a neural network may be used for the correction operation. The neural network can determine correction parameters on the basis of inference results obtained by machine learning, for example. In the case where correction parameters are determined by a neural network, for example, high-accuracy correction can be performed to make an abnormal pixel less noticeable without using a detailed algorithm for correction.

The above is the description of the correction method.

### Modification Example 1

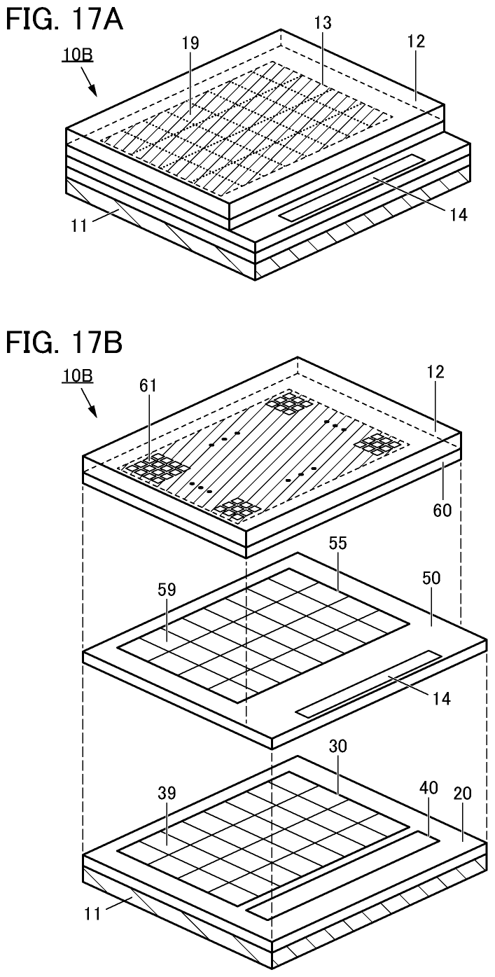

FIGS. 17A and 17B are perspective views of the display device 10B, which is a modification example of the display device 10A. FIG. 17B is a perspective view illustrating structures of layers included in the display device 10B. Note that description is made mainly on portions different from those of the display device 10A to reduce repeated description.

In the display device 10B, the driver circuit 30 and the pixel circuit group 55 including the plurality of pixel circuits 51 overlap with each other. In the display device 10B, the pixel circuit group 55 is divided into the plurality of sections 59 and the driver circuit 30 is divided into a plurality of sections 39. The plurality of sections 39 each include the source driver circuit 31 and the gate driver circuit 33.

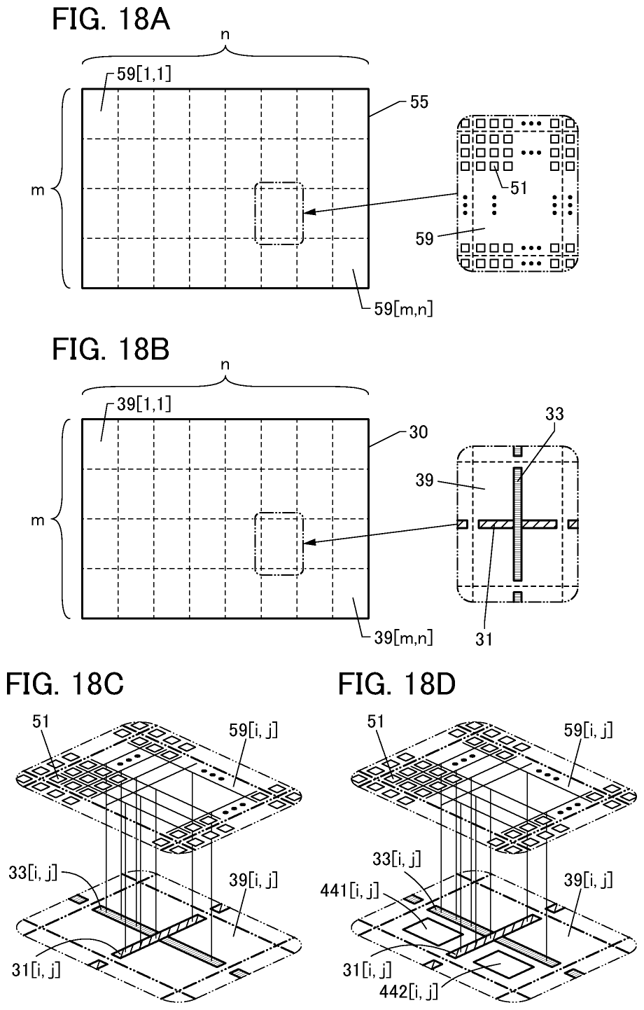

FIG. 18A illustrates a structure example of the pixel circuit group 55 included in the display device 10B. FIG. 18B illustrates a structure example of the driver circuit 30 included in the display device 10B. The sections 59 and the sections 39 are each arranged in a matrix of m rows and n columns (m and n are each an integer of 1 or more). In this specification and the like, the section 59 in the first row and the first column is denoted by a section 59[1,1], and the section 59 in the m-th row and the n-th column is denoted by a section 59[m,n]. Similarly, the section 39 in the first row and the first column is denoted by a section 39[1,1], and the section 39 in the m-th row and the n-th column is denoted by a section 39[m,n]. FIGS. 18A and 18B illustrate a case where m is 4 and n is 8. That is, the pixel circuit group 55 and the driver circuit 30 are each divided into 32 sections.

The plurality of sections 59 each include a plurality of the pixel circuits 51, a plurality of the wirings SL, and a plurality of the wirings GL. In each of the sections 59, one of the pixel circuits 51 is electrically connected to at least one of the wirings SL and at least one of the wirings GL.

One of the sections 59 and one of the sections 39 are provided to overlap with each other (see FIG. 18C). For example, a section 59[i,j] (i is an integer greater than or equal to 1 and less than or equal to m, and j is an integer greater than or equal to 1 and less than or equal to n) and a section 39[i,j] are provided to overlap with each other. A source driver circuit 31[i,j] included in the section 39[i,j] is electrically connected to the wiring SL included in the section 59[i,j]. A gate driver circuit 33[i,j] included in the section 39[i,j] is electrically connected to the wiring GL included in the section 59i,j. The source driver circuit 31[i,j] and the gate driver circuit 33[i,j] have a function of controlling the pixel circuits 51 included in the section 59[i,j].

When the section 59[i,j] and the section 39[i,j] are provided to overlap with each other, a connection distance (wiring length) between the pixel circuit 51 included in the section 59[i,j] and each of the source driver circuit 31 and the gate driver circuit 33 included in the section 39[i,j] can be made extremely short. As a result, the wiring resistance and the parasitic capacitance are reduced, and thus time taken for charging and discharging can be reduced and high-speed driving can be achieved. Moreover, power consumption can be reduced. Furthermore, the size and weight of the display device can be reduced.

In addition, the display device 10B includes the source driver circuit 31 and the gate driver circuit 33 in each of the sections 39. Thus, the display portion 13 can be divided to correspond to the sections 59 and the respective sections 39, and image rewriting can be performed in each section. For example, the display portion 13 can perform image rewriting only in a section with an image change and can retain image data in a section with no change, thereby reducing the power consumption.

In this embodiment or the like, each of portions obtained by dividing the display portion 13 to correspond to the sections 59 is referred to as a sub-display portion 19. Thus, it can also be said that the sub-display portions 19 are divided to correspond to the sections 39. In the display device 10B described with reference to FIGS. 17A and 17B and FIGS. 18A to 18D, the display portion 13 is divided into 32 of the sub-display portions 19 (see FIG. 17A). Each of the sub-display portions 19 includes a plurality of the pixels 230 illustrated in FIGS. 11A and 11B and the like. Specifically, one of the sub-display portions 19 includes one of the sections 59 including the plurality of pixel circuits 51, and the plurality of light-emitting elements 61. Each of the sections 39 has a function of controlling the plurality of pixels 230 included in one of the sub-display portions 19.

In the display device 10B, driving frequency at the time of displaying an image can be set freely for each of the sub-display portions 19 by the timing controller 44 included in the functional circuit 40. The functional circuit 40 has a function of controlling operations in the plurality of sections 39 and the plurality of sections 59. In other words, the functional circuit 40 has a function of controlling driving frequency and operation timing of each of the plurality of sub-display portions 19 arranged in a matrix. In addition, the functional circuit 40 has a function of adjusting synchronization between the sub-display portions.

A timing controller 441 and an input/output circuit 442 may be provided for each of the sections 39 (see FIG. 18D). For the input/output circuit 442, an inter-integrated circuit (I²C) interface can be used, for example. The timing controller 441 included in the section 39[i,j] is denoted as a timing controller 441[i,j] in FIG. 18D. Furthermore, the input/output circuit 442 included the section 39[i,j] is denoted as an input/output circuit 442[i,j].

The functional circuit 40 supplies signals for setting the driving frequency and scan direction of the gate driver circuit 33[i,j] and operation parameters, such as the number of pixels in image data reduced for decreasing resolution (the number of pixels where image data rewriting is not performed), to the input/output circuit 442[i,j], for example. The source driver circuit 31[i,j] and the gate driver circuit 33[i,j] operate in accordance with the operation parameters.

In the case where the sub-display portions 19 each include a light-receiving element described later, the input/output circuit 442 outputs data obtained by photoelectric conversion by the light-receiving element to the functional circuit 40.

The display device 10B in the electronic device of one embodiment of the present invention, in which the pixel circuit 51 and the driver circuit 30 are stacked and the driving frequency is set freely in each of the sub-display portions 19 in accordance with the eye movement of the user, can achieve low power consumption.

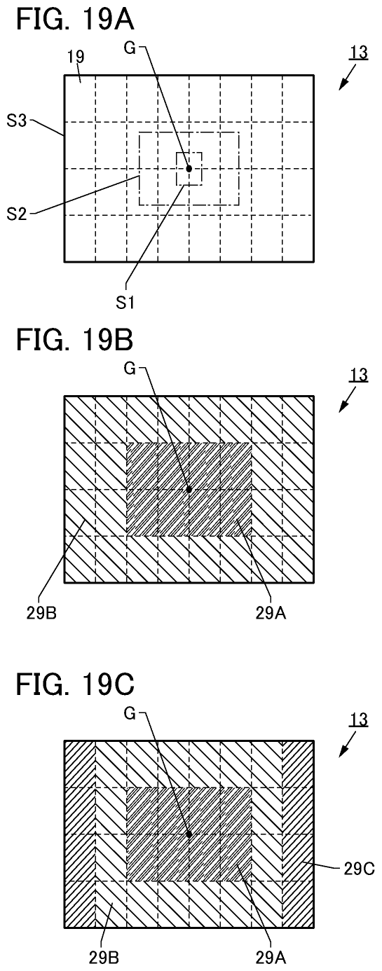

FIG. 19A illustrates the display portion 13 including the sub-display portions 19 in four rows and eight columns. FIG. 19A also illustrates a first region Si to a third region S3 with a gaze point G as a center. The CPU 45 divides the plurality of sub-display portions 19 between a first section 29A overlapping with the first region S1 and the second region S2 and a second section 29B overlapping with the third region S3. In other words, the CPU 45 divides the plurality of sections 39 between the first section 29A and the second section 29B. In this case, the first section 29A overlapping with the first region Si and the second region S2 includes a region overlapping with the gaze point G, and the second section 29B includes the sub-display portions 19 positioned outside the first section 29A (see FIG. 19B).

The operations of the driver circuits (the source driver circuit 31 and the gate driver circuit 33) included in each of the plurality of sections 39 are controlled by the functional circuit 40. The second section 29B is, for example, is a section overlapping with the third region S3 including a stable gaze visual field, an induced visual field, and an auxiliary visual field, which is hard for the user to discriminate. Thus, the user perceives a small reduction in practical display quality even when the number of times of image data rewriting operations per unit time (hereinafter, also referred to as “image rewriting frequency”) at the time of displaying an image is smaller in the second section 29B than in the first section 29A. In other words, a reduction in practical display quality is small even when driving frequency of the sub-display portion 19 included in the second section 29B (also referred to as “second driving frequency”) is lower than driving frequency of the sub-display portions 19 included in the first section 29A (also referred to as “first driving frequency”).

A decrease in the driving frequency can result in a reduction in power consumption of the display device. On the other hand, a decrease in the driving frequency reduces the display quality, particularly in displaying a moving image. According to one embodiment of the present invention, the second driving frequency is made lower than the first driving frequency; thus, power consumption can be reduced in a section where the visibility by the user is low without reducing the practical display quality. One embodiment of the present invention can achieve both display quality maintenance and a reduction in power consumption.

The first driving frequency can be higher than or equal to 30 Hz and lower than or equal to 500 Hz, preferably higher than or equal to 60 Hz and lower than or equal to 500 Hz. The second driving frequency is preferably lower than or equal to the first driving frequency, further preferably lower than or equal to a half of the first driving frequency, still further preferably lower than or equal to one fifth of the first driving frequency.

Some of the sub-display portions 19 overlapping with the third region S3 may be set as a third section 29C positioned outside the second section 29B (see FIG. 19C), and driving frequency of the sub-display portions 19 included in the third section 29C (also referred to as “third driving frequency”) may be made lower than the driving frequency in the second section 29B. The third driving frequency is preferably lower than or equal to the second driving frequency, further preferably lower than or equal to a half of the second driving frequency, still further preferably lower than or equal to one fifth of the second driving frequency. A significantly low image rewriting frequency can further reduce power consumption. Note that rewriting of image data may be stopped if necessary, in which case power consumption can be further reduced.

When such a driving method is employed, a transistor with an extremely low off-state current is suitably used as a transistor included in the pixel circuit 51. For example, an OS transistor is suitably used as the transistor included in the pixel circuit 51. An OS transistor has an extremely low off-state current and thus can achieve long-term retention of image data supplied to the pixel circuit 51. It is particularly suitable to use an OS transistor as the transistor 52A.

In some cases, an image whose brightness, contrast, color tone, or the like is greatly different from that of the previous image is displayed as in the case where an image scene displayed on the display portion 13 is changed, for example. Such a case causes a mismatch of the timing at which an image is changed between the first section 29A and a section whose driving frequency is lower than that of the first section 29A. This might cause a great difference in the brightness, contrast, color tone, or the like between the sections, leading to the loss of the practical display quality. To prevent this, in the case where an image scene is changed, for example, image rewriting is performed in the section other than the first section 29A at a driving frequency which is the same as that of the first section 29A, and then the driving frequency of the section other than the first section 29A is decreased.

Furthermore, in the case where the amount of positional change of the gaze point G is determined to be larger than a certain amount, image rewriting may be performed in the section other than the first section 29A at a driving frequency which is the same as that of the first section 29A, and the driving frequency of the section other than the first section 29A may be decreased when the amount of positional change is determined to be within the certain amount. In the case where the amount of positional change of the gaze point G is determined to be small, the driving frequency of the section other than the first section 29A may be further decreased.

In the case where the display device 10B does not include a frame memory, which is a memory device for temporarily retaining image data, or includes only one frame memory for the entire display portion 13, each of the second driving frequency and the third driving frequency needs to be an integral submultiple of the first driving frequency.

When frame memories are provided for the respective sub-display portions 19, each of the second driving frequency and the third driving frequency can be set to any value without limitation to an integral submultiple of the first driving frequency. When the second driving frequency and the third driving frequency are set to any values, the degree of freedom in setting the driving frequencies can be increased. As a result, a reduction in the practical display quality can be small.

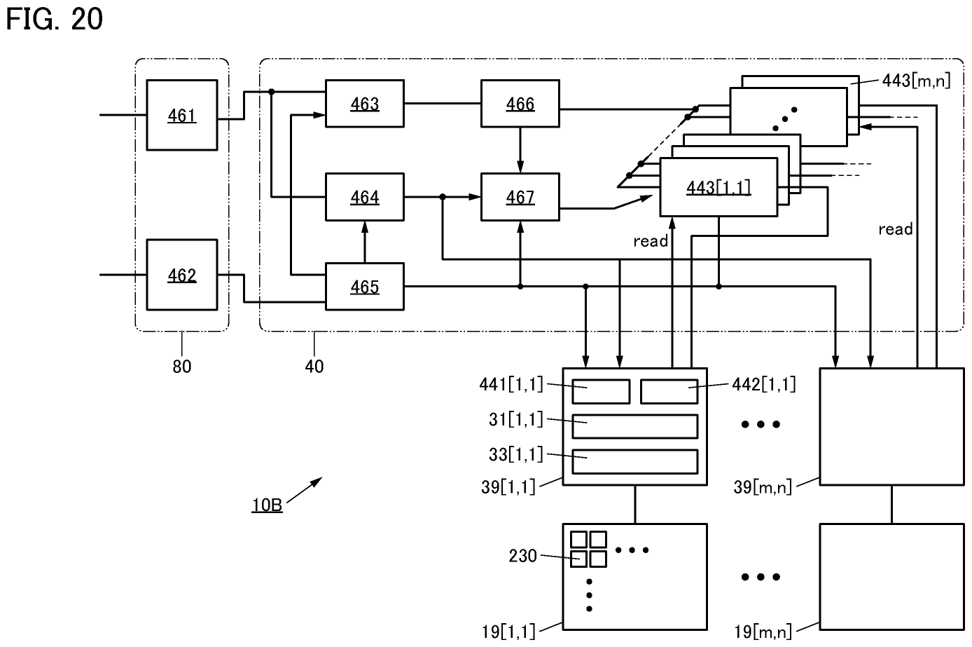

FIG. 20 is a block diagram illustrating a configuration example of the display device 10B including a frame memory 443 for each of the sub-display portions 19. In FIG. 20, the input/output circuit 80 includes an image data input unit 461 and a clock signal input unit 462. The functional circuit 40 includes an image data temporary retention unit 463, an operation parameter setting unit 464, an internal clock signal generating unit 465, an image processing unit 466, a memory controller 467, and a plurality of the frame memories 443.

Each of the plurality of frame memories 443 has a function of retaining image data to be displayed on the corresponding one of the plurality of sub-display portions 19. For example, a frame memory 443[1,1] has a function of retaining image data to be displayed on a sub-display portion 19[1,1]. Similarly, a frame memory 443[m,n] has a function of retaining image data to be displayed on a sub-display portion 19[m,n].

Each of the plurality of sub-display portions 19 is electrically connected to the corresponding one of the plurality of sections 39. In FIG. 20, each of the plurality of sections 39 includes the source driver circuit 31, the gate driver circuit 33, the timing controller 441, and the input/output circuit 442.

Image data to be displayed on the display portion 13 and operation parameters of the display device 10B are supplied to the image data input unit 461 from the outside. A clock signal is supplied to the clock signal input unit 462 from the outside. The clock signal is supplied to the internal clock signal generating unit 465 via the clock signal input unit 462.

The internal clock signal generating unit 465 has a function of generating a clock signal used in the display device 10B (also referred to as “internal clock signal”) with the use of the clock signal supplied from the outside. The internal clock signal is supplied to the image data temporary retention unit 463, the operation parameter setting unit 464, the memory controller 467, the section 39, and the like for matching operation timing between the circuits included in the display device 10B, for example.

The image data input via the image data input unit 461 is supplied to the image data temporary retention unit 463. The operation parameters input via the image data input unit 461 is supplied to the operation parameter setting unit 464.

The image data temporary retention unit 463 retains the supplied image data and supplies the image data to the image processing unit 466 in synchronization with the internal clock signal. Owing to the image data temporary retention unit 463, a mismatch between the timing at which image data is supplied from the outside and the timing at which the image data is processed in the display device 10B can be eliminated.

The operation parameter setting unit 464 has a function of retaining the supplied operation parameters. The operation parameters include data for determining the driving frequency, scan direction, resolution, or the like for each of the plurality of sub-display portions 19.

The image processing unit 466 has a function of performing arithmetic processing of the image data retained in the image data temporary retention unit 463. For example, the image processing unit 466 has a function of performing contrast adjustment, brightness adjustment, and gamma correction of the image data. Furthermore, the image processing unit 466 has a function of dividing the image data retained in the image data temporary retention unit 463 for the sub-display portions 19.

The memory controller 467 has a function of controlling the operations of the plurality of frame memories 443. The image data is retained in the plurality of frame memories 443 after being divided by the image processing unit 466 for the sub-display portions 19. Each of the plurality of frame memories 443 has a function of supplying image data to the corresponding section 39 in response to a read request signal (read) from the section 39.

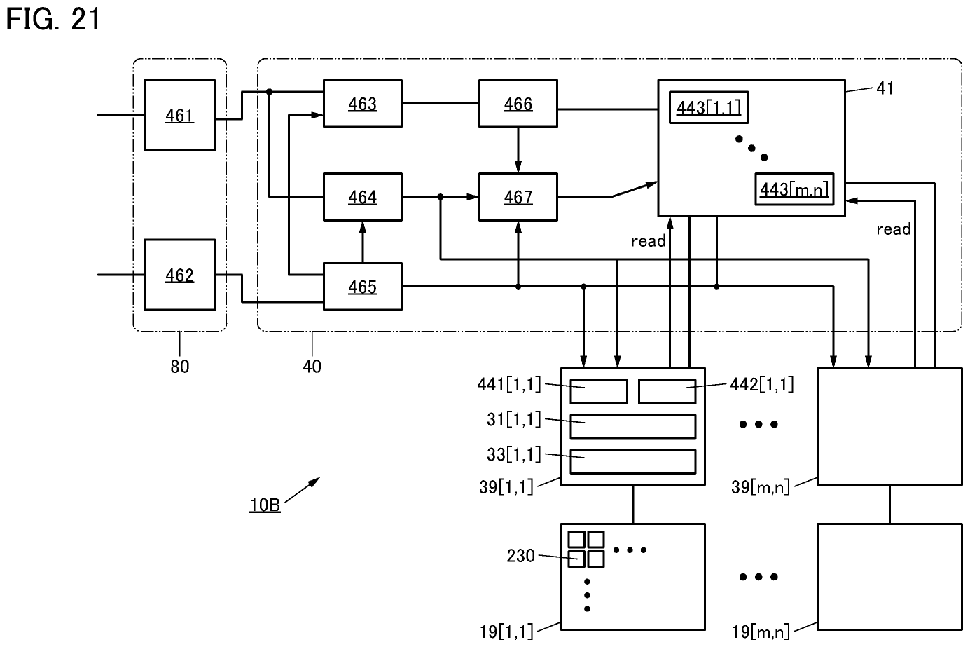

Note that the memory device 41 may be used as the frame memories 443 as illustrated in FIG. 21. In other words, image data divided for the sub-display portions 19 may be retained in the memory device 41.

The frame memories 443 may be provided in a component other than the functional circuit 40. Alternatively, the frame memory 443 may be provided in a semiconductor device other than the display device 10B.

Note that sections set for the display portion 13 are not limited to the first section 29A, the second section 29B, and the third section 29C. The display portion 13 may include four or more sections. When a plurality of sections are set for the display portion 13 and the driving frequencies of the sections gradually decreases from the gaze point G toward the edge of the display portion 13, a reduction in the practical display quality can be smaller.

An image to be displayed on the first section 29A may be subjected to the above-described upconversion processing. When an image obtained by the upconversion processing is displayed on the first section 29A, the display quality can be increased.

The upconversion processing may be performed on an image to be displayed on the section other than the first section 29A. When an image obtained by the upconversion processing is displayed on the section other than the first section 29A, a reduction in the practical display quality that occurs in the case where the driving frequency of the section other than the first section 29A is decreased can be smaller.

Note that the upconversion processing of an image to be displayed on the first section 29A may be performed using an algorithm with high accuracy, and the upconversion processing of an image to be displayed on the section other than the first section 29A may be performed using an algorithm with low accuracy. A reduction in the practical display quality that occurs in the case where the driving frequency of the section other than the first section 29A is decreased can be smaller also in such a case.

When image data rewriting is performed concurrently in all of the sub-display portions 19, high-speed rewriting is achieved. In other words, when image data rewriting is performed concurrently in all of the sections 39, high-speed rewriting is achieved.

In general, while pixels in one row are selected by a gate driver circuit, a source driver circuit writes image data to all of the pixels in one row concurrently in line sequential driving. In the case where the display portion 13 is not divided into the sub-display portions 19 and the resolution is 4000×2000 pixels, for example, image data needs to be written to 4000 pixels by the source driver circuit while the pixels in one row are selected by the gate driver circuit. In the case where the frame frequency is 120 Hz, one frame period is approximately 8.3 msec. Accordingly, the gate driver circuit needs to select pixels in 2000 rows in approximately 8.3 msec, and a period during which one gate line is selected, or an image data writing period per pixel, is approximately 4.17 μsec. That is, it becomes more difficult to ensure sufficient time for rewriting image data as the resolution or frame frequency of the display portion increases.

The display portion 13 of the display device 10B described as an example in this embodiment is divided into four parts in the row direction. Thus, the image data writing period per pixel in one sub-display portion 19 can be four times as long as that of the case where the display portion 13 is not divided. One embodiment of the present invention can easily ensure the time required for rewriting image data even at a frame frequency of 240 Hz or 360 Hz; thus, a display device with high display quality can be obtained.

Since the display portion 13 of the display device 10B described as an example in this embodiment is divided into four parts in the row direction, the length of the wiring SL electrically connecting the source driver circuit and the pixel circuit becomes ¼. Accordingly, each of the resistance and parasitic capacitance of the wiring SL becomes ¼, whereby the time required for writing (rewriting) image data can be shortened.

In addition, the display portion 13 of the display device 10B described as an example in this embodiment is divided into eight parts in the column direction; thus, the length of the wiring GL electrically connecting the gate driver circuit and the pixel circuit becomes ⅛. Accordingly, each of the resistance and parasitic capacitance of the wiring GL becomes ⅛, whereby degradation and delay of a signal can be inhibited and the time required for rewriting image data can be easily ensured.

Since the display device 10B of one embodiment of the present invention enables sufficient time for writing image data to be ensured easily, display image rewriting can be performed at high speed. Thus, a display device with high display quality, in particular, a display device that excels in displaying a moving image, can be obtained.

### Modification Example 2

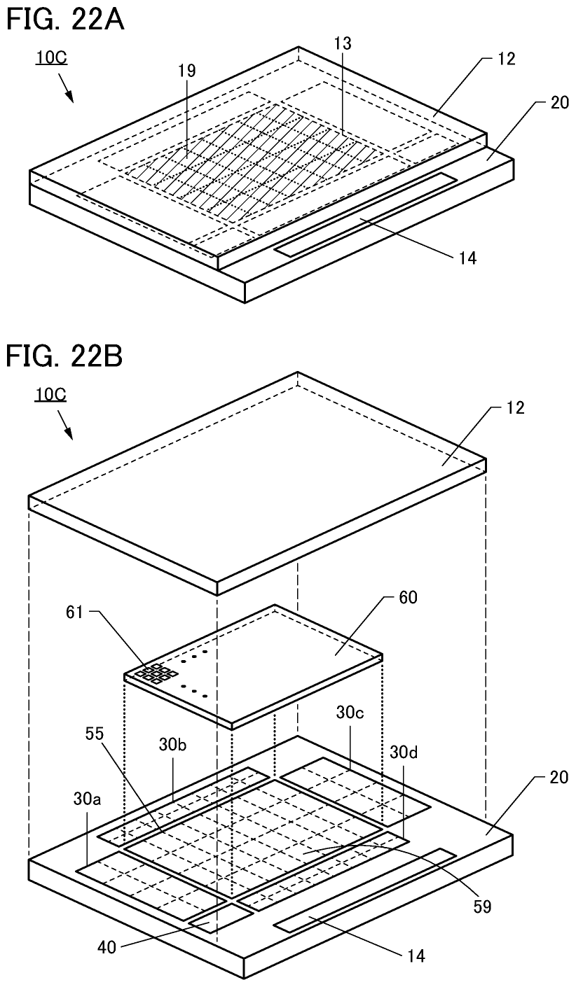

FIGS. 22A and 22B are perspective views of a display device 10C, which is a modification example of the display device 10A. Note that the display device 10C is also a modification example of the display device 10B. FIG. 22B is a perspective view illustrating structures of layers included in the display device 10C. Note that description is made mainly on portions different from those of the display device 10A and the display device 10B to reduce repeated description.

The pixel circuit group 55 including the plurality of pixel circuits 51, the driver circuit 30, the functional circuit 40, and the terminal portion 14 may be provided in the same layer. In the display device 10C, the pixel circuit group 55, the driver circuit 30, the functional circuit 40, and the terminal portion 14 are provided in the layer 20. Since the pixel circuit group 55, the driver circuit 30, and the functional circuit 40 are provided in the same layer, wirings electrically connecting the circuits can be short. Thus, wiring resistance and parasitic capacitance are reduced, leading to lower power consumption.

In the case where a c-Si transistor is used as a transistor included in the display device 10C, for example, a single crystal silicon substrate can be used as the layer 20 and the pixel circuit group 55, the driver circuit 30, the functional circuit 40, and the terminal portion 14 can be provided. When a single crystal silicon substrate is used as the layer 20, the substrate 11 can be omitted. As a result, the weight of the display device 10C can be reduced. In addition, the cost of manufacturing the display device 10C can be reduced. Thus, the productivity of the display device 10C can be improved.

Note that a transistor included in the display device 10C is not limited to a c-Si transistor. Any of a variety of transistors such as a poly-Si transistor and an OS transistor can be used as the transistor included in the display device 10C.

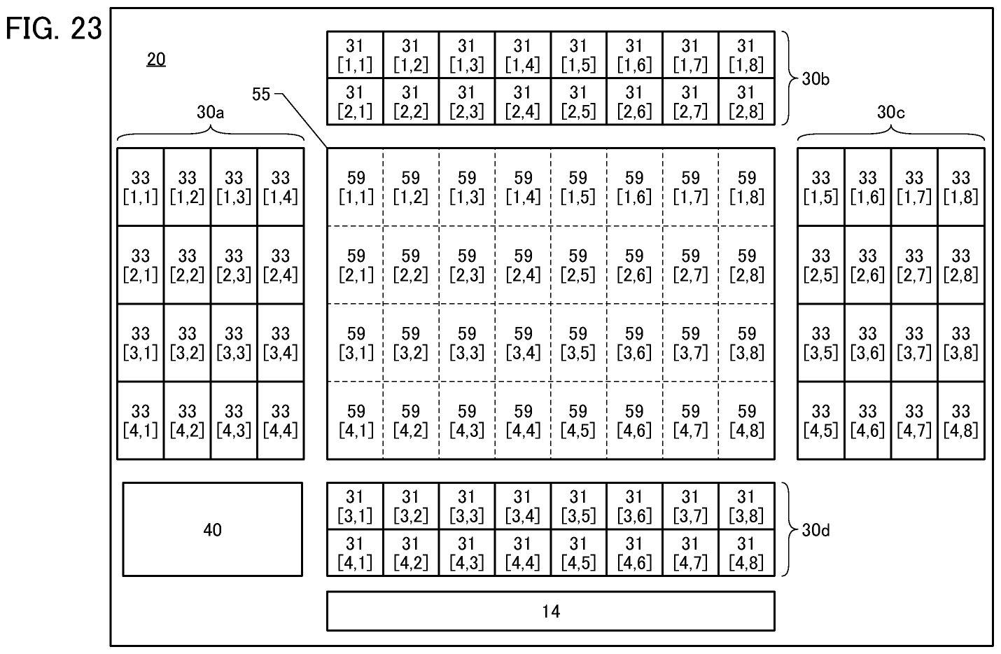

In the display device 10C illustrated in FIGS. 22A and 22B, the display portion 13 is composed of the sub-display portions 19 arranged in a matrix of m rows and n columns. Accordingly, the pixel circuit group 55 is divided into the sections 59 arranged in a matrix of m rows and n columns. FIG. 23 illustrates a planar layout of the layer 20. FIG. 23 illustrates the sections 59 of the case where m is 4 and n is 8.

In the display device 10C, the driver circuit 30 is divided into four regions: a driver circuit 30a, a driver circuit 30b, a driver circuit 30c, and a driver circuit 30d. The driver circuit 30a, the driver circuit 30b, the driver circuit 30c, and the driver circuit 30d are provided outside the pixel circuit group 55. Specifically, the driver circuit 30a is provided on a first side of the four sides of the pixel circuit group 55, the driver circuit 30c is provided on a third side that faces the first side with the pixel circuit group 55 positioned therebetween, the driver circuit 30b is provided on a second side, and the driver circuit 30d is provided on a fourth side that faces the second side with the pixel circuit group 55 positioned therebetween.

The driver circuit 30a and the driver circuit 30c each include 16 of the gate driver circuits 33. The driver circuit 30b and the driver circuit 30d each include 16 of the source driver circuits 31. Each of the gate driver circuits 33 is electrically connected to a plurality of the pixel circuits 51 included in the corresponding section 59. Each of the source driver circuits 31 is electrically connected to a plurality of the pixel circuits 51 included in the corresponding section 59.

The gate driver circuit 33 electrically connected to the section 59[1,1] is denoted as a gate driver circuit 33[1,1], and the source driver circuit 31 electrically connected to the section 59[1,1] is denoted as a source driver circuit 31[1,1] in FIG. 23. Similarly, the gate driver circuit 33 electrically connected to a section 59[4,8] is denoted as a gate driver circuit 33[4,8], and the source driver circuit 31 electrically connected to the section 59[4,8] is denoted as a source driver circuit 31[4,8].

The driver circuit 30a includes gate driver circuits 33[1,1] to 33[1,4], gate driver circuits 33[2,1] to 33[2,4], gate driver circuits 33[3,1] to 33[3,4], and gate driver circuits 33[4,1] to 33[4,4]. The driver circuit 30b includes source driver circuits 31[1,1] to 31[1,8] and source driver circuits 31[2,1] to 31[2,8]. The driver circuit 30c includes gate driver circuits 33[1,5] to 33[1,8], gate driver circuits 33[2,5] to 33[2,8], gate driver circuits 33[3,5] to 33[3,8], and gate driver circuits 33[4,5] to 33[4,8]. The driver circuit 30d includes source driver circuits 31[3,1] to 31[3,8] and source driver circuits 31[4,1] to 31[4,8].

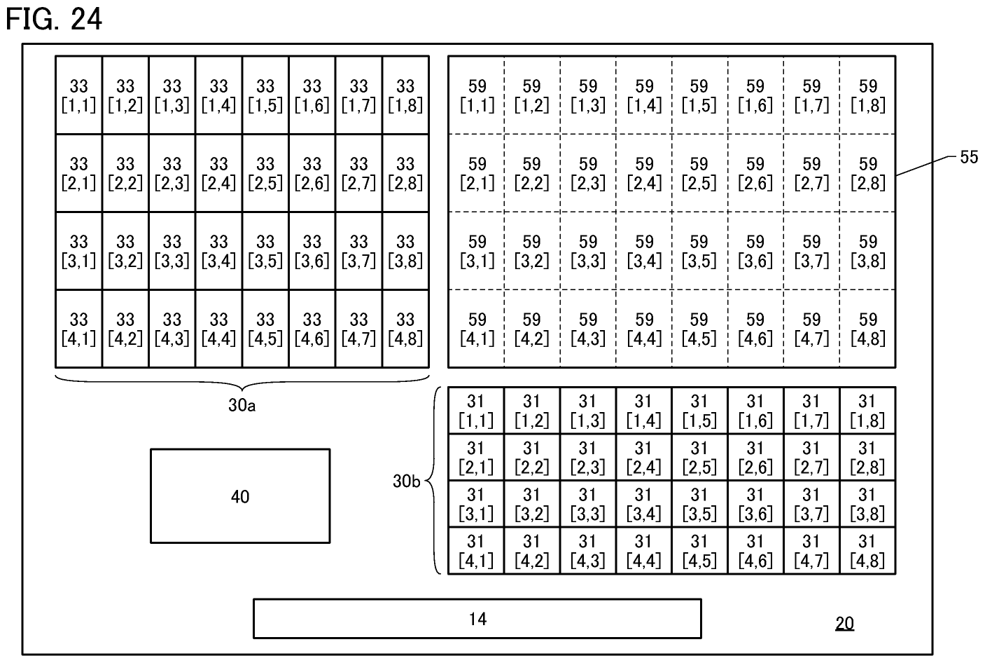

The positions of the pixel circuit group 55, the driver circuit 30, and the functional circuit 40 provided in the layer 20 are not limited to those illustrated in FIG. 23. For example, a configuration illustrated in FIG. 24 may be employed. In FIG. 24, the driver circuit 30 is divided into two regions: the driver circuit 30a and the driver circuit 30b. For example, the driver circuit 30a includes 32 of the gate driver circuits 33 (the gate driver circuits 33[1,1] to 33[4,8]) and the driver circuit 30b includes 32 of the source driver circuits 31 (the source driver circuits 31[1,1] to 31[4,8]).

Note that the display device 10B and the display device 10C of one embodiment of the present invention are each an example in which the display portion 13 is divided into the 32 sub-display portions 19. However, the division number of the display portion 13 in each of the display device 10B and the display device 10C of one embodiment of the present invention may be 16, 64, 128, or the like, without limitation to 32. As the division number of the display portion 13 increases, a reduction in practical display quality perceived by the user can be smaller.

### Embodiment 3

In this embodiment, structure examples of a display device which can be used for the electronic device of one embodiment of the present invention will be described. The display device described below as an example can be used for the display device 521 or the like in Embodiment 1.

One embodiment of the present invention is a display device including a light-emitting element (also referred to as a light-emitting device). The display device includes two or more light-emitting elements that emit light of different colors. The light-emitting elements each include a pair of electrodes and an EL layer therebetween. The light-emitting elements are preferably organic electroluminescent elements (organic EL elements). The two or more light-emitting elements that emit light of different colors include respective EL layers containing different light-emitting materials. For example, three kinds of light-emitting elements emitting red (R), green (G), and blue (B) light are included, whereby a full-color display device can be obtained.

In the case of manufacturing a display device including a plurality of light-emitting elements emitting light of different colors, at least layers (light-emitting layers) containing light-emitting materials different in emission color each need to be formed in an island shape. In a known method for separately forming part or the whole of an EL layer, an island-shaped organic film is formed by an evaporation method using a shadow mask such as a metal mask. However, this method has difficulty in achieving high resolution and a high aperture ratio of a display device because in this method, a deviation from the designed shape and position of the island-shaped organic film is caused by various influences such as the low accuracy of the metal mask position, the positional deviation between the metal mask and a substrate, a warp of the metal mask, and the vapor-scattering-induced expansion of the outline of the formed film. In addition, the outline of a layer may blur during vapor deposition, whereby the thickness of its end portion may be small. That is, the thickness of an island-shaped light-emitting layer may vary from area to area. In the case of manufacturing a display device with a large size, high definition, or high resolution, the manufacturing yield might be reduced because of low dimensional accuracy of the metal mask and deformation due to heat or the like. Thus, a measure has been taken for pseudo improvement in resolution (also referred to pixel density). As a specific measure, a unique pixel arrangement such as a PenTile pattern has been employed.

Note that in this specification and the like, the term “island shape” refers to a state where two or more layers formed using the same material in the same step are physically separated from each other. For example, “island-shaped light-emitting layer” means a state where the light-emitting layer and its adjacent light-emitting layer are physically separated from each other.

In one embodiment of the present invention, fine patterning of an EL layer is performed by photolithography without a shadow mask such as a fine metal mask (FMM). With the patterning, a high-resolution display device with a high aperture ratio, which has been difficult to achieve, can be fabricated. Moreover, EL layers can be formed separately, enabling the display device to perform extremely clear display with high contrast and high display quality. Note that, fine patterning of an EL layer may be performed using both a metal mask and photolithography, for example.

Part or the whole of the EL layer can be physically partitioned, inhibiting a leakage current flowing between adjacent light-emitting elements through a layer (also referred to as a common layer) shared by the light-emitting elements. This can prevent crosstalk due to unintended light emission, so that a display device with extremely high contrast can be obtained. Specifically, a display device having high current efficiency at low luminance can be obtained.

Note that a display device of one embodiment of the present invention can also be obtained by combining white-light-emitting elements with a color filter. In that case, the light-emitting elements having the same structure can be provided in pixels (subpixels) emitting light of different colors, allowing all the layers to be common layers. Furthermore, part or the whole of the EL layer is partitioned by photolithography, which inhibits a leakage current from flowing through the common layers to achieve a display device with high contrast. In particular, when an element has a tandem structure in which a plurality of light-emitting layers are stacked with a highly conductive intermediate layer therebetween, a leakage current through the intermediate layer can be effectively prevented, achieving a display device with high luminance, high resolution, and high contrast.

Furthermore, an insulating layer covering at least a side surface of the island-shaped light-emitting layer is preferably provided. The insulating layer may cover part of a top surface of the island-shaped EL layer. For the insulating layer, a material having a barrier property against water and oxygen is preferably used. For example, an inorganic insulating film that is less likely to diffuse water and oxygen can be used. Thus, the deterioration of the EL layer is inhibited, and a highly reliable display device can be achieved.

Between two light-emitting elements that are adjacent to each other, there is a region (depression) where the EL layers of the light-emitting elements are not provided. In the case where the depression is covered with a common electrode or with a common electrode and a common layer, the common electrode might be disconnected (or “step-cut”) by a step at an end portion of the EL layer, thereby causing insulation of the common electrode over the EL layer. In view of this, the local gap between the two adjacent light-emitting elements is preferably filled with a resin layer (also referred to as local filling planarization, or LFP) serving as a planarization film. The resin layer has a function of a planarization film. This structure can inhibit a step-cut of the common layer or the common electrode, making it possible to obtain a highly reliable display device.

More specific structure examples of the display device of one embodiment of the present invention will be described below with reference to drawings.

### Structure Example

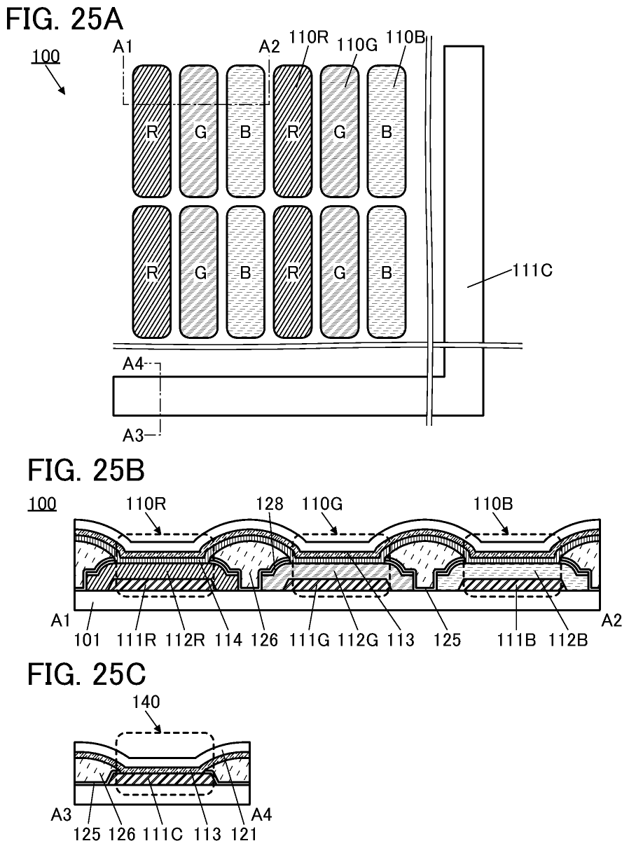

FIG. 25A is a schematic top view of a display device 100 of one embodiment of the present invention. The display device 100 includes, over a substrate 101, a plurality of light-emitting elements 110R exhibiting red, a plurality of light-emitting elements 110G exhibiting green, and a plurality of light-emitting elements 110B exhibiting blue. In FIG. 25A, light-emitting regions of the light-emitting elements are denoted by R, G, and B to easily differentiate the light-emitting elements.

The light-emitting elements 110R, the light-emitting elements 110G, and the light-emitting elements 110B are arranged in a matrix. FIG. 25A illustrates what is called a stripe arrangement, in which light-emitting elements of the same color are arranged in one direction. Note that the arrangement of the light-emitting elements is not limited thereto; another arrangement such as an S stripe, delta, Bayer, zigzag, PenTile, or diamond pattern may also be used.

As each of the light-emitting elements 110R, 110G, and 110B, an EL element such as an organic light-emitting diode (OLED) or a quantum-dot light-emitting diode (QLED) is preferably used, for example. Examples of a light-emitting substance contained in the EL element include a substance exhibiting fluorescence (fluorescent material), a substance exhibiting phosphorescence (phosphorescent material), and a substance exhibiting thermally activated delayed fluorescence (a thermally activated delayed fluorescent (TADF) material). Examples of the light-emitting substance contained in the EL element include not only organic compounds but also inorganic compounds (e.g., quantum dot materials).

FIG. 25A also illustrates a connection electrode 111C that is electrically connected to a common electrode 113. The connection electrode 111C is supplied with a potential (e.g., an anode potential or a cathode potential) that is to be supplied to the common electrode 113. The connection electrode 111C is provided outside a display region where the light-emitting elements 110R and the like are arranged.

The connection electrode 111C can be provided along the outer periphery of the display region. For example, the connection electrode 111C may be provided along one side of the outer periphery of the display region or two or more sides of the outer periphery of the display region. That is, in the case where the display region has a rectangular top surface, a top surface of the connection electrode 111C can have a band shape (a rectangular shape), an L shape, a square bracket shape, a quadrangular shape, or the like.

FIGS. 25B and 25C are the schematic cross-sectional views taken along dashed-dotted line A1-A2 and dashed-dotted line A3-A4 in FIG. 25A. FIG. 25B is a schematic cross-sectional view of the light-emitting element 110R, the light-emitting element 110G, and the light-emitting element 110B, and FIG. 25C is a schematic cross-sectional view of a connection portion 140 to which the connection electrode 111C and the common electrode 113 are connected.

The light-emitting element 110R includes a pixel electrode 111R, an organic layer 112R, a common layer 114, and the common electrode 113. The light-emitting element 110G includes a pixel electrode 111G, an organic layer 112G, the common layer 114, and the common electrode 113. The light-emitting element 110B includes a pixel electrode 111B, an organic layer 112B, the common layer 114, and the common electrode 113. The common layer 114 and the common electrode 113 are shared by the light-emitting element 110R, the light-emitting element 110G, and the light-emitting element 110B.

The organic layer 112R of the light-emitting element 110R contains a light-emitting organic compound that emits light with intensity at least in a red wavelength range. The organic layer 112G of the light-emitting element 110G contains a light-emitting organic compound that emits light with intensity at least in a green wavelength range. The organic layer 112B of the light-emitting element 110B contains a light-emitting organic compound that emits light with intensity at least in a blue wavelength range. Each of the organic layers 112R, 112G, and 112B can also be referred to as an EL layer, and includes at least a layer containing a light-emitting organic compound (a light-emitting layer).

Hereafter, the term “light-emitting element 110” is sometimes used to describe matters common to the light-emitting elements 110R, 110G, and 110B. Likewise, in the description of matters common to the components that are distinguished using alphabets, such as the organic layers 112R, 112G, and 112B, reference numerals without such alphabets are sometimes used.

The organic layer 112 and the common layer 114 can each independently include one or more of an electron-injection layer, an electron-transport layer, a hole-injection layer, and a hole-transport layer. For example, the organic layer 112 can include a hole-injection layer, a hole-transport layer, a light-emitting layer, and an electron-transport layer that are stacked from the pixel electrode 111 side, and the common layer 114 can include an electron-injection layer.

The pixel electrode 111R, the pixel electrode 111G, and the pixel electrode 111B are provided for the respective light-emitting elements. Each of the common electrode 113 and common layer 114 is provided as a continuous layer shared by the light-emitting elements. A conductive film that has a property of transmitting visible light is used for either the respective pixel electrodes or the common electrode 113, and a reflective conductive film is used for the other. When the respective pixel electrodes are light-transmitting electrodes and the common electrode 113 is a reflective electrode, a bottom-emission display device is obtained. When the respective pixel electrodes are reflective electrodes and the common electrode 113 is a light-transmitting electrode, a top-emission display device is obtained. Note that when both the respective pixel electrodes and the common electrode 113 transmit light, a dual-emission display device can be obtained.

A protective layer 121 is provided over the common electrode 113 so as to cover the light-emitting elements 110R, 110G, and 110B. The protective layer 121 has a function of preventing diffusion of impurities such as water into each light-emitting element from above.

The pixel electrode 111 preferably has an end portion with a tapered shape. In the case where the pixel electrode has an end portion with a tapered shape, a portion of the organic layer 112 that is provided along a side surface of the pixel electrode also has a tapered shape. When the side surface of the pixel electrode is tapered, coverage with an EL layer provided along the side surface of the pixel electrode can be improved. The side surface of the pixel electrode having such a tapered shape is preferred because it allows a foreign matter (such as dust or particles) mixing during the manufacturing process to be easily removed by treatment such as cleaning.

In this specification and the like, a tapered shape indicates a shape in which at least part of a side surface of a structure is inclined to a substrate surface. For example, a tapered shape preferably includes a region where the angle between the inclined side surface and the substrate surface (such an angle is also referred to as a taper angle) is less than 90°.

The organic layer 112 has an island shape as a result of processing by photolithography. Thus, the angle formed between a top surface and a side surface of an end portion of the organic layer 112 is approximately 90°. By contrast, an organic film formed using a fine metal mask (FMM) or the like has a thickness that tends to gradually decrease with decreasing distance to an end portion, and has a top surface forming a slope in an area extending greater than or equal to 1 μm and less than or equal to 10 μm from the end portion, for example; thus, such an organic film has a shape whose top surface and side surface cannot be easily distinguished from each other.

An insulating layer 125, a resin layer 126, and a layer 128 are included between two adjacent light-emitting elements.

Between two adjacent light-emitting elements, a side surface of the organic layer 112 of one light-emitting element faces a side surface of the organic layer 112 of the other light-emitting element with a resin layer 126 between the side surfaces. The resin layer 126 is positioned between two adjacent light-emitting elements so as to fill the region between the end portions of their organic layers 112 and the region between the two organic layers 112. The resin layer 126 has a top surface with a smooth convex shape. The top surface of the resin layer 126 is covered with the common layer 114 and the common electrode 113.

The resin layer 126 functions as a planarization film that fills a step between two adjacent light-emitting elements. Providing the resin layer 126 can prevent a phenomenon in which the common electrode 113 is divided by a step at an end portion of the organic layer 112 (also referred to as disconnection) from occurring and the common electrode 113 over the organic layer 112 from being insulated. The resin layer 126 can also be referred to as a local filling planarization (LFP) layer.

An insulating layer containing an organic material can be suitably used as the resin layer 126. Examples of materials used for the resin layer 126 include an acrylic resin, a polyimide resin, an epoxy resin, an imide resin, a polyamide resin, a polyimide-amide resin, a silicone resin, a siloxane resin, a benzocyclobutene-based resin, a phenol resin, and precursors of these resins. The resin layer 126 may be formed using an organic material such as polyvinyl alcohol (PVA), polyvinyl butyral, polyvinylpyrrolidone, polyethylene glycol, polyglycerin, pullulan, water-soluble cellulose, or an alcohol-soluble polyamide resin.

A photosensitive resin can also be used for the resin layer 126. A photoresist may be used for the photosensitive resin. As the photosensitive resin, a positive photosensitive material or a negative photosensitive material can be used.

The resin layer 126 may contain a material absorbing visible light. For example, the resin layer 126 itself may be made of a material absorbing visible light, or the resin layer 126 may contain a pigment absorbing visible light. For example, the resin layer 126 can be formed using a resin that can be used as a color filter transmitting red, blue, or green light and absorbing light of the other colors; or a resin that contains carbon black as a pigment and functions as a black matrix.

The insulating layer 125 is provided to be in contact with the side surface of the organic layer 112 and to cover an upper end portion of the organic layer 112. Part of the insulating layer 125 is in contact with a top surface of the substrate 101.

The insulating layer 125 is positioned between the resin layer 126 and the organic layer 112 to function as a protective film for preventing contact between the resin layer 126 and the organic layer 112. In the case of bringing the resin layer 126 into contact with the organic layer 112, the organic layer 112 might be dissolved by an organic solvent or the like used in formation of the resin layer 126. In view of this, the insulating layer 125 is provided between the organic layer 112 and the resin layer 126 as described in this embodiment to protect the side surface of the organic layer.

The insulating layer 125 can be an insulating layer containing an inorganic material. As the insulating layer 125, an inorganic insulating film such as an oxide insulating film, a nitride insulating film, an oxynitride insulating film, or a nitride oxide insulating film can be used, for example. The insulating layer 125 may have a single-layer structure or a stacked-layer structure. Examples of the oxide insulating film include a silicon oxide film, an aluminum oxide film, a magnesium oxide film, an indium gallium zinc oxide film, a gallium oxide film, a germanium oxide film, an yttrium oxide film, a zirconium oxide film, a lanthanum oxide film, a neodymium oxide film, a hafnium oxide film, and a tantalum oxide film. Examples of the nitride insulating film include a silicon nitride film and an aluminum nitride film. Examples of the oxynitride insulating film include a silicon oxynitride film and an aluminum oxynitride film. Examples of the nitride oxide insulating film include a silicon nitride oxide film and an aluminum nitride oxide film. In particular, when a metal oxide film such as an aluminum oxide film or a hafnium oxide film or an inorganic insulating film such as a silicon oxide film that is formed by an ALD method is used for the insulating layer 125, the insulating layer 125 has a small number of pin holes and excels in a function of protecting the EL layer.

Note that in this specification and the like, oxynitride refers to a material in which an oxygen content is higher than a nitrogen content, and nitride oxide refers to a material in which a nitrogen content is higher than an oxygen content. For example, silicon oxynitride refers to a material in which an oxygen content is higher than a nitrogen content, and silicon nitride oxide refers to a material in which a nitrogen content is higher than an oxygen content.

The insulating layer 125 can be formed by a sputtering method, a CVD method, a PLD method, an ALD method, or the like. The insulating layer 125 is preferably formed by an ALD method achieving good coverage.

Between the insulating layer 125 and the resin layer 126, a reflective film (e.g., a metal film containing one or more of silver, palladium, copper, titanium, aluminum, and the like) may be provided to reflect the light that is emitted from the light-emitting layer. In this case, the light extraction efficiency can be increased.

Part of a protective layer (also referred to as a mask layer or a sacrificial layer) for protecting the organic layer 112 during etching of the organic layer 112 survives the etching to become the layer 128. For the layer 128, the material that can be used for the insulating layer 125 can be used. Particularly, the layer 128 and the insulating layer 125 are preferably formed with the same material, in which case an apparatus or the like for processing can be used in common.

In particular, a metal oxide film such as an aluminum oxide film or a hafnium oxide film and an inorganic insulating film such as a silicon oxide film which are formed by an ALD method have a small number of pinholes, and thus excel in the function of protecting the EL layer and are preferably used for the insulating layer 125 and the layer 128.

The protective layer 121 is provided to cover the common electrode 113.

The protective layer 121 can have, for example, a single-layer structure or a stacked-layer structure at least including an inorganic insulating film. Examples of the inorganic insulating film include an oxide film or a nitride film such as a silicon oxide film, a silicon oxynitride film, a silicon nitride oxide film, a silicon nitride film, an aluminum oxide film, an aluminum oxynitride film, or a hafnium oxide film. Alternatively, a semiconductor material or a conductive material such as indium gallium oxide, indium zinc oxide, indium tin oxide, or indium gallium zinc oxide may be used for the protective layer 121.

As the protective layer 121, a stacked film of an inorganic insulating film and an organic insulating film can be used. For example, a structure in which an organic insulating film is sandwiched between a pair of inorganic insulating films is preferable. Furthermore, it is preferred that the organic insulating film function as a planarization film. With this structure, a top surface of the organic insulating film can be flat, and accordingly, coverage with the inorganic insulating film over the organic insulating film is improved, leading to an improvement in barrier properties. Moreover, since a top surface of the protective layer 121 is flat, a preferable effect can be obtained; when a component (e.g., a color filter, an electrode of a touch sensor, a lens array, or the like) is provided above the protective layer 121, the component is less affected by an uneven shape caused by the lower structure.

FIG. 25C illustrates the connection portion 140 in which the connection electrode 111C is electrically connected to the common electrode 113. In the connection portion 140, an opening portion is provided in the insulating layer 125 and the resin layer 126 over the connection electrode 111C. In the opening portion, the connection electrode 111C and the common electrode 113 are electrically connected to each other.

Although FIG. 25C illustrates the connection portion 140 in which the connection electrode 111C and the common electrode 113 are electrically connected to each other, the common electrode 113 may be provided over the connection electrode 111C with the common layer 114 therebetween. Particularly in the case of the common layer 114 that includes a carrier-injection layer, for example, the common layer 114 can be formed to be thin using a material with sufficiently low electrical resistivity and thus can be in the connection portion 140 almost without causing any problem. Accordingly, the common electrode 113 and the common layer 114 can be formed using the same shielding mask, whereby manufacturing costs can be reduced.

The above is the description of the structure example of the display device.

### [Pixel Layout]

Pixel layouts different from the layout in FIG. 25A will be mainly described below. There is no particular limitation on the arrangement of the light-emitting elements (subpixels), and a variety of methods can be employed.

Examples of a top surface shape of the subpixel include polygons such as a triangle, a tetragon (including a rectangle and a square), and a pentagon; polygons with rounded corners; an ellipse; and a circle. Here, a top surface shape of the subpixel corresponds to a top surface shape of a light-emitting region of the light-emitting element.

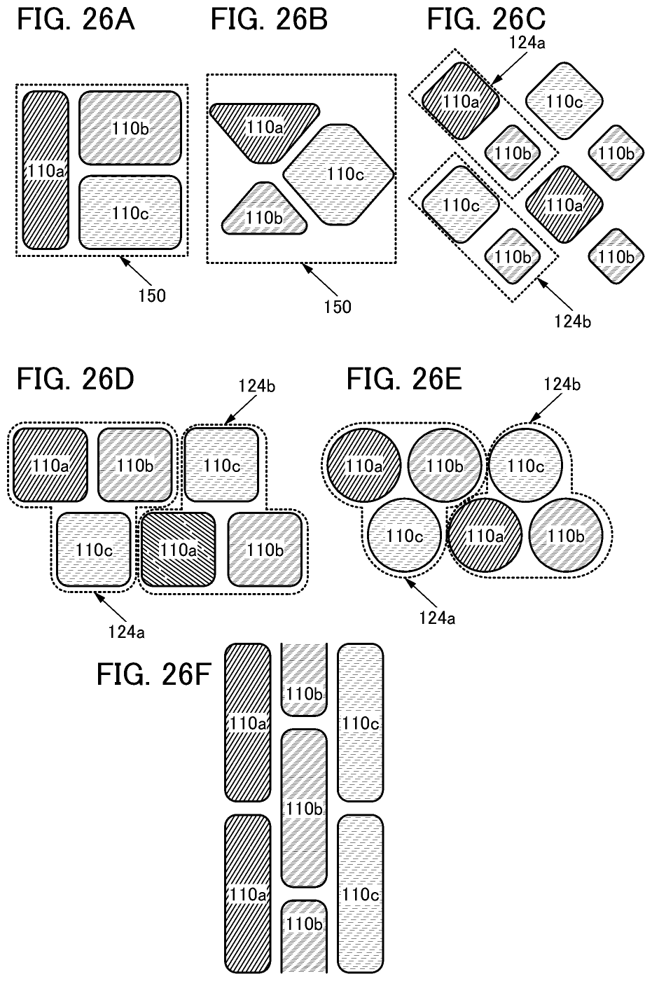

A pixel 150 illustrated in FIG. 26A employs S-stripe arrangement. The pixel 150 in FIG. 26A consists of three subpixels: light-emitting elements 110a, 110b, and 110c. For example, the light-emitting element 110a may be a blue-light-emitting element, the light-emitting element 110b may be a red-light-emitting element, and the light-emitting element 110c may be a green-light-emitting element.

The pixel 150 illustrated in FIG. 26B includes the light-emitting element 110a whose top surface has a rough trapezoidal shape with rounded corners, the light-emitting element 110b whose top surface has a rough triangle shape with rounded corners, and the light-emitting element 110c whose top surface has a rough tetragonal or rough hexagonal shape with rounded corners. The light-emitting element 110a has a larger light-emitting area than the light-emitting element 110b. In this manner, the shapes and sizes of the light-emitting elements can be determined independently. For example, the size of a light-emitting element with higher reliability can be smaller. For example, the light-emitting element 110a may be a green-light-emitting element, the light-emitting element 110b may be a red-light-emitting element, and the light-emitting element 110c may be a blue-light-emitting element.

Pixels 124a and 124b illustrated in FIG. 26C employ PenTile arrangement. FIG. 26C illustrates an example in which the pixels 124a including the light-emitting elements 110a and 110b and the pixels 124b including the light-emitting elements 110b and 110c are alternately arranged. For example, the light-emitting element 110a may be a red-light-emitting element, the light-emitting element 110b may be a green-light-emitting element, and the light-emitting element 110c may be a blue-light-emitting element.

The pixels 124a and 124b illustrated in FIGS. 26D and 26E employ delta arrangement. The pixel 124a includes two light-emitting elements (the light-emitting elements 110a and 110b) in the upper row (first row) and one light-emitting element (the light-emitting element 110c) in the lower row (second row). The pixel 124b includes one light-emitting element (the light-emitting element 110c) in the upper row (first row) and two light-emitting elements (the light-emitting elements 110a and 110b) in the lower row (second row). For example, the light-emitting element 110a may be a red-light-emitting element, the light-emitting element 110b may be a green-light-emitting element, and the light-emitting element 110c may be a blue-light-emitting element.

FIG. 26D illustrates an example where the top surface of each light-emitting element has a rough tetragonal shape with rounded corners, and FIG. 26E illustrates an example where the top surface of each light-emitting element is circular.

FIG. 26F illustrates an example where light-emitting elements of different colors are arranged in a zigzag manner. Specifically, the positions of the top sides of two light-emitting elements arranged in the column direction (e.g., the light-emitting element 110a and the light-emitting element 110b or the light-emitting element 110b and the light-emitting element 110c) are not aligned in the top view. For example, the light-emitting element 110a may be a red-light-emitting element, the light-emitting element 110b may be a green-light-emitting element, and the light-emitting element 110c may be a blue-light-emitting element.

In a photolithography method, as a pattern to be formed by processing becomes finer, the influence of light diffraction becomes more difficult to ignore; therefore, the fidelity in transferring a photomask pattern by light exposure is degraded, and it becomes difficult to process a resist mask into a desired shape. Thus, a pattern with rounded corners is likely to be formed even with a rectangular photomask pattern. Consequently, a top surface of a light-emitting element may have a polygonal shape with rounded corners, an elliptical shape, a circular shape, or the like.

Furthermore, in the manufacturing method of the display panel of one embodiment of the present invention, the EL layer is processed into an island shape with the use of a resist mask. A resist film formed over the EL layer needs to be cured at a temperature lower than the upper temperature limit of the EL layer. Therefore, the resist film is insufficiently cured in some cases depending on the upper temperature limit of the material of the EL layer and the curing temperature of the resist material. An insufficiently cured resist film may have a shape different from a desired shape by processing. As a result, a top surface of the EL layer may have a polygonal shape with rounded corners, an elliptical shape, a circular shape, or the like. For example, when a resist mask with a square top surface is intended to be formed, a resist mask with a circular top surface may be formed, and the top surface of the EL layer may be circular.

To obtain a desired top surface shape of the EL layer, a technique of correcting a mask pattern in advance so that a transferred pattern agrees with a design pattern (an optical proximity correction (OPC) technique) may be used. Specifically, with the OPC technique, a pattern for correction is added to a corner portion or the like of a figure on a mask pattern.

The above is the description of the pixel layouts.

At least part of this embodiment can be implemented in combination with any of the other embodiments described in this specification, as appropriate.

### Embodiment 4

In this embodiment, other structure examples of a display device (display panel) that can be used for the electronic device of one embodiment of the present invention will be described. Display devices (display panels) described below as examples can each be used for the display device 521 or the like in Embodiment 1.

The display device of this embodiment can be a high-resolution display device. Thus, the display device of one embodiment of the present invention can be used for display portions of information terminals (wearable devices) such as watch-type or bracelet-type information terminals and display portions of wearable devices capable of being worn on a head, such as a VR device such as a head-mounted display and a glasses-type AR device.

### [Display Module]

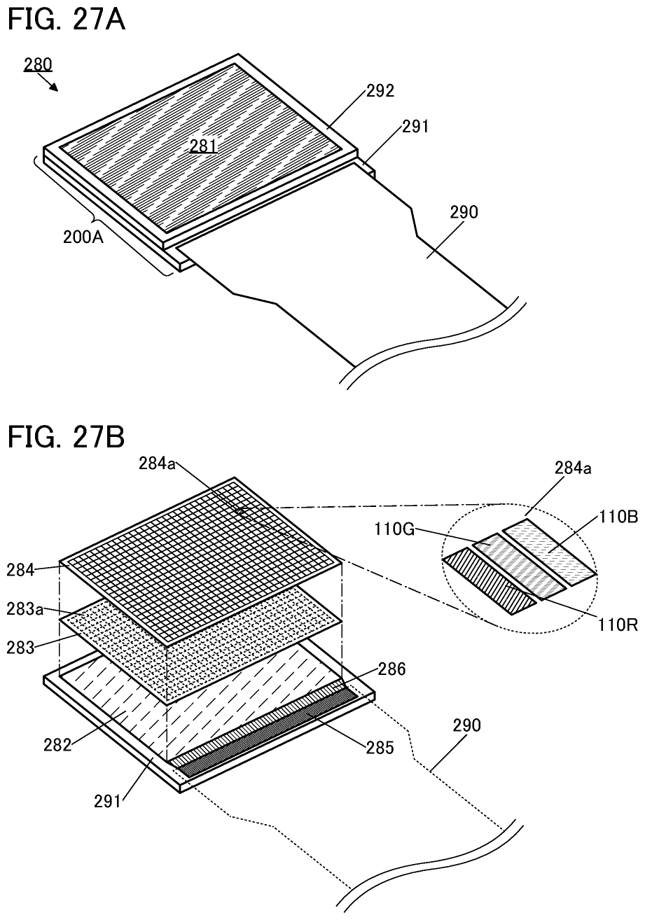

FIG. 27A is a perspective view of a display module 280. The display module 280 includes a display device 200A and an FPC 290. Note that a display panel included in the display module 280 is not limited to the display device 200A, and may be any of display devices 200B to 200G, which are described later.

The display module 280 includes a substrate 291 and a substrate 292. The display module 280 includes a display portion 281. The display portion 281 is a region where an image is displayed.

FIG. 27B is a perspective view schematically illustrating a structure on the substrate 291 side. Over the substrate 291, a circuit portion 282, a pixel circuit portion 283 over the circuit portion 282, and the pixel portion 284 over the pixel circuit portion 283 are stacked. In addition, a terminal portion 285 for connection to the FPC 290 is included in a portion not overlapping with the pixel portion 284 over the substrate 291. The terminal portion 285 and the circuit portion 282 are electrically connected to each other through a wiring portion 286 formed of a plurality of wirings.

The pixel portion 284 includes a plurality of pixels 284a arranged periodically. An enlarged view of one pixel 284a is illustrated on the right side in FIG. 27B. The pixel 284a includes the light-emitting element 110R emitting red light, the light-emitting element 110G emitting green light, and the light-emitting element 110B emitting blue light.

The pixel circuit portion 283 includes a plurality of pixel circuits 283a arranged periodically. One pixel circuit 283a is a circuit that controls light emission from three light-emitting devices included in one pixel 284a. One pixel circuit 283a may be provided with three circuits each of which controls light emission of one light-emitting device. For example, the pixel circuit 283a can include at least one selection transistor, one current control transistor (driving transistor), and a capacitor for one light-emitting device. In this case, a gate signal is input to a gate of the selection transistor, and a source signal is input to a source of the selection transistor. Thus, an active-matrix display panel is achieved.

The circuit portion 282 includes a circuit for driving the pixel circuits 283a in the pixel circuit portion 283. For example, one or both of a gate line driver circuit and a source line driver circuit are preferably included. In addition, at least one of an arithmetic circuit, a memory circuit, a power supply circuit, and the like may be included. A transistor included in the circuit portion 282 may constitute part of the pixel circuit 283a. That is, the pixel circuit 283a may be constituted by a transistor included in the pixel circuit portion 283 and a transistor included in the circuit portion 282.

The FPC 290 functions as a wiring for supplying a video signal, a power supply potential, and the like to the circuit portion 282 from the outside. An IC may be mounted on the FPC 290.

The display module 280 can have a structure in which one or both of the pixel circuit portion 283 and the circuit portion 282 are stacked below the pixel portion 284; thus, the aperture ratio (the effective display area ratio) of the display portion 281 can be significantly high. For example, the aperture ratio of the display portion 281 can be greater than or equal to 40% and less than 100%, preferably greater than or equal to 50% and less than or equal to 95%, and further preferably greater than or equal to 60% and less than or equal to 95%. Furthermore, the pixels 284a can be arranged extremely densely and thus the display portion 281 can have greatly high resolution. For example, the pixels 284a are preferably arranged in the display portion 281 with a resolution greater than or equal to 2000 ppi, preferably greater than or equal to 3000 ppi, further preferably greater than or equal to 5000 ppi, and still further preferably greater than or equal to 6000 ppi, and less than or equal to 20000 ppi or less than or equal to 30000 ppi.

Such a display module 280 has extremely high resolution, and thus can be suitably used for a device for VR such as a head-mounted display or a glasses-type device for AR. For example, even in the case of a structure in which the display portion of the display module 280 is seen through a lens, pixels of the extremely-high-resolution display portion 281 included in the display module 280 are prevented from being seen when the display portion is enlarged by the lens, so that display providing a high sense of immersion can be performed. Without being limited thereto, the display module 280 can be suitably used for electronic devices including a relatively small display portion. For example, the display module 280 can be favorably used in a display portion of a wearable electronic device, such as a wrist watch.

### [Display Device 200A]

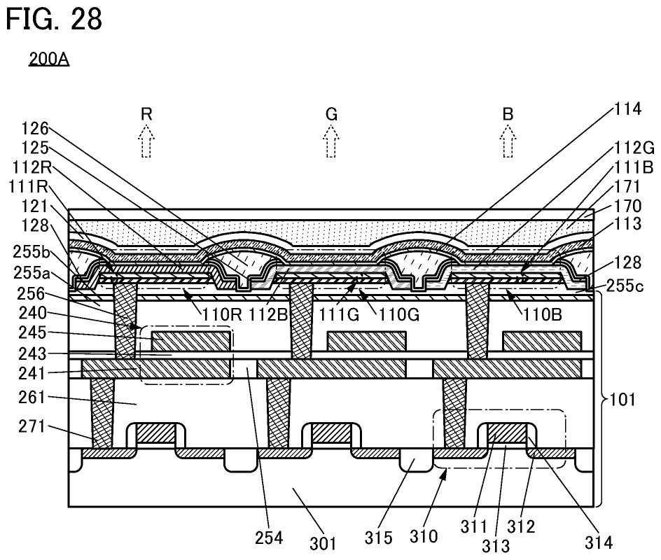

The display device 200A illustrated in FIG. 28 includes a substrate 301, the light-emitting elements 110R, 110G, and 110B, a capacitor 240, and a transistor 310.

The substrate 301 corresponds to the substrate 291 in FIGS. 27A and 27B.

The transistor 310 is a transistor whose channel formation region is in the substrate 301. As the substrate 301, a semiconductor substrate such as a single crystal silicon substrate can be used, for example. The transistor 310 includes part of the substrate 301, a conductive layer 311, a low-resistance region 312, an insulating layer 313, and an insulating layer 314. The conductive layer 311 functions as a gate electrode. The insulating layer 313 is positioned between the substrate 301 and the conductive layer 311 and functions as a gate insulating layer. The low-resistance region 312 is a region where the substrate 301 is doped with an impurity, and functions as one of a source and a drain. The insulating layer 314 is provided to cover a side surface of the conductive layer 311.

An element isolation layer 315 is provided between two adjacent transistors 310 so as to be embedded in the substrate 301.

Furthermore, an insulating layer 261 is provided to cover the transistor 310, and the capacitor 240 is provided over the insulating layer 261.

The capacitor 240 includes a conductive layer 241, a conductive layer 245, and an insulating layer 243 between the conductive layers 241 and 245. The conductive layer 241 functions as one electrode of the capacitor 240, the conductive layer 245 functions as the other electrode of the capacitor 240, and the insulating layer 243 functions as a dielectric of the capacitor 240.

The conductive layer 241 is provided over the insulating layer 261 and is embedded in an insulating layer 254. The conductive layer 241 is electrically connected to one of the source and the drain of the transistor 310 through a plug 271 embedded in the insulating layer 261. The insulating layer 243 is provided to cover the conductive layer 241. The conductive layer 245 is provided in a region overlapping with the conductive layer 241 with the insulating layer 243 therebetween.

An insulating layer 255a is provided to cover the capacitor 240; an insulating layer 255b is provided over the insulating layer 255a; and an insulating layer 255c is provided over the insulating layer 255b.

An inorganic insulating film can be suitably used as each of the insulating layers 255a, 255b, and 255c. For example, it is preferred that a silicon oxide film be used as the insulating layers 255a and 255c and a silicon nitride film be used as the insulating layer 255b. This enables the insulating layer 255b to function as an etching protective film. Although this embodiment describes an example in which part of the insulating layer 255c is etched to form a recessed portion, the recessed portion is not necessarily provided in the insulating layer 255c.

The light-emitting element 110R, the light-emitting element 110G, and the light-emitting element 110B are provided over the insulating layer 255c. Embodiment 3 can be referred to for the structures of the light-emitting element 110R, the light-emitting element 110G, and the light-emitting element 110B.

In the display device 200A, since the light-emitting devices of different colors are separately formed, the difference between the chromaticity at low luminance emission and that at high luminance emission is small. Furthermore, since the organic layers 112R, 112G, and 112B are separated from each other, crosstalk generated between adjacent subpixels can be prevented while the display device 200A has high resolution. Accordingly, the display panel can have high resolution and high display quality.

In the region between adjacent light-emitting elements, the insulating layer 125, the resin layer 126, and the layer 128 are provided.

The pixel electrodes 111R, 111G, and 111B of the light-emitting elements are each electrically connected to the one of the source and the drain of the transistor 310 through a plug 256 embedded in the insulating layers 255a, 255b, and 255c, the conductive layer 241 embedded in the insulating layer 254, and the plug 271 embedded in the insulating layer 261. A top surface of the insulating layer 255c and a top surface of the plug 256 are level with or substantially level with each other. Any of a variety of conductive materials can be used for the plugs.

The protective layer 121 is provided over the light-emitting elements 110R, 110G, and 110B. A substrate 170 is bonded above the protective layer 121 with an adhesive layer 171.

An insulating layer covering an end portion of a top end portion of the pixel electrode 111 is not provided between two adjacent pixel electrodes 111. Thus, the interval between adjacent light-emitting elements can be extremely shortened. Accordingly, the display device can have high resolution or high definition.

### [Display Device 200B]

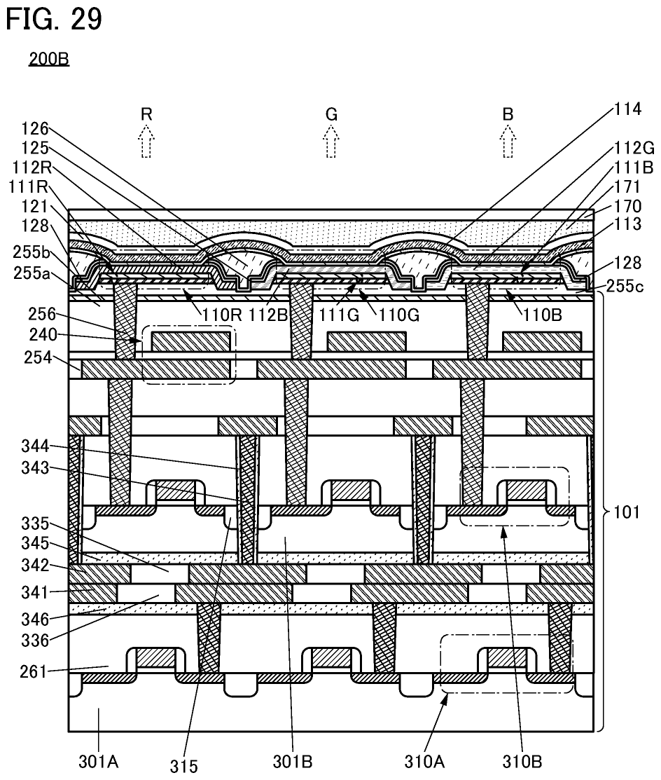

The display device 200B illustrated in FIG. 29 has a structure in which a transistor 310A and a transistor 310B each having a channel formed in a semiconductor substrate are stacked. Note that in the following description of display panels, the description of portions similar to those of the above-described display panel may be omitted.

In the display device 200B, a substrate 301B provided with the transistor 310B, the capacitor 240, and the light-emitting devices is bonded to a substrate 301A provided with the transistor 310A.

Here, an insulating layer 345 is provided on a bottom surface of the substrate 301B. An insulating layer 346 is provided over the insulating layer 261 over the substrate 301A. The insulating layers 345 and 346 function as protective layers and can inhibit diffusion of impurities into the substrate 301B and the substrate 301A. As the insulating layers 345 and 346, an inorganic insulating film that can be used as the protective layer 121 or an insulating layer 332 can be used.

The substrate 301B is provided with a plug 343 that penetrates the substrate 301B and the insulating layer 345. An insulating layer 344 functioning as a protective layer is preferably provided to cover a side surface of the plug 343.

A conductive layer 342 is provided under the insulating layer 345 on the rear surface of the substrate 301B. The conductive layer 342 is embedded in the insulating layer 335. Bottom surfaces of the conductive layer 342 and the insulating layer 335 are planarized. The conductive layer 342 is electrically connected to the plug 343.

A conductive layer 341 is provided over the insulating layer 346 over the substrate 301A. The conductive layer 341 is embedded in the insulating layer 336. Top surfaces of the conductive layer 341 and the insulating layer 336 are planarized.

The conductive layers 341 and 342 are preferably formed using the same conductive material. For example, it is possible to use a metal film containing an element selected from Al, Cr, Cu, Ta, Ti, Mo, and W, or a metal nitride film containing any of the above elements as a component (a titanium nitride film, a molybdenum nitride film, or a tungsten nitride film). Copper is particularly preferably used for the conductive layers 341 and 342. In that case, it is possible to employ copper-to-copper (Cu-to-Cu) direct bonding (a technique for achieving electrical continuity by connecting copper (Cu) pads).

### [Display Device 200C]

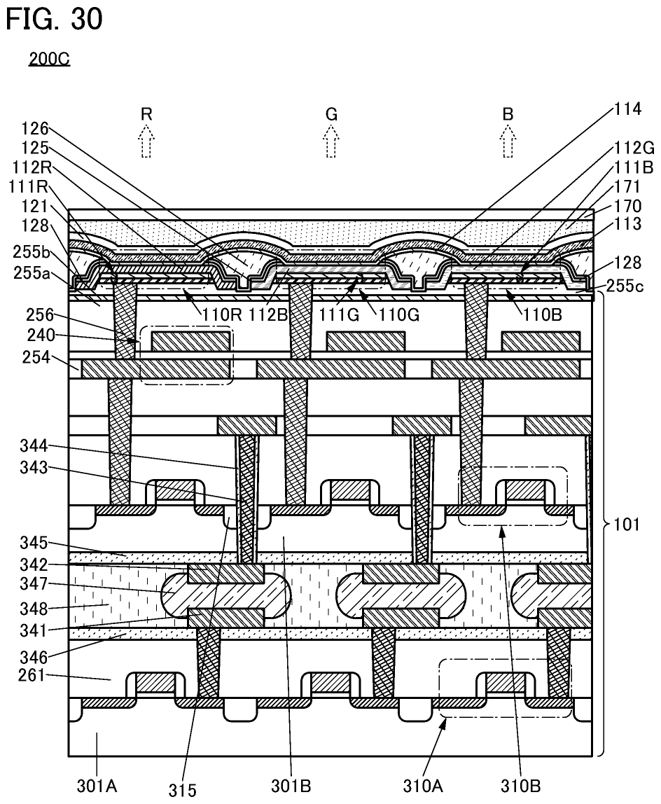

The display device 200C illustrated in FIG. 30 has a structure in which the conductive layer 341 and the conductive layer 342 are bonded to each other with a bump 347.

As illustrated in FIG. 30, providing the bump 347 between the conductive layer 341 and the conductive layer 342 enables the conductive layers 341 and 342 to be electrically connected to each other. The bump 347 can be formed using a conductive material containing gold (Au), nickel (Ni), indium (In), tin (Sn), or the like, for example. As another example, solder may be used for the bump 347. An adhesive layer 348 may be provided between the insulating layer 345 and the insulating layer 346. In the case where the bump 347 is provided, the insulating layer 335 and the insulating layer 336 may be omitted.

### [Display Device 200D]

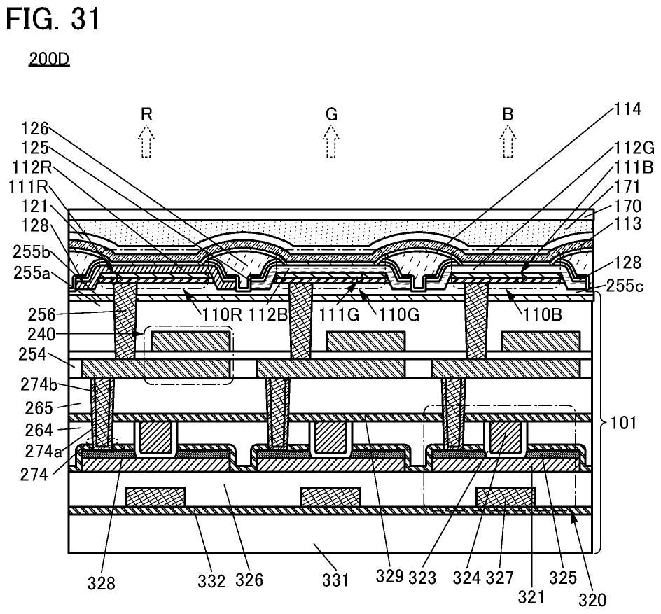

The display device 200D illustrated in FIG. 31 differs from the display device 200A mainly in a structure of a transistor.

A transistor 320 is an OS transistor.

The transistor 320 includes a semiconductor layer 321, an insulating layer 323, a conductive layer 324, a pair of conductive layers 325, an insulating layer 326, and a conductive layer 327.

A substrate 331 corresponds to the substrate 291 illustrated in FIGS. 27A and 27B.

The insulating layer 332 is provided over the substrate 331. The insulating layer 332 functions as a barrier layer that prevents diffusion of an impurity such as water or hydrogen from the substrate 331 into the transistor 320 and release of oxygen from the semiconductor layer 321 to the insulating layer 332 side. As the insulating layer 332, it is possible to use, for example, a film in which hydrogen or oxygen is less likely to diffuse than in a silicon oxide film, such as an aluminum oxide film, a hafnium oxide film, or a silicon nitride film.

The conductive layer 327 is provided over the insulating layer 332, and the insulating layer 326 is provided to cover the conductive layer 327. The conductive layer 327 functions as a first gate electrode of the transistor 320, and part of the insulating layer 326 functions as a first gate insulating layer. An oxide insulating film such as a silicon oxide film is preferably used as at least part of the insulating layer 326 that is in contact with the semiconductor layer 321. A top surface of the insulating layer 326 is preferably planarized.

The semiconductor layer 321 is provided over the insulating layer 326. A metal oxide film having semiconductor characteristics (also referred to as an oxide semiconductor film) is preferably used as the semiconductor layer 321. The pair of conductive layers 325 are provided on and in contact with the semiconductor layer 321, and function as a source electrode and a drain electrode.

An insulating layer 328 is provided to cover top and side surfaces of the pair of conductive layers 325, a side surface of the semiconductor layer 321, and the like, and an insulating layer 264 is provided over the insulating layer 328. The insulating layer 328 functions as a barrier layer that prevents diffusion of an impurity such as water or hydrogen from the insulating layer 264 and the like into the semiconductor layer 321 and release of oxygen from the semiconductor layer 321. As the insulating layer 328, an insulating film similar to the insulating layer 332 can be used.

An opening reaching the semiconductor layer 321 is provided in the insulating layers 328 and 264. The insulating layer 323 that is in contact with a top surface of the semiconductor layer 321 and the conductive layer 324 are embedded in the opening. The conductive layer 324 functions as a second gate electrode, and the insulating layer 323 functions as a second gate insulating layer.

A top surface of the conductive layer 324, a top surface of the insulating layer 323, and a top surface of the insulating layer 264 are planarized so that they are level with or substantially level with each other, and an insulating layer 329 and an insulating layer 265 are provided to cover these layers.

The insulating layers 264 and 265 each function as an interlayer insulating layer. The insulating layer 329 functions as a barrier layer that prevents diffusion of an impurity such as water or hydrogen from the insulating layer 265 or the like into the transistor 320. As the insulating layer 329, an insulating film similar to the insulating layers 328 and 332 can be used.

A plug 274 electrically connected to one of the pair of conductive layers 325 is provided to be embedded in the insulating layers 265, 329, and 264. Here, the plug 274 preferably includes a conductive layer 274a that covers a side surface of an opening formed in the insulating layers 265, 329, 264, and 328 and part of the top surface of the conductive layer 325, and a conductive layer 274b in contact with a top surface of the conductive layer 274a. For the conductive layer 274a, a conductive material in which hydrogen and oxygen are less likely to diffuse is preferably used.

### [Display Device 200E]

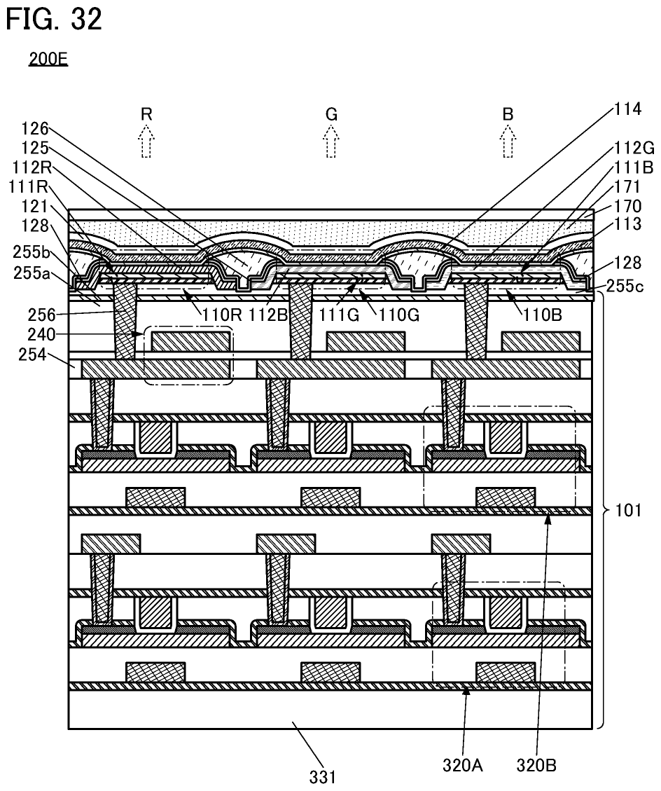

The display device 200E illustrated in FIG. 32 has a structure in which a transistor 320A and a transistor 320B each including an oxide semiconductor in a semiconductor where a channel is formed are stacked.

The description of the display device 200D can be referred to for the transistor 320A, the transistor 320B, and the components around them.

Although the structure in which two transistors each including an oxide semiconductor are stacked is described, one embodiment of the present invention is not limited thereto. For example, three or more transistors may be stacked.

### [Display Device 200F]

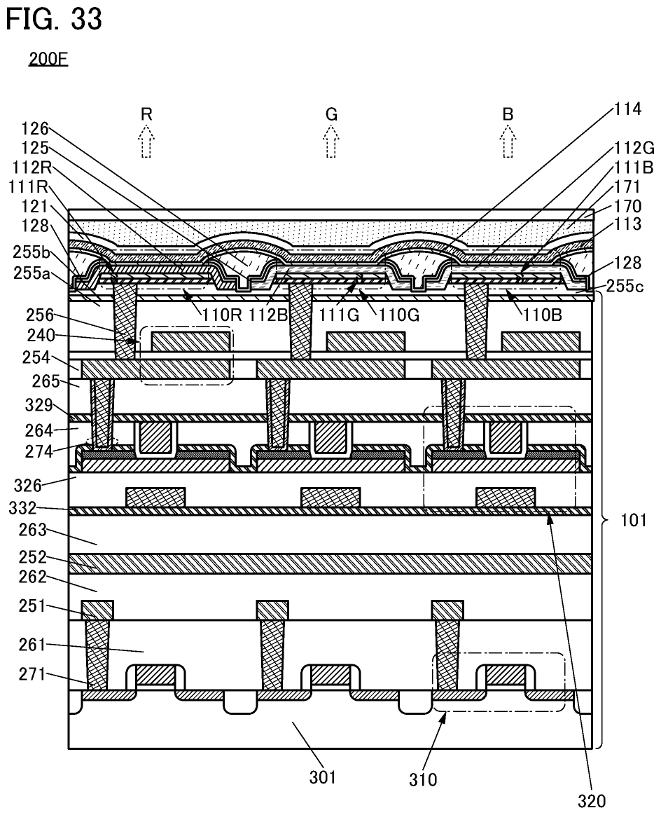

The display device 200F illustrated in FIG. 33 has a structure in which the transistor 310 having a channel formed in the substrate 301 and the transistor 320 including a metal oxide in a semiconductor layer where a channel is formed are stacked.

The insulating layer 261 is provided to cover the transistor 310, and a conductive layer 251 is provided over the insulating layer 261. An insulating layer 262 is provided to cover the conductive layer 251, and a conductive layer 252 is provided over the insulating layer 262. The conductive layer 251 and the conductive layer 252 each function as a wiring. An insulating layer 263 and the insulating layer 332 are provided to cover the conductive layer 252, and the transistor 320 is provided over the insulating layer 332. The insulating layer 265 is provided to cover the transistor 320, and the capacitor 240 is provided over the insulating layer 265. The capacitor 240 and the transistor 320 are electrically connected to each other through the plug 274.

The transistor 320 can be used as a transistor included in the pixel circuit. The transistor 310 can be used as a transistor included in the pixel circuit or a transistor included in a driver circuit for driving the pixel circuit (a gate line driver circuit or a source line driver circuit). The transistor 310 and the transistor 320 can also be used as transistors included in a variety of circuits such as an arithmetic circuit and a memory circuit.

With such a structure, not only the pixel circuit but also the driver circuit and the like can be formed directly under the light-emitting devices; thus, the display panel can be reduced in size as compared with the case where a driver circuit is provided around a display region.

### [Display Device 200G]

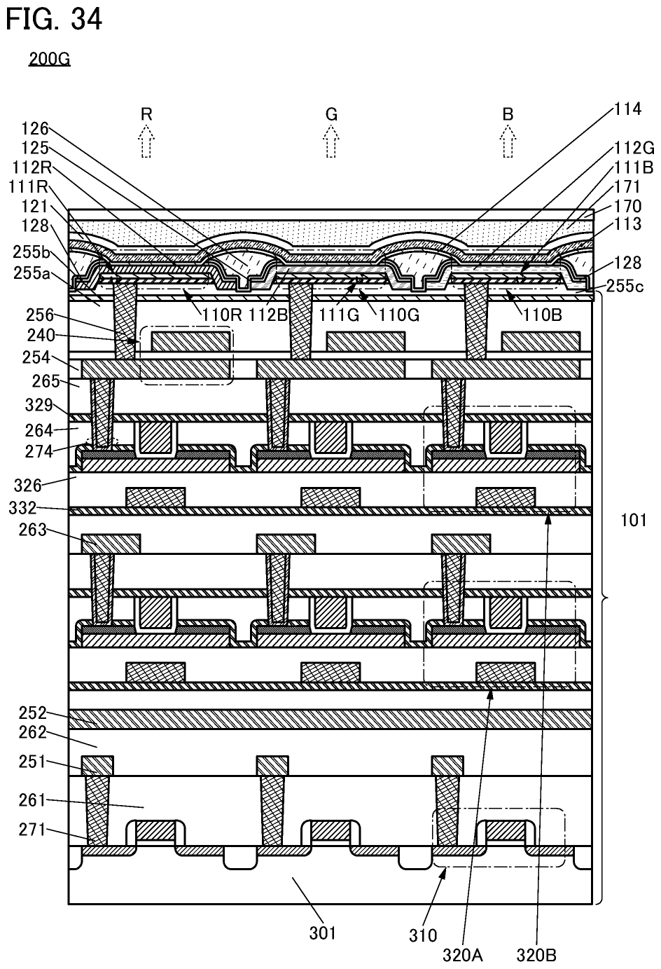

The display device 200G illustrated in FIG. 34 has a structure in which the transistor 310 having a channel formed in the substrate 301 and the transistors 320A and 320B each including a metal oxide in a semiconductor layer where a channel is formed are stacked.

The transistor 320A can be used as a transistor included in the pixel circuit. The transistor 310 can be used as a transistor included in the pixel circuit or a transistor included in a driver circuit for driving the pixel circuit (a gate line driver circuit or a source line driver circuit). The transistor 320B may be used as a transistor included in the pixel circuit or a transistor included in the driver circuit. The transistor 310, the transistor 320A, and the transistor 320B can also be used as transistors included in a variety of circuits such as an arithmetic circuit and a memory circuit.

At least part of this embodiment can be implemented in combination with any of the other embodiments described in this specification, as appropriate.

### Embodiment 5

In this embodiment, a light-emitting device (light-emitting element) that can be used in the display device of one embodiment of the present invention will be described.

In this specification and the like, a device formed using a metal mask or a fine metal mask (FMM) is sometimes referred to as a device having a metal mask (MM) structure. In this specification and the like, a device formed without using a metal mask or an FMM is sometimes referred to as a device having a metal maskless (MML) structure.

In this specification and the like, a structure in which at least light-emitting layers of light-emitting devices with different emission wavelengths are separately formed may be referred to as a side-by-side (SBS) structure. The SBS structure can optimize materials and structures of light-emitting devices and thus can extend freedom of choice of materials and structures, whereby the luminance and the reliability can be easily improved.

In this specification and the like, a hole or an electron is sometimes referred to as a carrier. Specifically, a hole-injection layer or an electron-injection layer may be referred to as a carrier-injection layer, a hole-transport layer or an electron-transport layer may be referred to as a carrier-transport layer, and a hole-blocking layer or an electron-blocking layer may be referred to as a carrier-blocking layer. Note that the above-described carrier-injection layer, carrier-transport layer, and carrier-blocking layer cannot be distinguished from each other depending on the cross-sectional shape or properties in some cases. One layer may have two or three functions of the carrier-injection layer, the carrier-transport layer, and the carrier-blocking layer in some cases.

In this specification and the like, a light-emitting device (also referred to as a light-emitting element) includes an EL layer between a pair of electrodes. The EL layer includes at least a light-emitting layer. Examples of layers (also referred to as functional layers) in the EL layer include a light-emitting layer, carrier-injection layers (a hole-injection layer and an electron-injection layer), carrier-transport layers (a hole-transport layer and an electron-transport layer), and carrier-blocking layers (a hole-blocking layer and an electron-blocking layer).

As the light-emitting device, an organic light-emitting diode (OLED) or a quantum-dot light-emitting diode (QLED) is preferably used, for example. Examples of a light-emitting substance contained in the light-emitting device include a substance exhibiting fluorescence (fluorescent material), a substance exhibiting phosphorescence (phosphorescent material), a substance exhibiting thermally activated delayed fluorescence (thermally activated delayed fluorescent (TADF) material), and an inorganic compound (e.g., a quantum dot material). A light-emitting diode (LED) such as a micro-LED can also be used as the light-emitting device.

The light-emitting device can emit infrared, red, green, blue, cyan, magenta, yellow, or white light, for example. When the light-emitting device has a microcavity structure, the color purity can be increased.

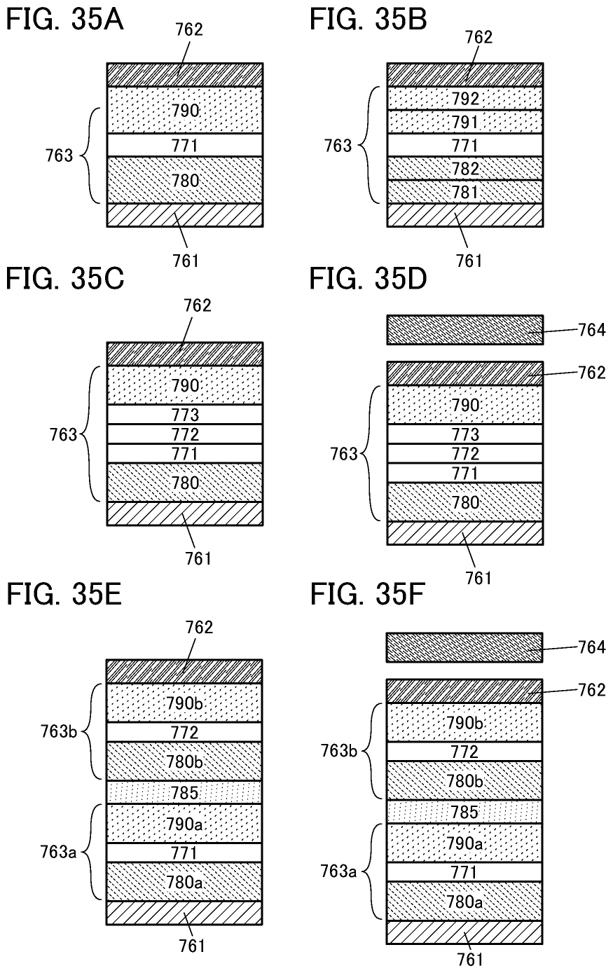

As illustrated in FIG. 35A, the light-emitting device includes an EL layer 763 between a pair of electrodes (a lower electrode 761 and an upper electrode 762). The EL layer 763 can be formed of a plurality of layers such as a layer 780, a light-emitting layer 771, and a layer 790.

The light-emitting layer 771 contains at least a light-emitting substance (also referred to as a light-emitting material).

In the case where the lower electrode 761 is an anode and the upper electrode 762 is a cathode, the layer 780 includes one or more of a layer containing a substance having a high hole-injection property (hole-injection layer), a layer containing a substance having a high hole-transport property (hole-transport layer), and a layer containing a substance having a high electron-blocking property (electron-blocking layer). Furthermore, the layer 790 includes one or more of a layer containing a substance having a high electron-injection property (electron-injection layer), a layer containing a substance having a high electron-transport property (electron-transport layer), and a layer containing a substance having a high hole-blocking property (hole-blocking layer). In the case where the lower electrode 761 is a cathode and the upper electrode 762 is an anode, the structures of the layer 780 and the layer 790 are interchanged.

The structure including the layer 780, the light-emitting layer 771, and the layer 790, which is provided between the pair of electrodes, can function as a single light-emitting unit, and the structure in FIG. 35A is referred to as a single structure in this specification.

FIG. 35B is a modification example of the EL layer 763 included in the light-emitting device illustrated in FIG. 35A. Specifically, the light-emitting device illustrated in FIG. 35B includes a layer 781 over the lower electrode 761, a layer 782 over the layer 781, the light-emitting layer 771 over the layer 782, a layer 791 over the light-emitting layer 771, a layer 792 over the layer 791, and the upper electrode 762 over the layer 792.

In the case where the lower electrode 761 is an anode and the upper electrode 762 is a cathode, the layer 781 can be a hole-injection layer, the layer 782 can be a hole-transport layer, the layer 791 can be an electron-transport layer, and the layer 792 can be an electron-injection layer, for example. In the case where the lower electrode 761 is a cathode and the upper electrode 762 is an anode, the layer 781 can be an electron-injection layer, the layer 782 can be an electron-transport layer, the layer 791 can be a hole-transport layer, and the layer 792 can be a hole-injection layer. With such a layered structure, carriers can be efficiently injected to the light-emitting layer 771, and the efficiency of the recombination of carriers in the light-emitting layer 771 can be enhanced.

Note that structures in which a plurality of light-emitting layers (light-emitting layers 771, 772, and 773) are provided between the layers 780 and 790 as illustrated in FIGS. 35C and 35D are other variations of the single structure. Although FIGS. 35C and 35D each illustrate an example in which three light-emitting layers are included, the number of light-emitting layers in a light-emitting device having a single structure may be two or four or more. A light-emitting device having a single structure may include a buffer layer between two light-emitting layers.

A structure in which a plurality of light-emitting units (light-emitting units 763a and 763b) are connected in series with a charge-generation layer (also referred to as an intermediate layer) 785 therebetween as illustrated in FIGS. 35E and 35F is referred to as a tandem structure in this specification. The tandem structure may be referred to as a stack structure. The tandem structure enables a light-emitting device capable of high-luminance light emission. Furthermore, the tandem structure allows the amount of current needed for obtaining the same luminance to be reduced as compared to the case of using a single structure, and thus can improve the reliability.

Note that FIGS. 35D and 35F each illustrate an example in which the display device includes a layer 764 overlapping with the light-emitting device. FIG. 35D is an example in which the layer 764 overlaps with the light-emitting device illustrated in FIG. 35C and FIG. 35F illustrates an example in which the layer 764 overlaps with the light-emitting device illustrated in FIG. 35E.

One or both of a color conversion layer and a color filter (coloring layer) can be used as the layer 764.

In FIGS. 35C and 35D, light-emitting substances that emit light of the same color or the same light-emitting substance may be used for the light-emitting layers 771, 772, and 773. For example, a light-emitting substance that emits blue light may be used for the light-emitting layers 771, 772, and 773. In a subpixel that emits blue light, blue light from the light-emitting device can be extracted as it is. In each of a subpixel that emits red light and a subpixel that emits green light, a color conversion layer is provided as the layer 764 illustrated in FIG. 35D for converting blue light from the light-emitting device into light with a longer wavelength, so that red light or green light can be extracted.

Alternatively, light-emitting substances that emit light of different colors may be used for the light-emitting layers 771, 772, and 773. White light can be obtained when the light-emitting layer 771, the light-emitting layer 772, and the light-emitting layer 773 emit light of complementary colors. The light-emitting device having a single structure preferably includes a light-emitting layer containing a light-emitting substance emitting blue light and a light-emitting layer containing a light-emitting substance emitting visible light with a longer wavelength than blue light, for example.

In the case where the light-emitting device having a single structure includes three light-emitting layers, for example, a light-emitting layer containing a light-emitting substance emitting red (R) light, a light-emitting layer containing a light-emitting substance emitting green (G) light, and a light-emitting layer containing a light-emitting substance emitting blue (B) light are preferably included. The stacking order of the light-emitting layers can be RGB or RBG from an anode side, for example. In that case, a buffer layer may be provided between R and G or between R and B.

In the case where the light-emitting device having a single structure includes two light-emitting layers, for example, a light-emitting layer containing a light-emitting substance emitting blue (B) light and a light-emitting layer containing a light-emitting substance emitting yellow (Y) light are preferably included. Such a structure may be referred to as a BY single structure.

A color filter may be provided as the layer 764 illustrated in FIG. 35D. When white light passes through a color filter, light of a desired color can be obtained.

In the light-emitting device that emits white light, two or more kinds of light-emitting substances are preferably contained. To obtain white light emission, the two or more kinds of light-emitting substances are selected so as to emit light of complementary colors. For example, when emission colors of a first light-emitting layer and a second light-emitting layer are complementary colors, the light-emitting device can emit white light as a whole. The same applies to a light-emitting device including three or more light-emitting layers.

In FIGS. 35E and 35F, light-emitting substances that emit light of the same color or the same light-emitting substance may be used for the light-emitting layers 771 and 772.

For example, in light-emitting devices included in subpixels emitting light of different colors, a light-emitting substance that emits blue light can be used for each of the light-emitting layer 771 and the light-emitting layer 772. In the subpixel that emits blue light, blue light from the light-emitting device can be extracted as it is. In each of the subpixel that emits red light and the subpixel that emits green light, a color conversion layer is provided as the layer 764 illustrated in FIG. 35F for converting blue light from the light-emitting device into light with a longer wavelength, so that red light or green light can be extracted.

In the case where light-emitting devices with the structure illustrated in FIG. 35E or FIG. 35F are used in subpixels emitting light of different colors, light-emitting substances may be different between the subpixels. Specifically, in the light-emitting device included in the subpixel emitting red light, a light-emitting substance that emits red light can be used for each of the light-emitting layer 771 and the light-emitting layer 772. In the light-emitting device included in the subpixel emitting green light, a light-emitting substance that emits green light can be used for each of the light-emitting layer 771 and the light-emitting layer 772. In the light-emitting device included in the subpixel emitting blue light, a light-emitting substance that emits blue light can be used for each of the light-emitting layer 771 and the light-emitting layer 772. A display device with such a structure includes a light-emitting device with a tandem structure and can be regarded to have an SBS structure. Thus, the display device can have advantages of both of a tandem structure and an SBS structure. Accordingly, a highly reliable light-emitting device capable of high luminance light emission can be obtained.

In FIGS. 35E and 35F, light-emitting substances that emit light of different colors may be used for the light-emitting layers 771 and 772. White light can be obtained when the light-emitting layer 771 and the light-emitting layer 772 emit light of complementary colors. A color filter may be provided as the layer 764 illustrated in FIG. 35F. When white light passes through a color filter, light of a desired color can be obtained.

Although FIGS. 35E and 35F each illustrate an example in which the light-emitting unit 763a includes one light-emitting layer 771 and the light-emitting unit 763b includes one light-emitting layer 772, one embodiment of the present invention is not limited thereto. Each of the light-emitting unit 763a and the light-emitting unit 763b may include two or more light-emitting layers.

Although FIGS. 35E and 35F each illustrate an example of a light-emitting device including two light-emitting units, one embodiment of the present invention is not limited thereto. The light-emitting device may include three or more light-emitting units.

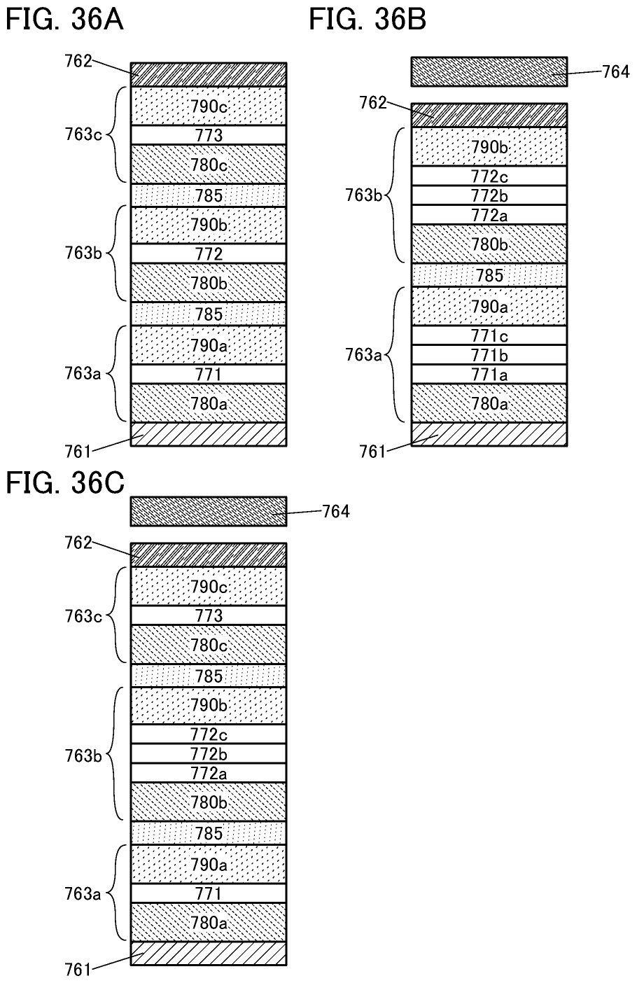

Specifically, the light-emitting device may have any of structures illustrated in FIGS. 36A to 36C.

FIG. 36A illustrates a structure including three light-emitting units. Note that a structure including two light-emitting units and a structure including three light-emitting units may be referred to as a two-unit tandem structure and a three-unit tandem structure, respectively.

In the structure illustrated in FIG. 36A, a plurality of light-emitting units (light-emitting units 763a, 763b, and 763c) are connected in series with the charge-generation layer 785 provided between each two light-emitting units. The light-emitting unit 763a includes a layer 780a, the light-emitting layer 771, and a layer 790a. The light-emitting unit 763b includes a layer 780b, the light-emitting layer 772, and a layer 790b. The light-emitting unit 763c includes a layer 780c, the light-emitting layer 773, and a layer 790c.

Note that in the structure illustrated in FIG. 36A, the light-emitting layers 771, 772, and 773 preferably contain light-emitting substances that emit light of the same color. Specifically, a structure in which the light-emitting layers 771, 772, and 773 each contain a red (R) light-emitting substance (what is called a three-unit tandem structure of R\R\R), a structure in which the light-emitting layers 771, 772, and 773 each contain a green (G) light-emitting substance (what is called a three-unit tandem structure of G\G\G), or a structure in which the light-emitting layers 771, 772, and 773 each contain a blue (B) light-emitting substance (what is called a three-unit tandem structure of B\B\B) can be employed.

Note that the structure containing the light-emitting substances that emit light of the same color is not limited to the above structure. For example, a light-emitting device with a tandem structure may be employed in which light-emitting units each containing a plurality of light-emitting substances are stacked as illustrated in FIG. 36B. FIG. 36B illustrates a structure in which a plurality of light-emitting units (light-emitting units 763a and 763b) are connected in series with the charge-generation layer 785 therebetween. The light-emitting unit 763a includes the layer 780a, a light-emitting layer 771a, a light-emitting layer 771b, a light-emitting layer 771c, and the layer 790a. The light-emitting unit 763b includes the layer 780b, a light-emitting layer 772a, a light-emitting layer 772b, a light-emitting layer 772c, and the layer 790b.

In the structure illustrated in FIG. 36B, light-emitting substances for the light-emitting layers 771a, 771b, and 771c are selected so as to emit light of complementary colors to obtain white (W) light emission. Furthermore, light-emitting substances for the light-emitting layers 772a, 772b, and 772c are selected so as to emit light of complementary colors to obtain white (W) light emission. That is, the structure illustrated in FIG. 36B is a two-unit tandem structure of W\W. Note that there is no particular limitation on the stacking order of the light-emitting layers 771a, 771b, and 771c containing light-emitting substances that emit light of complementary colors, and a practitioner can select an optimum stacking order as appropriate. Although not illustrated, a three-unit tandem structure of W\W\W or a tandem structure with four or more units may be employed.

In the case of a light-emitting device with a tandem structure, any of the following structure may be employed, for example: a two-unit tandem structure of B\Y including a light-emitting unit that emits yellow (Y) light and a light-emitting unit that emits blue (B) light; a two-unit tandem structure of R·G\B including a light-emitting unit that emits red (R) and green (G) light and a light-emitting unit that emits blue (B) light; a three-unit tandem structure of B\Y\B including a light-emitting unit that emits blue (B) light, a light-emitting unit that emits yellow (Y) light, and a light-emitting unit that emits blue (B) light in this order; a three-unit tandem structure of B\YG\B including a light-emitting unit that emits blue (B) light, a light-emitting unit that emits yellow-green (YG) light, and a light-emitting unit that emits blue (B) light in this order; and a three-unit tandem structure of B\G\B including a light-emitting unit that emits blue (B) light, a light-emitting unit that emits green (G) light, and a light-emitting unit that emits blue (B) light in this order.

Alternatively, a light-emitting unit containing one light-emitting substance and a light-emitting unit containing a plurality of light-emitting substances may be used in combination as illustrated in FIG. 36C.

Specifically, in the structure illustrated in FIG. 36C, a plurality of light-emitting units (the light-emitting units 763a, 763b, and 763c) are connected in series with the charge-generation layer 785 provided between each two light-emitting units. The light-emitting unit 763a includes the layer 780a, the light-emitting layer 771, and the layer 790a. The light-emitting unit 763b includes the layer 780b, the light-emitting layer 772a, the light-emitting layer 772b, the light-emitting layer 772c, and the layer 790b. The light-emitting unit 763c includes the layer 780c, the light-emitting layer 773, and the layer 790c.

The structure illustrated in FIG. 36C can be, for example, a three-unit tandem structure of B\R·G·YG\B in which the light-emitting unit 763a is a light-emitting unit that emits blue (B) light, the light-emitting unit 763b is a light-emitting unit that emits red (R), green (G), and yellow-green (YG) light, and the light-emitting unit 763c is a light-emitting unit that emits blue (B) light.

Examples of the stacked structure of light-emitting units include, from an anode side, a two-unit structure of B and Y; a two-unit structure of B and a light-emitting unit X; a three-unit structure of B, Y, and B; and a three-unit structure of B, X, and B. Examples of the stacked structure of light-emitting layers in the light-emitting unit X include, from an anode side, a two-layer structure of R and Y; a two-layer structure of R and G; a two-layer structure of G and R; a three-layer structure of G, R, and G; and a three-layer structure of R, G, and R. Another layer may be provided between two light-emitting layers.

In FIGS. 35C and 35D, the layers 780 and 790 may each have a stacked-layer structure of two or more layers as illustrated in FIG. 35B.

In each of FIGS. 35E and 35F, the light-emitting unit 763a includes the layer 780a, the light-emitting layer 771, and the layer 790a, and the light-emitting unit 763b includes the layer 780b, the light-emitting layer 772, and the layer 790b.

In the case where the lower electrode 761 is an anode and the upper electrode 762 is a cathode, the layers 780a and 780b each include one or more of a hole-injection layer, a hole-transport layer, and an electron-blocking layer. Furthermore, the layers 790a and 790b each include one or more of an electron-injection layer, an electron-transport layer, and a hole-blocking layer. In the case where the lower electrode 761 is a cathode and the upper electrode 762 is an anode, the structures of the layer 780a and the layer 790a are interchanged and the structures of the layer 780b and the layer 790b are interchanged.

In the case where the lower electrode 761 is an anode and the upper electrode 762 is a cathode, the layer 780a includes a hole-injection layer and a hole-transport layer over the hole-injection layer, and may further include an electron-blocking layer over the hole-transport layer, for example. The layer 790a includes an electron-transport layer, and may further include a hole-blocking layer between the light-emitting layer 771 and the electron-transport layer. The layer 780b includes a hole-transport layer, and may further include an electron-blocking layer over the hole-transport layer. The layer 790b includes an electron-transport layer and an electron-injection layer over the electron-transport layer, and may further include a hole-blocking layer between the light-emitting layer 772 and the electron-transport layer. In the case where the lower electrode 761 is a cathode and the upper electrode 762 is an anode, the layer 780a includes an electron-injection layer and an electron-transport layer over the electron-injection layer, and may further include a hole-blocking layer over the electron-transport layer, for example. The layer 790a includes a hole-transport layer, and may further include an electron-blocking layer between the light-emitting layer 771 and the hole-transport layer. The layer 780b includes an electron-transport layer, and may further include a hole-blocking layer over the electron-transport layer. The layer 790b includes a hole-transport layer and a hole-injection layer over the hole-transport layer, and may further include an electron-blocking layer between the light-emitting layer 772 and the hole-transport layer.

In the case of fabricating the light-emitting device with a tandem structure, two light-emitting units are stacked with the charge-generation layer 785 therebetween. The charge-generation layer 785 includes at least a charge-generation region. The charge-generation layer 785 has a function of injecting electrons into one of the two light-emitting units and injecting holes to the other when voltage is applied between the pair of electrodes.

Next, materials that can be used for the light-emitting device will be described.

A conductive film transmitting visible light is used for the electrode through which light is extracted, which is either the lower electrode 761 or the upper electrode 762. A conductive film reflecting visible light is preferably used for the electrode through which light is not extracted. In the case where the display device includes a light-emitting device emitting infrared light, a conductive film transmitting visible light and infrared light is used for the electrode through which light is extracted, and a conductive film reflecting visible light and infrared light is preferably used for the electrode through which light is not extracted.

A conductive film that transmitting visible light may be used also for the electrode through which light is not extracted. In that case, the electrode is preferably provided between a reflective layer and the EL layer 763. In other words, light emitted from the EL layer 763 may be reflected by the reflective layer to be extracted from the display device.

As a material for the pair of electrodes of the light-emitting device, a metal, an alloy, an electrically conductive compound, a mixture thereof, or the like can be used as appropriate. Specific examples of the material include metals such as aluminum, titanium, chromium, manganese, iron, cobalt, nickel, copper, gallium, zinc, indium, tin, molybdenum, tantalum, tungsten, palladium, gold, platinum, silver, yttrium, and neodymium, and an alloy containing appropriate combination of any of these metals. Other examples of the material include an indium tin oxide (In—Sn oxide, also referred to as ITO), an In—Si—Sn oxide (also referred to as ITSO), an indium zinc oxide (In—Zn oxide), and an In—W—Zn oxide. Other examples of the material include an alloy containing aluminum (aluminum alloy) such as an alloy of aluminum, nickel, and lanthanum (Al—Ni—La), and an alloy of silver, palladium, and copper (Ag—Pd—Cu, also referred to as APC). Other examples of the material include an element belonging to Group 1 or Group 2 of the periodic table that is not described above (e.g., lithium, cesium, calcium, or strontium), a rare earth metal such as europium or ytterbium, an alloy containing an appropriate combination of any of these elements, and graphene.

The light-emitting device preferably employs a microcavity structure. Therefore, one of the pair of electrodes of the light-emitting device is preferably an electrode having properties of transmitting and reflecting visible light (transflective electrode), and the other is preferably an electrode having a property of reflecting visible light (reflective electrode). When the light-emitting device has a microcavity structure, light obtained from the light-emitting layer can be resonated between the electrodes, whereby light emitted from the light-emitting device can be intensified.

Note that the transflective electrode can have a stacked-layer structure of a conductive layer that can be used as a reflective electrode and a conductive layer that can be used as an electrode having a property of transmitting visible light (also referred to as a transparent electrode).

The transparent electrode has a light transmittance higher than or equal to 40%. For example, an electrode having a visible light (light with wavelengths greater than or equal to 400 nm and less than 750 nm) transmittance higher than or equal to 40% is preferably used in the transparent electrode of the light-emitting device. The transflective electrode has a visible light reflectance higher than or equal to 10% and lower than or equal to 95%, preferably higher than or equal to 30% and lower than or equal to 80%. The reflective electrode has a visible light reflectance higher than or equal to 40% and lower than or equal to 100%, preferably higher than or equal to 70% and lower than or equal to 100%. These electrodes preferably have a resistivity lower than or equal to 1×10⁻² Ωcm.

The light-emitting device includes at least a light-emitting layer. In addition to the light-emitting layer, the light-emitting device may further include a layer containing any of a substance having a high hole-injection property, a substance having a high hole-transport property, a hole-blocking material, a substance having a high electron-transport property, a substance having a high electron-injection property, an electron-blocking material, a substance having a bipolar property (a substance with a high electron- and hole-transport property), and the like. For example, the light-emitting device can include one or more of a hole-injection layer, a hole-transport layer, a hole-blocking layer, a charge-generation layer, an electron-blocking layer, an electron-transport layer, and an electron-injection layer in addition to the light-emitting layer.

Either a low molecular compound or a high molecular compound can be used in the light-emitting device, and an inorganic compound may also be included. Each layer included in the light-emitting device can be formed by any of the following methods: an evaporation method (including a vacuum evaporation method), a transfer method, a printing method, an inkjet method, a coating method, and the like.

The light-emitting layer contains one or more kinds of light-emitting substances. As the light-emitting substance, a substance whose emission color is blue, violet, bluish violet, green, yellowish green, yellow, orange, red, or the like is appropriately used. Alternatively, as the light-emitting substance, a substance that emits near-infrared light can be used.

Examples of the light-emitting substance include a fluorescent material, a phosphorescent material, a TADF material, and a quantum dot material.

Examples of a fluorescent material include a pyrene derivative, an anthracene derivative, a triphenylene derivative, a fluorene derivative, a carbazole derivative, a dibenzothiophene derivative, a dibenzofuran derivative, a dibenzoquinoxaline derivative, a quinoxaline derivative, a pyridine derivative, a pyrimidine derivative, a phenanthrene derivative, and a naphthalene derivative.

Examples of a phosphorescent material include an organometallic complex (particularly an iridium complex) having a 4H-triazole skeleton, a 1H-triazole skeleton, an imidazole skeleton, a pyrimidine skeleton, a pyrazine skeleton, or a pyridine skeleton; an organometallic complex (particularly an iridium complex) having a phenylpyridine derivative including an electron-withdrawing group as a ligand; a platinum complex; and a rare earth metal complex.

The light-emitting layer may contain one or more kinds of organic compounds (e.g., a host material or an assist material) in addition to the light-emitting substance (guest material). As one or more kinds of organic compounds, one or both of a substance having a high hole-transport property (hole-transport material) and a substance having a high electron-transport property (electron-transport material) can be used. As the hole-transport material, a later-described material having a high hole-transport property that can be used for the hole-transport layer can be used. As the electron-transport material, a later-described material having a high electron-transport property that can be used for the electron-transport layer can be used. Alternatively, as one or more kinds of organic compounds, a bipolar material or a TADF material may be used.

The light-emitting layer preferably includes a phosphorescent material and a combination of a hole-transport material and an electron-transport material that easily forms an exciplex, for example. With such a structure, light emission can be efficiently obtained by exciplex-triplet energy transfer (ExTET), which is energy transfer from the exciplex to the light-emitting substance (phosphorescent material). When a combination of materials is selected so as to form an exciplex that emits light whose wavelength overlaps with the wavelength of a lowest-energy-side absorption band of the light-emitting substance, energy can be transferred smoothly and light emission can be obtained efficiently. With the above structure, high efficiency, low-voltage driving, and a long lifetime of a light-emitting device can be achieved at the same time.

The hole-injection layer injects holes from the anode to the hole-transport layer and contains a material having a high hole-injection property. Examples of a material having a high hole-injection property include an aromatic amine compound and a composite material containing a hole-transport material and an acceptor material (electron-accepting material).

As the acceptor material, for example, an oxide of a metal belonging to any of Group 4 to Group 8 of the periodic table can be used. Specific examples include molybdenum oxide, vanadium oxide, niobium oxide, tantalum oxide, chromium oxide, tungsten oxide, manganese oxide, and rhenium oxide. Among these, molybdenum oxide is especially preferable since it is stable in the air, has a low hygroscopic property, and is easy to handle. Alternatively, an organic acceptor material containing fluorine can be used. Alternatively, organic acceptor materials such as a quinodimethane derivative, a chloranil derivative, and a hexaazatriphenylene derivative can be used.

As the material having a high hole-injection property, a material containing a hole-transport material and the above-described oxide of a metal belonging to Group 4 to Group 8 of the periodic table (typified by molybdenum oxide) may be used, for example.

The hole-transport layer transports holes injected from the anode by the hole-injection layer, to the light-emitting layer. The hole-transport layer contains a hole-transport material. The hole-transport material preferably has a hole mobility higher than or equal to 1×10⁻⁶ cm²/Vs. Note that other substances can also be used as long as the substances have a hole-transport property higher than an electron-transport property. As the hole-transport material, materials having a high hole-transport property, such as a π-electron rich heteroaromatic compound (e.g., a carbazole derivative, a thiophene derivative, and a furan derivative) and an aromatic amine (a compound having an aromatic amine skeleton), are preferred.

The electron-blocking layer is provided in contact with the light-emitting layer. The electron-blocking layer is a layer having a hole-transport property and containing a material that can block an electron. Among the above-described hole-transport materials, a material having an electron-blocking property can be used for the electron-blocking layer.

Since the electron-blocking layer has a hole-transport property, the electron-blocking layer can also be referred to as a hole-transport layer. Among hole-transport layers, a layer having an electron-blocking property can also be referred to as an electron-blocking layer.

The electron-transport layer transports electrons injected from the cathode by the electron-injection layer, to the light-emitting layer. The electron-transport layer contains an electron-transport material. The electron-transport material preferably has an electron mobility higher than or equal to 1×10⁻⁶ cm²/Vs. Note that other substances can also be used as long as the substances have an electron-transport property higher than a hole-transport property. As the electron-transport material, any of the following materials having a high electron-transport property can be used, for example: a metal complex having a quinoline skeleton, a metal complex having a benzoquinoline skeleton, a metal complex having an oxazole skeleton, a metal complex having a thiazole skeleton, an oxadiazole derivative, a triazole derivative, an imidazole derivative, an oxazole derivative, a thiazole derivative, a phenanthroline derivative, a quinoline derivative having a quinoline ligand, a benzoquinoline derivative, a quinoxaline derivative, a dibenzoquinoxaline derivative, a pyridine derivative, a bipyridine derivative, a pyrimidine derivative, and a π-electron deficient heteroaromatic compound such as a nitrogen-containing heteroaromatic compound.

The hole-blocking layer is provided in contact with the light-emitting layer. The hole-blocking layer is a layer having an electron-transport property and containing a material that can block a hole. Among the above-described electron-transport materials, a material having a hole-blocking property can be used for the hole-blocking layer.

Since the hole-blocking layer has an electron-transport property, the hole-blocking layer can also be referred to as an electron-transport layer. Among electron-transport layers, a layer having a hole-blocking property can also be referred to as a hole-blocking layer.

The electron-injection layer injects electrons from the cathode to the electron-transport layer and contains a material with a high electron-injection property. As the material with a high electron-injection property, an alkali metal, an alkaline earth metal, or a compound thereof can be used. As the material with a high electron-injection property, a composite material containing an electron-transport material and a donor material (electron-donating material) can also be used.

The LUMO level of the material having a high electron-injection property preferably has a small difference (specifically, 0.5 eV or less) from the work function of a material for the cathode.

The electron-injection layer can be formed using an alkali metal, an alkaline earth metal, or a compound thereof, such as lithium, cesium, ytterbium, lithium fluoride (LiF), cesium fluoride (CsF), calcium fluoride (CaFx, where X is a given number), 8-(quinolinolato)lithium (abbreviation: Liq), 2-(2-pyridyl)phenolatolithium (abbreviation: LiPP), 2-(2-pyridyl)-3-pyridinolatolithium (abbreviation: LiPPy), 4-phenyl-2-(2-pyridyl)phenolatolithium (abbreviation: LiPPP), lithium oxide (LiO_{X}), or cesium carbonate, for example. The electron-injection layer may have a stacked-layer structure of two or more layers. As an example of the stacked-layer structure, a structure in which lithium fluoride is used for the first layer and ytterbium is used for the second layer is given.

The electron-injection layer may contain an electron-transport material. For example, a compound having an unshared electron pair and an electron deficient heteroaromatic ring can be used as the electron-transport material. Specifically, it is possible to use a compound having at least one of a pyridine ring, a diazine ring (a pyrimidine ring, a pyrazine ring, or a pyridazine ring), and a triazine ring.

Note that the lowest unoccupied molecular orbital (LUMO) level of the organic compound having an unshared electron pair is preferably greater than or equal to −3.6 eV and less than or equal to −2.3 eV. In general, the highest occupied molecular orbital (HOMO) level and the LUMO level of an organic compound can be estimated by cyclic voltammetry (CV), photoelectron spectroscopy, optical absorption spectroscopy, inverse photoelectron spectroscopy, or the like.

For example, 4,7-diphenyl-1,10-phenanthroline (abbreviation: BPhen), 2,9-di(naphthalen-2-yl)-4,7-diphenyl-1,10-phenanthroline (abbreviation: NBPhen), diquinoxalino[2,3-a:2′,3′-c]phenazine (abbreviation: HATNA), 2,4,6-tris[3′-(pyridin-3-yl)biphenyl-3-yl]-1,3,5-triazine (abbreviation: TmPPPyTz), or the like can be used as the organic compound having an unshared electron pair. Note that NBPhen has a higher glass transition point (Tg) than BPhen and thus has high heat resistance.

As described above, the charge-generation layer includes at least a charge-generation region. The charge-generation region preferably contains an acceptor material. For example, the charge-generation region preferably contains the above-described hole-transport material and acceptor material that can be used for the hole-injection layer.

The charge-generation layer preferably includes a layer containing a material having a high electron-injection property. The layer can also be referred to as an electron-injection buffer layer. The electron-injection buffer layer is preferably provided between the charge-generation region and the electron-transport layer. The electron-injection buffer layer can reduce an injection barrier between the charge-generation region and the electron-transport layer; thus, electrons generated in the charge-generation region can be easily injected into the electron-transport layer.

The electron-injection buffer layer preferably contains an alkali metal or an alkaline earth metal, and can contain an alkali metal compound or an alkaline earth metal compound, for example. Specifically, the electron-injection buffer layer preferably contains an inorganic compound containing an alkali metal and oxygen or an inorganic compound containing an alkaline earth metal and oxygen, and further preferably contains an inorganic compound containing lithium and oxygen (e.g., lithium oxide (Li₂O)). Alternatively, a material that can be used for the electron-injection layer can be favorably used for the electron-injection buffer layer.

The charge-generation layer preferably includes a layer containing a material having a high electron-transport property. The layer can also be referred to as an electron-relay layer. The electron-relay layer is preferably provided between the charge-generation region and the electron-injection buffer layer. In the case where the charge-generation layer does not include an electron-injection buffer layer, the electron-relay layer is preferably provided between the charge-generation region and the electron-transport layer. The electron-relay layer has a function of preventing an interaction between the charge-generation region and the electron-injection buffer layer (or the electron-transport layer) and transferring electrons smoothly.

For the electron-relay layer, a phthalocyanine-based material such as copper(II) phthalocyanine (abbreviation: CuPc), or a metal complex having a metal-oxygen bond and an aromatic ligand is preferably used.

Note that the charge-generation region, the electron-injection buffer layer, and the electron-relay layer cannot be clearly distinguished from one another depending on the cross-sectional shape or properties in some cases.

The charge-generation layer may contain a donor material instead of an acceptor material. For example, the charge-generation layer may include a layer containing the above-described electron-transport material and donor material that can be used for the electron-injection layer.

When the charge-generation layer is provided between two light-emitting units to be stacked, an increase in driving voltage can be inhibited.

At least part of any of the structure examples, the drawings corresponding thereto, and the like described in this embodiment can be implemented in combination with any of the other structure examples, the other drawings corresponding thereto, and the like as appropriate.

This application is based on Japanese Patent Application Serial No. 2021-165494 filed with Japan Patent Office on Oct. 7, 2021, the entire contents of which are hereby incorporated by reference.

What is claimed is:

1. An electronic device comprising:
a housing;
a display device;
a system unit;
a camera;
a secondary battery;
a reflective surface; and
a wearing tool,
wherein the system unit and the secondary battery are each positioned inside the housing,
wherein the system unit comprises a charging circuit unit,
wherein the charging circuit unit is configured to control charging of the secondary battery,
wherein the system unit is configured to perform first processing based on imaging data of the camera,
wherein the first processing comprises at least one of gesture operation, head tracking, and eye tracking,
wherein the system unit is configured to generate image data based on the first processing, and
wherein the display device is configured to display the image data.

2. The electronic device according to claim 1, wherein the wearing tool is configured to hold a user's head around the user's ear.

3. The electronic device according to claim 1, wherein the wearing tool is worn over a user's ear.

4. The electronic device according to claim 1, wherein the housing has a curved shape along a user's head.

5. The electronic device according to claim 1, wherein the housing has a cylindrical shape whose axis is along a part of a substantially elliptical shape.

6. The electronic device according to claim 1, wherein the secondary battery is flexible.

7. An electronic device comprising:
a housing;
a display device;
a system unit;
a camera;
a secondary battery;
a reflective surface; and
a wearing tool,
wherein the system unit and the secondary battery are each positioned inside the housing,
wherein the system unit comprises a charging circuit unit,
wherein the charging circuit unit is configured to control charging of the secondary battery,
wherein the system unit is configured to perform first processing based on imaging data of the camera,
wherein the first processing comprises at least one of gesture operation, head tracking, and eye tracking,
wherein the system unit is configured to generate image data based on the first processing,
wherein the display device is configured to display the image data, and
wherein the display device comprises an organic electroluminescent element.

8. The electronic device according to claim 7, wherein the wearing tool is configured to hold a user's head around the user's ear.

9. The electronic device according to claim 7, wherein the wearing tool is worn over a user's ear.

10. The electronic device according to claim 7, wherein the housing has a curved shape along a user's head.

11. The electronic device according to claim 7, wherein the housing has a cylindrical shape whose axis is along a part of a substantially elliptical shape.

12. The electronic device according to claim 7, wherein the secondary battery is flexible.

13. An electronic device comprising:
a housing;
a display device;
a system unit;
a camera;
a secondary battery;
a reflective surface; and
a wearing tool,
wherein the system unit and the secondary battery are each positioned inside the housing,
wherein the system unit comprises a charging circuit unit,
wherein the charging circuit unit is configured to control charging of the secondary battery,
wherein the system unit is configured to perform first processing based on imaging data of the camera,
wherein the first processing comprises at least one of gesture operation, head tracking, and eye tracking,
wherein the system unit is configured to generate image data based on the first processing,
wherein the display device is configured to display the image data,
wherein the display device comprises an organic electroluminescent element, and
wherein the organic electroluminescent element comprises a plurality of light-emitting layers.

14. The electronic device according to claim 13, wherein the wearing tool is configured to hold a user's head around the user's ear.

15. The electronic device according to claim 13, wherein the wearing tool is worn over a user's ear.

16. The electronic device according to claim 13, wherein the housing has a curved shape along a user's head.

17. The electronic device according to claim 13, wherein the housing has a cylindrical shape whose axis is along a part of a substantially elliptical shape.

18. The electronic device according to claim 13, wherein the secondary battery is flexible.
